(19) United States
(12) Patent Application Publication
(10) Pub. No.: US 2026/0267183 A1
(43) Pub. Date: Sep. 10, 2026

(54) TRANSPARENT ARTICLES WITH HIGH SHALLOW HARDNESS AND DISPLAY DEVICES WITH THE SAME

(71) Applicant: CORNING INCORPORATED, CORNING, NY (US)

(72) Inventors: Jaymin Amin, Corning, NY (US); Jason Thomas Harris, Horseheads, NY (US); Shandon Dee Hart, Elmira, NY (US); Karl William Koch, III, Elmira, NY (US); Carlo Anthony Kosik Williams, Painted Post, NY (US); Lin Lin, Painted Post, NY (US); Alexandre Michel Mayolet, Corning, NY (US); Dong-gun Moon, Yongin-si Gyeonggi-do (KR); Jeonghong Oh, Cheonan-si Chungcheongnam-do (KR); Naveen Prakash, Fishers, IN (US); James Joseph Price, Corning, NY (US); Charlene Marie Smith, Corning, NY (US); Ananthanarayanan Subramanian, Corning, NY (US); Ljerka Ukrainczyk, Ithaca, NY (US); Florence Christine Monique Verrier, Corning, NY (US); Tingge Xu, San Jose, CA (US); Binwei Zhang, Horseheads, NY (US); Wenlei Zhang, Painted Post, NY (US)

(21) Appl. No.: 19/662,149

(22) Filed: Apr. 29, 2026

Related U.S. Application Data
(63) Continuation of application No. 18/142,067, filed on May 2, 2023.
(60) Provisional application No. 63/337,846, filed on May 3, 2022.
(60) Provisional application No. 63/441,293, filed on Jan. 26, 2023.
(60) Provisional application No. 63/462,661, filed on Apr. 28, 2023.

(51) Int. Cl. G02F 1/1333; G02B 1/14; G02F 1/1347; G02F 1/19

(52) U.S. Cl. CPC G02F 1/133305; G02B 1/14; G02F 1/13471; G02F 1/19; G02F 2201/50

(57) ABSTRACT

A transparent article is described herein that includes: a substrate comprising an opposing first and second primary surface; and an optical film structure disposed on the first primary surface. The optical film structure comprises a scratch-resistant layer, a plurality of alternating high refractive index (RI) and low RI layers, and an outer and inner structure, the scratch-resistant layer disposed between the outer and inner structures. The outer structure can comprise at least one medium RI layer in contact with one of the high RI layers and the scratch-resistant layer. The medium RI layer comprises an RI from 1.55 to 1.80, each of the high RI layers comprises an RI of >1.80, and each of the low RI layers comprises an RI<1.55. A sum of the physical thicknesses of all of the low RI layers in the outer structure can be <200 nm.

### CLAIM OF PRIORITY

This application is a continuation application of U.S. application Ser. No. 18/142,067, filed May 2, 2023, still pending, which claims the benefit of priority under 35 U.S.C. § 119 of U.S. Provisional Application No. 63/337,846 filed May 3, 2022, and claims the benefit of priority under 35 U.S.C. § 119 of U.S. Provisional Application No. 63/441,293 filed Jan. 26, 2023, and claims the benefit of priority under 35 U.S.C. § 119 of U.S. Provisional Application No. 63/462,661 filed Apr. 28, 2023, the content of these documents are hereby incorporated herein by reference in their entirety.

### FIELD

This disclosure relates to transparent articles for protection of optical articles and display devices, and particularly to transparent articles having a substrate with an optical film structure disposed thereon that exhibit various optical and mechanical performance attributes including, but not limited to, high shallow hardness, low reflectance, low glare, high visible and infrared transmittance, low reflected color, color uniformity, minimized overall thickness, retained strength, and minimized, as-deposited warp.

### BACKGROUND

Cover articles with glass substrates are often used to protect critical devices and components within electronic products and systems, such as mobile devices, smart phones, computer tablets, hand-held devices, vehicular displays and other electronic devices with displays, cameras, light sources and/or sensors. These cover articles can also be employed in architectural articles, transportation articles (e.g., articles used in automotive applications, trains, aircraft, sea craft, etc.), appliance articles, or any article that requires some transparency, scratch resistance, abrasion resistance, or a combination thereof.

These applications that employ cover glass articles often demand a combination of mechanical and environmental durability, breakage resistance, damage resistance, scratch resistance and strong optical performance characteristics. For example, the cover articles may be required to exhibit highlight transmittance, low reflectance and/or low transmitted color in the visible spectrum. In some applications, the cover articles are required to cover and protect display devices, cameras, sensors and/or light sources. Further, recent data suggests that high hardness close to the outer surface of the optical structures of cover articles can appreciably improve scratch and abrasion resistance, particularly for scratches that originate from sliding motions with low applied normal forces.

Further, conventional cover articles employing glass or glass-ceramic substrates and optical film structures can suffer from reduced article-level mechanical performance. In particular, the inclusion of optical film structures on these substrates has provided advantages in terms of optical performance and certain mechanical properties (e.g., scratch resistance); however, conventional combinations of these substrates and optical film structures (e.g., as optimized for improved scratch resistance with high modulus and/or hardness) has resulted in inferior strength levels for the resultant article. Notably, it appears that the presence of the optical film structure on the substrate can disadvantageously reduce the strength level of the article to a level below the strength of the substrate in a bare form without the optical film structure.

Accordingly, there is a need for improved cover articles for protection of optical articles and devices, particularly transparent articles that exhibit high shallow hardness (or high hardness more generally), low reflectance, low glare, high visible and infrared transmittance, low reflected color, and color uniformity, along with, in some instances, damage resistance, high modulus and/or high fracture toughness. There is also a need for the foregoing transparent articles which employ optical film structures with minimized overall thickness and as-deposited warp levels, with retained hardness and strength. Further, there is a need for the foregoing transparent articles in which their bare substrate strength levels are retained, or substantially retained (e.g., at or above an application-driven threshold), after the inclusion of their optical film structures. These needs, and other needs, are addressed by the present disclosure.

### SUMMARY

According to an aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, one or both of: (i) the outer structure comprises at least one medium RI layer in contact with one or both of: (a) the scratch-resistant layer and (b) one of the high RI layers; and (ii) a sum of the physical thicknesses of all of the low RI layers in the outer structure is less than about 200 nm. Further, the at least one medium RI layer comprises a refractive index from 1.55 to 1.80, each of the high RI layers comprises a refractive index of greater than 1.80, and each of the low RI layers comprises a refractive index of less than 1.55.

According to an aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. Further, the medium RI layer comprises a refractive index from 1.55 to 1.80, each of the high RI layers comprises a refractive index of greater than 1.80, and each of the low RI layers comprises a refractive index of less than 1.55.

According to another aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, a sum of the physical thicknesses of all of the low RI layers in the outer structure is less than about 75 nm.

According to a further aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one of the high RI layers and the scratch-resistant layer. Further, the medium RI layer comprises a refractive index from 1.55 to 1.80, each of the high RI layers comprises a refractive index of greater than 1.80, and each of the low RI layers comprises a refractive index of less than 1.55. In addition, a sum of the physical thicknesses of all of the low RI layers in the outer structure is less than about 75 nm.

According to an aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, a sum of the physical thicknesses of all of the low RI layers in the outer structure is less than about 75 nm. In addition, the article exhibits an average first-surface photopic reflectance of less than 7% and a first-surface reflectance at a wavelength of 940 nm of less than 8%, each as measured at a near-normal angle of incidence.

According to another aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, a sum of the physical thicknesses of all of the low RI layers in the outer structure is less than about 200 nm. In addition, the article exhibits an average first-surface photopic reflectance of less than 3% and a first-surface reflectance at a wavelength of 940 nm of less than 5%, each as measured at a near-normal angle of incidence.

According to an aspect of the disclosure, a transparent article is provided that includes: a glass-ceramic substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one of the high RI layers and the scratch-resistant layer. Further, the medium RI layer comprises a refractive index from 1.55 to 1.80, each of the high RI layers comprises a refractive index of greater than 1.80, and each of the low RI layers comprises a refractive index of less than 1.55. In addition, the glass-ceramic substrate comprises an elastic modulus of greater than 85 GPa and a fracture toughness of greater than 0.8 MPa·√m.

According to an aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. Further, the at least one medium RI layer comprises a refractive index from 1.55 to 1.80, each of the high RI layers comprises a refractive index of greater than 1.80, and each of the low RI layers comprises a refractive index of less than 1.55. The optical film structure has a physical thickness of from about 200 nm to 5000 nm. Further, the article exhibits a first-surface average photopic reflectance of less than 6%. In addition, the article exhibits one or more of: (i) a hardness of greater than 11 GPa at an indentation depth of about 20 nm or 40 nm; (ii) a hardness of greater than 15 GPa at an indentation depth of 100 nm; and (iii) a hardness of greater than 16 GPa at an indentation depth of 125 nm, as measured by a Berkovich Hardness Test at the outer surface of the optical film structure.

According to an aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. Further, the at least one medium RI layer comprises a refractive index from 1.55 to 1.80, each of the high RI layers comprises a refractive index of greater than 1.80, and each of the low RI layers comprises a refractive index of less than 1.55. The optical film structure has a physical thickness of from about 200 nm to 800 nm. Further, the article exhibits a first-surface average photopic reflectance of less than 6%. In addition, the article exhibits one or more of: (i) a hardness of greater than 9 GPa at an indentation depth of 20 nm; (ii) a hardness of greater than 10 GPa at an indentation depth of 40 nm; (iii) a hardness of greater than 12 GPa at an indentation depth of 100 nm; and (iv) a hardness of greater than 12 GPa at an indentation depth of 125 nm, as measured by a Berkovich Hardness Test at the outer surface of the optical film structure

According to an aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. In addition, the at least one medium RI layer comprises a refractive index from 1.55 to 1.80, each of the high RI layers comprises a refractive index of greater than 1.80, and each of the low RI layers comprises a refractive index of less than 1.55. Further, the scratch-resistant layer has a physical thickness from about 100 nm to less than 2000 nm.

According to other aspects of the disclosure, a display device is provided that includes one or more of the foregoing transparent articles, with each article serving as a protective cover for the display device.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments, wherein:

FIGS. 1A, 1B, 1C, 1D, 1E, 1F, and 1G are cross-sectional side views of transparent articles (e.g., for a display device), according to one or more embodiments of the disclosure;

FIG. 2A is a plan view of an exemplary electronic device incorporating any of the transparent articles disclosed herein;

FIG. 2B is a perspective view of the exemplary electronic device of FIG. 2A;

FIGS. 3A, 4A and 5A are plots of first-surface reflectance vs. wavelength, as measured at a near-normal incident angle of 8°, for three comparative articles, respectively;

FIGS. 3B, 4B and 5B are plots of single-sided, reflected color, as measured at incident angles from 0° to 90° with various optical film structure thickness scaling factors, for the three comparative articles with optical properties in FIGS. 3A, 4A and 5A;

FIGS. 6A, 7A and 8A are plots of first-surface reflectance vs. wavelength, as measured at a near-normal incident angle of 8°, for three transparent articles of the disclosure, respectively;

FIGS. 6B, 7B and 8B are plots of single-sided, reflected color, as measured at incident angles from 0° to 90° with various optical film structure thickness scaling factors, for the three transparent articles of the disclosure with the optical properties in FIGS. 6A, 7A and 8A;

FIG. 9A is a box plot of average article failure stress, as measured in a ring-on-ring test, for the transparent articles of the disclosure with the optical properties in FIGS. 6A-8B, a control article without an optical film structure and a comparative article with the optical properties in FIGS. 4A and 4B;

FIGS. 9B and 9C are plots of hardness and elastic modulus vs. displacement, as measured in a Berkovich Hardness Test of the optical film structures of the transparent articles of the disclosure with the optical properties in FIGS. 6A-8B;

FIGS. 10A, 11A, 12A, 13A, 14A, 15A, 16A, 17A, and 20A are plots of first-surface reflectance vs. wavelength, as measured at a near-normal incident angle of 8°, for nine transparent articles of the disclosure, respectively;

FIGS. 10B, 11B, 12B, 13B, 14B, 15B, 16B, 17B, and 20B are plots of single-sided, reflected color, as measured at incident angles from 0° to 90° with various optical film structure thickness scaling factors, for the nine transparent articles of the disclosure with the optical properties in FIGS. 10A, 11A, 12A, 13A, 14A, 15A, 16A, 17A, and 20A;

FIGS. 18A and 19A are plots of first-surface reflectance vs. wavelength, as measured at a near-normal incident angle of 6°, for two transparent articles of the disclosure, respectively;

FIGS. 18B and 19B are plots of single-sided, reflected color, as measured at incident angles from 0° to 90°, for the two transparent articles of the disclosure with the optical properties in FIGS. 18A and 19A;

FIG. 21 is a table that summarizes the optical and mechanical properties of the comparative and inventive examples of the disclosure;

FIG. 22 is a chart of average article failure stress vs. optical film structure residual stress, as modeled for transparent articles with optical film structures of the disclosure exhibiting different elastic modulus values;

FIG. 23A is a box plot of average article edge failure stress, as measured in a 4-point bend test, for a transparent article of the disclosure and a comparative article without an optical film structure;

FIG. 23B is a plot of single-sided, reflectance vs. wavelength for the transparent article of FIG. 23A, as measured at a near-normal incident angle of 8°;

FIG. 23C is a plot of single-sided reflected color, as measured at incident angles from 0° to 90° with various optical film structure thickness scaling factors, for the transparent article of FIG. 23A;

FIG. 24 is a plot of hardness (GPa) vs. indentation depth (from 0 to 50 nm), as measured in a Berkovich Hardness Test of the optical film structures of a transparent article of the disclosure and a comparative article;

FIG. 25A is a plot of first-surface reflectance vs. wavelength, as measured at a near-normal incident angle of 8°, for a comparative article;

FIG. 25B is a plot of single-sided, reflected color, as measured at incident angles from 0° to 90°, for the comparative article with the optical properties of FIG. 25A;

FIGS. 26A, 27A, 28A, 29A, 30A, 31A, 32A, 33A, 34A, 35A, and 36A are plots of first-surface reflectance vs. wavelength, as measured at a near-normal incident angle of 8°, for eleven transparent articles of the disclosure, respectively;

FIGS. 26B, 27B, 28B, 29B, 30B, 31B, 32B, 33B, 34B, 35B, and 36B are plots of single-sided, reflected color, as measured at incident angles from 0° to 90°, for the transparent articles of the disclosure with the optical properties of FIGS. 26A, 27A, 28A, 29A, 30A, 31A, 32A, 33A, 34A, 35A, and 36A, respectively;

FIG. 29C is a plot of hardness (GPa) vs. indentation depth, as measured in a Berkovich Hardness Test of the optical film structure of the transparent article of the disclosure with the optical properties in FIGS. 29A and 29B;

FIG. 37A is a schematic of a comparative article having an optical film structure with a scratch resistant layer having varying thickness levels;

FIG. 37B is a schematic plot of hardness (GPa) vs. indentation depth, as modeled to be indicative of the results from a Berkovich Hardness Test of the optical film structure of the comparative articles of FIG. 37A;

FIG. 38 is a schematic of the basic fracture mechanics principles of a transparent article of the disclosure;

FIGS. 39A and 39B are schematics of a transparent article of the disclosure, as subjected to pure bending with equal moments, to assess warp as a function of the thickness of the optical film structure;

FIG. 40A is a schematic plot of hardness (GPa) vs. indentation depth, as modeled to be indicative of the results from a Berkovich Hardness Test of the optical film structure of transparent articles of the disclosure having varying levels of scratch resistant layer thickness;

FIG. 40B is a schematic plot of hardness (GPa) vs. scratch resistant layer thickness, as modeled to be indicative of the results from a Berkovich Hardness Test of the optical film structure of the transparent articles of FIG. 40A;

FIGS. 41A and 41B are schematic plots of retained strength (MPa) vs. substrate flaw size, as modeled to be indicative of a ring-on-ring (ROR) test of the transparent articles of FIG. 40A having varying levels of scratch resistant layer thickness and a control sample without an optical film structure;

FIG. 41C is a schematic plot of retained strength (MPa) vs. scratch resistant layer thickness, as modeled to be indicative of the surface retained strength and strength at a depth of 63 μm in an ROR test of the transparent articles of FIG. 40A;

FIG. 42A is a schematic plot of net deflection vs. single side material removal of the transparent articles of FIG. 40A having varying scratch resistant layer thickness levels; and

FIG. 42B is a schematic plot of single side material removal required before deposition of the optical film structure to achieve zero warp as a function of scratch resistant layer thickness for the transparent articles of FIG. 40A.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between material and the surface. The intervening material(s) may constitute a layer, as defined herein.

As used herein, the terms “low RI layer”, “medium RI layer” and “high RI layer” refer to the relative values of the refractive index (“RI”) of layers of an optical film structure of a transparent article according to the disclosure. Hence, the RI of the low RI layer <the RI of the medium RI layer <the RI of the high RI layer, unless otherwise expressly noted in this disclosure. Accordingly, low RI layers have refractive index values that are less than the refractive index values of medium and high RI layers. Further, as used herein, “low RI layer” and “low index layer” are interchangeable with the same meaning. Likewise, “medium RI layer” and “medium index layer” are interchangeable with the same meaning. Similarly, “high RI layer” and “high index layer” are interchangeable with the same meaning.

As used herein the term “glass-ceramic substrate” is not limited to glass-ceramic substrates. Rather, the term “glass-ceramic substrate” refers to a group of substrates that are inclusive of glass-ceramic substrates, ceramic substrates, glass substrates, sapphire substrates, strengthened glass substrates, and strengthened glass-ceramic substrates.

As used herein, the term “strengthened substrate” refers to a substrate employed in a transparent article of the disclosure that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of a single optical film structure or the outer optical film structure of a transparent article of the disclosure with the diamond Berkovich indenter to form an indent to an indentation depth in the range from about 50 nm to about 1000 nm (or the entire thickness of the outer or inner optical film structure, whichever is less) and measuring the maximum hardness from this indentation along the entire indentation depth range or a segment of this indentation depth (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

As used herein, the term “ring-on-ring test”, “Ring-on-Ring Test”, or “ROR Test” refers to a test employed to determine the failure strength or stress (in units of MPa) of transparent articles of the disclosure, along with comparative articles. Each ROR Test was conducted with a test arrangement using loading and supporting rings made of high-strength steel having diameters of 12.7 mm and 25.4 mm, respectively. In addition, the load bearing surfaces of the loading and supporting rings are machined to a radius of about 0.0625 inches to minimize stress concentrations in the contact region between the rings and the transparent articles. Further, the loading ring is placed on the outermost primary surface of the transparent article (e.g., on the outer surface of its optical film structure) and the supporting ring is placed on the innermost primary surface of the transparent article (e.g., on the second primary surface of its substrate). The loading ring incorporates a mechanism that enables articulation of the loading ring and that insures proper alignment and uniform loading of the test sample. In addition, each ROR Test was conducted by applying the loading ring against the transparent article at a loading rate of 1.2 mm/min. The term “average” in the context of an ROR Test is based on the mathematical average of failure stress measurements made on five (5) samples. Further, unless stated otherwise in specific instances of the disclosure, all failure stress values and measurements described herein refer to measurements from the ROR testing, which places the outer surface of the article in tension, as described in International Publication No. WO2018/125676, published on Jul. 5, 2018, entitled “Coated Articles with Optical Coatings Having Residual Compressive Stress,” and incorporated herein by reference in its entirety. A failure in each ROR Test typically occurs on the side of the sample opposite the loading ring, which is in tension, and finite element modeling is used to provide an appropriate conversion from failure load to failure stress at the location of the failure. It is also understood that other failure strength tests can be employed to determine the failure strengths of the transparent articles of the disclosure, with an appropriate correlation made to the ROR values and results reported herein in this disclosure based on differences in test conditions, test specimen geometry, and other technical considerations understood by those with ordinary skill in the field. Nevertheless, unless otherwise noted, all average failure strength values reported for the transparent articles of the disclosure, along with comparative articles, are given as measured from an ROR Test.

As used herein, the terms “Four-point Bend Test”, “4-point Bend Test”, and “4-pt Bend Test” or the like refer to a mechanical property test conducted on the transparent articles of the disclosure according to the ASTM C158 Standard Test Methods for Strength of Glass by Flexure, incorporated herein by reference in its entirety. In the context of this disclosure, all transparent articles subjected to such testing were tested with either the side of the article having the optical film structure in compression (i.e., facing up) or in tension (i.e., facing down), unless otherwise noted. Comparative control articles without an optical film structure, but with an easy-to-clean (ETC) coating, were tested with either the side of the ETC coating in compression (i.e., facing up) or in tension (i.e., facing down). In all other respects, all testing in the disclosure referred to as a Four-point Bend Test was conducted according to the ASTM C158 protocol.

As used herein, the term “transmittance” is defined as the percentage of incident optical power within a given wavelength range transmitted through a material (e.g., the article, the substrate or the optical film or portions thereof). The term “reflectance” is similarly defined as the percentage of incident optical power within a given wavelength range that is reflected from a material (e.g., the article, the substrate, or the optical film or portions thereof). Transmittance and reflectance are measured using a specific linewidth. As used herein, an “average transmittance” refers to the average amount of incident optical power transmitted through a material over a defined wavelength regime. As used herein, an “average reflectance” refers to the average amount of incident optical power reflected by the material.

As used herein, “photopic reflectance” mimics the response of the human eye by weighting the reflectance or transmittance, respectively, versus wavelength spectrum according to the human eye's sensitivity. Photopic reflectance may also be defined as the luminance, or tristimulus Y value of reflected light, according to known conventions such as CIE color space conventions. The “average photopic reflectance”, as used herein, for a wavelength range from 380 nm to 720 nm is defined in the below equation as the spectral reflectance, R(λ) multiplied by the illuminant spectrum, I(λ) and the CIE's color matching function y̅(λ), related to the eye's spectral response:

$$〈 {R}_{p} 〉 = {\int }_{380 n m}^{720 n m} R ( λ ) \times I ( λ ) \times \overline{y} ( λ ) d λ$$

In addition, “average reflectance” can be determined over the visible spectrum, or over other wavelength ranges, according to measurement principles understood by those skilled in the field of the disclosure, e.g., in the infrared spectrum from 840 nm to 950 nm, etc. Unless otherwise noted, all reflectance values reported or otherwise referenced in this disclosure are associated with testing through both primary surfaces of the substrate and optical film structure(s) of the transparent articles of the disclosure, e.g., a “two-surface” average photopic reflectance. In cases where “one-surface” or “first-surface” reflectance is specified, the reflectance from the rear surface of the article is eliminated through optical bonding to a light absorber, allowing the reflectance of only the first surface to be measured.

The usability of a transparent article in an electronic device (e.g., as a protective cover) can be related to the total amount of reflectance in the article. Photopic reflectance is particularly important for display devices that employ visible light. Lower reflectance in a cover transparent article over a lens and/or a display associated with the device can reduce multiple-bounce reflections in the device that can generate ‘ghost images’. Thus, reflectance has an important relationship to image quality associated with the device, particularly its display and any of its other optical components (e.g., a lens of a camera). Low-reflectance displays also enable better display readability, reduced eye strain, and faster user response time (e.g., in an automotive display, where display readability can also correlate to driver safety). Low-reflectance displays can also allow for reduced display energy consumption and increased device battery life, since the display brightness can be reduced for low-reflectance displays compared to standard displays, while still maintaining the targeted level of display readability in bright ambient environments.

As used herein, “photopic transmittance” is defined in the below equation as the spectral transmittance, T(λ) multiplied by the illuminant spectrum, I(λ) and the CIE's color matching function y̅(λ), related to the eye's spectral response:

$$〈 {T}_{p} 〉 = {\int }_{380 n m}^{720 n m} T ( λ ) \times I ( λ ) \times \overline{y} ( λ ) d λ$$

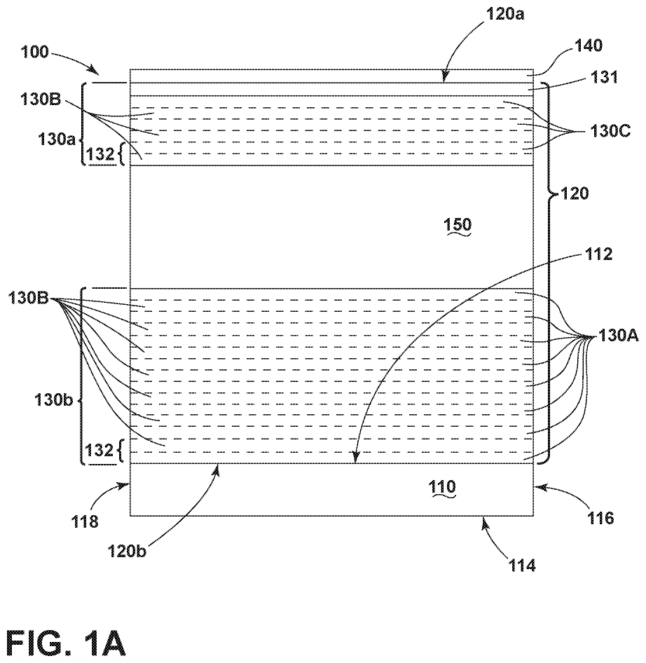

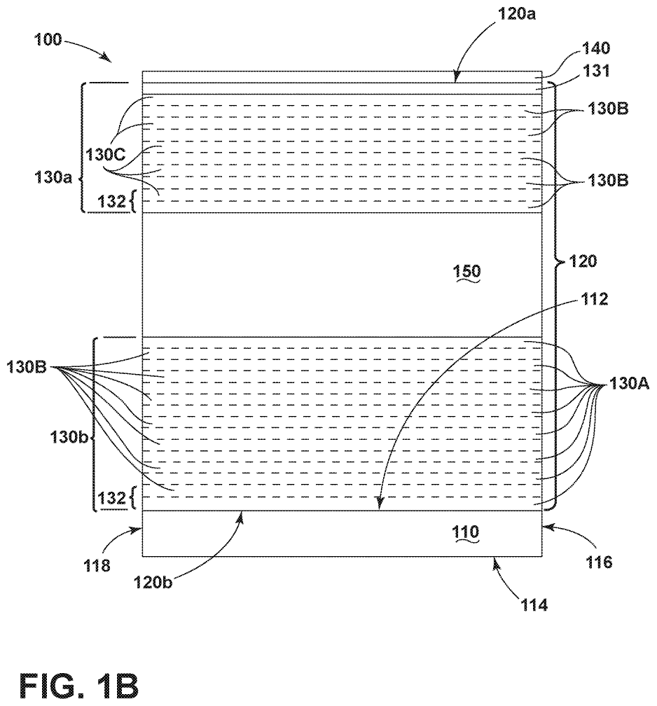

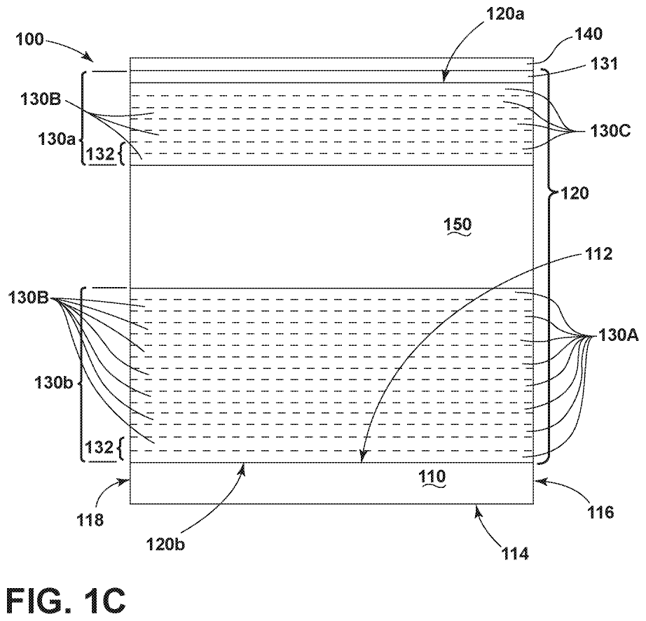

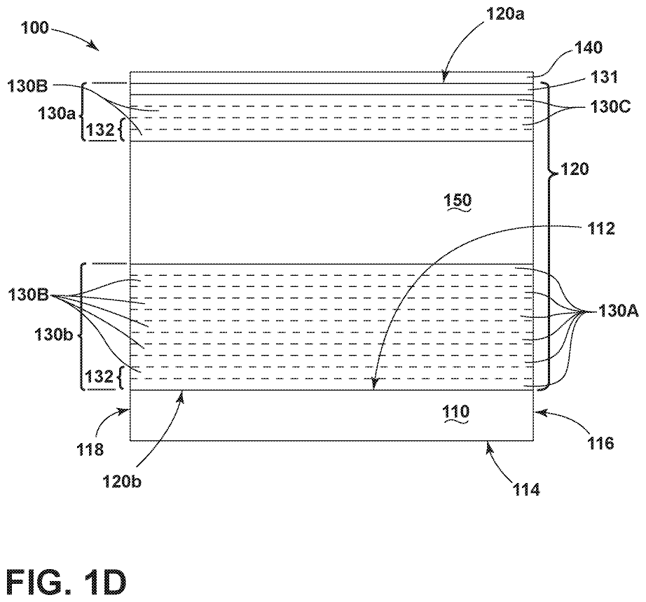

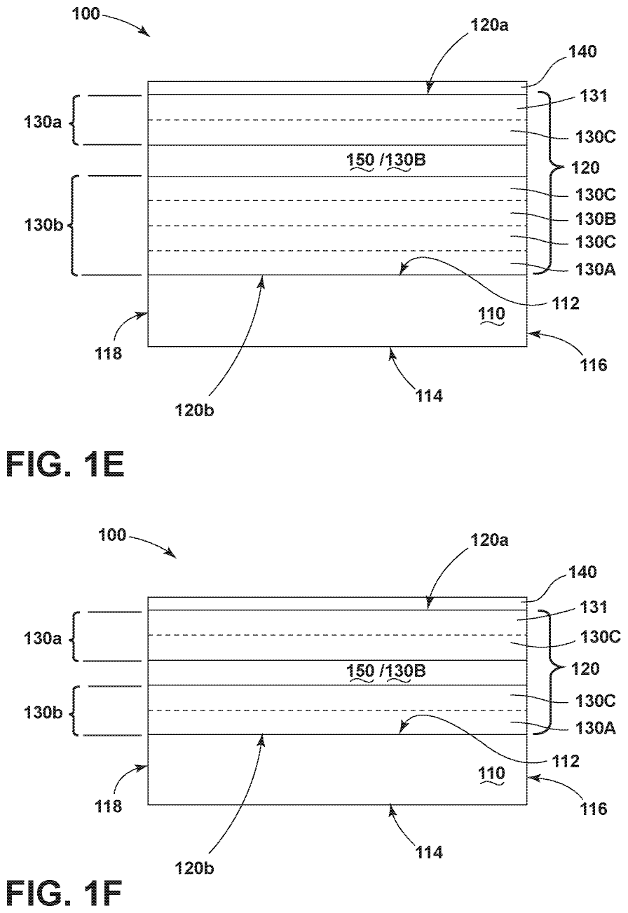

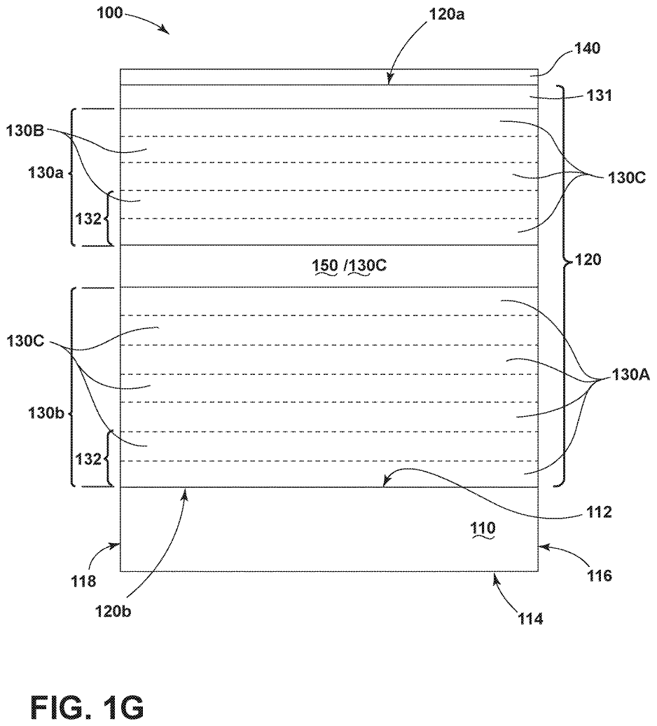

In addition, “average transmittance” or “average photopic transmittance” can be determined over the visible spectrum or other wavelength ranges, according to measurement principles understood by those skilled in the field of the disclosure, e.g., in the infrared spectrum from 840 nm to 950 nm, etc. Unless otherwise noted, all transmittance values reported or otherwise referenced in this disclosure and claims are associated with testing through both primary surfaces of the substrate and the optical film structure (e.g., the substrate 110, primary surfaces 112, 114, and optical film structure 120 as shown in FIGS. 1A-1D and described below) of the transparent articles, e.g., a “two-surface” average photopic transmittance.

As used herein, “transmitted color” and “reflected color” refer to the color transmitted or reflected through the transparent articles of the disclosure with regard to color in the CIE L*,a*,b* colorimetry system under a D65 illuminant. More specifically, the “transmitted color” and “reflected color” are given by √(a*²+b*²), as these color coordinates are measured through transmission or reflectance of a D65 illuminant through the primary surfaces of the substrate of the transparent article (e.g., the substrate 110, primary surfaces 112, 114, and optical film structure 120 as shown in FIGS. 1A-1D and described below) over an incident angle range, e.g., from 0 degrees to 10 degrees.

As also used herein, an “optical film structure thickness scaling factor” and “thickness scaling factor” are interchangeable and generally refer to expected differences in the thickness of the optical film structures of the disclosure that can occur from vapor deposition of the optical film structure on a non-planar substrate or non-planar portions of a substrate. These optical film structure thickness differences as a function of methods employed to deposit these structures on substrates are detailed in U.S. Provisional Patent Application No. 63/314,041, filed on Feb. 25, 2022, the salient portions of which related to thickness scaling factors and similar concepts are hereby incorporated by reference in this disclosure. In turn, these variances in the thickness of the optical film structure may result in non-uniformity of transmitted and/or reflected color exhibited by the transparent articles of the disclosure possessing such optical film structures. As such, transmitted and reflected color values are reported in this disclosure for various thickness scaling factors such that “100%” corresponds to color measurements on an optical film structure on a planar surface of the substrate or at the maximum thickness of the optical film structure on a surface of the substrate, “90%” corresponds to the color measurements on an optical film structure on a non-planar surface having 90% of the thickness of the portion of the optical film structure on an adjacent planar surface or the portion of the optical film structure on a surface of the substrate having a maximum thickness, and so on.

Generally, the disclosure is directed to transparent articles that employ optical film structures over substrates, including strengthened substrates. Further, these transparent articles can include a high toughness, high modulus glass-ceramic substrate that is optically transparent, with a high-hardness optical coating having controlled transmittance and color. In view of this combination of substrate and optical film structure, the transparent article can exhibit a high shallow hardness, while also exhibiting transparency, low reflectance, high visible and IR transmittance, and low color. In addition, transparent articles of the disclosure can advantageously exhibit failure strength levels that are the same as, or substantially close to, the failure strength levels of a bare glass-ceramic substrate.

In aspects of these transparent articles, the optical film structures are configured such that the articles that employ them exhibit a hardness of at least about 12 GPa, at least about 15 GPa, or even at least about 17 GPa, at a Barkovich nanoindentation depth of about 125 nm from the outer surface of the optical film structure. The optical film structure may comprise a multilayer optical interference film composed of SiO₂, SiOₓ, SiOₓN_{y}, SiN_{y}, and/or Si₃N₄ layers, which comprises a scratch-resistant layer (e.g., as embedded within the structure). According to some implementations, an outer structure of the optical film structure above the scratch-resistant layer can be configured with at least one medium RI layer (e.g., SiOₓN_{y}) in contact with one of the high RI layers and the scratch-resistant layer (e.g., SiOₓN_{y} or SiN_{y}) and/or a sum of the physical thicknesses of all of the low RI layers (e.g., SiO₂ or SiOₓN_{y}) in the outer structure limited to about 75 nm or less. Some or all of these structural characteristics can enable or otherwise significantly influence the achievement of these shallow high hardness levels.

The transparent articles of the disclosure can be employed for protection and/or covers of displays, camera lenses, sensors and/or light source components within or otherwise part of electronic devices, along with protection of other components (e.g., buttons, speakers, microphones, etc.). These transparent articles with a protective function employ an optical film structure disposed on a substrate such that the article exhibits a combination of high shallow hardness and desirable optical properties. Advantageously, these shallow high hardness levels are exhibited by the transparent articles of the disclosure without an appreciable loss in optical properties, e.g., low reflectance in the visible and IR spectra and low reflected color.

As also outlined in the disclosure, the foregoing, advantageous article-level high shallow hardness levels can be achieved through the control of the composition and/or arrangement of the optical film structures employed in the transparent articles. Notably, these hardness levels can be achieved by the articles of the disclosure while maintaining desired optical properties. In terms of optical properties, the transparent articles of the disclosure can exhibit an average first-surface reflectance of less than 6%, 5%, or even 4%; a first-surface reflectance at a wavelength of 940 nm of less than 7%, 6%, or even 5%; and an average first-surface reflectance at IR wavelengths of less than 10%, 9%, or even 8%, all as measured at a near-normal angle of incidence.

The transparent articles with a protective function can also employ an optical film structure disposed on a glass-ceramic substrate such that the article exhibits a combination of high hardness, high damage resistance and desirable optical properties, including high photopic transmittance and low transmitted color. The optical film structure can include a scratch-resistant layer, at any of various locations within the structure. Further, the optical film structures of these articles can include a plurality of alternating high and low refractive index layers, with each high index layer and a scratch resistant layer comprising nitride or an oxynitride and each low index layer comprising an oxide.

With regard to mechanical properties, embodiments of the transparent articles of the disclosure can exhibit a maximum hardness of 10 GPa or greater or 12 GPa or greater (or even greater than 14 GPa in some instances), as measured by a Berkovich Hardness Test over an indentation depth range from 100 nm to about 500 nm in the optical film structure. The glass-ceramic substrates employed in these articles can have an elastic modulus of greater than 85 GPa, or greater than 95 GPa in some instances. These glass-ceramic substrates also can exhibit a fracture toughness of greater than 0.8 MPa·√m, or greater than 1 MPa·√m in some instances.

According to some embodiments of the transparent articles of the disclosure, advantageous article-level failure stress levels can be achieved through the control of the composition, arrangement and/or processing of the optical film structures employed in the transparent articles. Notably, the composition, arrangement and/or processing of the optical film structures can be adjusted to obtain residual compressive stress levels of at least 700 MPa (e.g., from 700 to 1100 MPa) and an elastic modulus of at least 140 GPa (e.g., from 140 to 170 GPa, from 140 to 180 GPa, from 140 to 190 GPa, or from 140 to 200 GPa). These optical film structure mechanical properties unexpectedly correlate to average failure stress levels of 500 MPa or greater, 600 MPa or greater, or even 700 MPa or greater, in the transparent articles employing these optical film structures, as measured in an ROR test with the outer surface of the optical film structure of the article placed in tension.

Referring to FIGS. 1A-1D, a transparent article 100 according to one or more embodiments may include a substrate 110, and an optical film structure 120 defining an outer surface 120a and an inner surface 120b disposed on the substrate 110. The substrate 110 includes opposing primary surfaces 112, 114 and opposing secondary surfaces 116, 118. The optical film structure 120 is shown in FIGS. 1A-1D, with its inner surface 120b disposed on a first opposing primary surface 112 and no optical film structures are shown as being disposed on the second opposing primary surface 114. In some embodiments, however, one or more of the optical film structures 120 can be disposed on the second opposing primary surface 114 and/or on one or both of the opposing secondary surfaces 116, 118.

The optical film structure 120 includes at least one layer of material. As used herein, the term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layer may be formed by any known method in the art, including discrete deposition or continuous deposition processes. In one or more embodiments, the layer may be formed using only continuous deposition processes, or, alternatively, only discrete deposition processes.

In one or more embodiments, a single layer or multiple layers of the optical film structure 120 may be deposited onto the glass-ceramic substrate 110 by a vacuum deposition technique such as, for example, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used such as spraying, dipping, spin coating, or slot coating (e.g., using sol-gel materials). Generally, vapor deposition techniques may include a variety of vacuum deposition methods which can be used to produce thin films. For example, physical vapor deposition uses a physical process (such as heating or sputtering) to produce a vapor of material, which is then deposited on the object which is coated. Preferred methods of fabricating the optical film structure 120 can include reactive sputtering, metal-mode reactive sputtering and PECVD processes.

The optical film structure 120 may have a physical thickness of from about 100 nm to about 10 microns. For example, the optical film structure 120 may have a thickness greater than or equal to about 200 nm, 300 nm, 325 nm, 350 nm, 375 nm, 400 nm, 500 nm, 600 nm, 700 nm, 800 nm, 900 nm, 1 micron, 2 microns, 3 microns, 4 microns, 5 microns, 6 microns, 7 microns, or even 8 microns, and less than or equal to about 10 microns. In some implementations of the transparent articles 100 depicted in FIGS. 1A-1D, the optical film structure 120 has a physical thickness from 2 microns to 4 microns, 2.25 microns to 3.75 microns, or 2.5 microns to 3.5 microns.

In some embodiments, as depicted for example in FIGS. 1A-1D, the optical film structure 120 is divided into an outer structure 130a and an inner structure 130b, with a scratch-resistant layer 150 (as detailed further below) disposed between the structures 130a and 130b. In these embodiments, the outer and inner optical film structures 130a and 130b may have the same thicknesses or different thicknesses, and each comprises one or more layers.

Referring again to the transparent article 100 depicted in FIGS. 1A-1D, the optical film structure 120 includes one or more scratch-resistant layer(s) 150. For example, the transparent article 100 depicted in FIGS. 1A-1D includes an optical film structure 120 with a scratch-resistant layer 150 disposed over a primary surface 112 of the substrate 110. According to one embodiment, the scratch-resistant layer 150 may comprise one or more materials chosen from SiᵤAlᵥOₓN_{y}, Ta₂O₅, Nb₂O₅, AlN, AlNₓ, SiAlₓN_{y}, AlNₓ/SiAlₓN_{y}, Si₃N₄, AlOₓN_{y}, SiOₓN_{y}, SiN_{y}, SiNₓ:H_{y}, HfO₂, TiO₂, ZrO₂, Y₂O₃, Al₂O₃, MoO₃, diamond-like carbon, or combinations thereof. Exemplary materials used in the scratch-resistant layer 150 may include an inorganic carbide, nitride, oxide, diamond-like material, or combinations thereof. Examples of suitable materials for the scratch-resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 150 may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y}, and combinations thereof. In some implementations, the scratch-resistant layer 150 may include Si₃N₄, SiN_{y}, SiOₓN_{y}, and combinations thereof. In some embodiments, each of the scratch-resistant layers 150 employed in the transparent article 100 may exhibit an effective fracture toughness value greater than about 1 MPa√m and simultaneously exhibits a hardness value greater than about 10 GPa, as measured by a Berkovich Hardness Test.

Each of the scratch-resistant layers 150, as shown in exemplary form in the transparent article 100 depicted in FIGS. 1A-1D, can be comprised of any of the foregoing materials such that it exhibits a refractive index (RI) of greater than 1.80. In some implementations, the RI of the scratch-resistant layer 150 is greater than 1.80, greater than 1.85, or greater than 1.90. For example, the RI of the scratch-resistant layer 150 can be 1.80, 1.85, 1.9, 1.95, 2.0, 2.05, 2.10, 2.15, 2.20, 2.25, 2.3, 2.35, 2.4, 2.45, 2.5, and all RI values between the foregoing values.

Each of the scratch-resistant layers 150, as shown in exemplary form in the transparent article 100 depicted in FIGS. 1A-1D, may be relatively thick as compared with other layers (e.g., low RI layers 130A, high RI layers 130B, medium RI layers 130C, capping layer 131, etc.) such as greater than or equal to about 50 nm, 75 nm, 100 nm, 150 nm, 200 nm, 250 nm, 300 nm, 325 nm, 350 nm, 375 nm, 400 nm, 425 nm, 450 nm, 475 nm, 500 nm, 525 nm, 550 nm, 575 nm, 600 nm, 700 nm, 800 nm, 900 nm, 1 micron, 2 microns, 3 microns, 4 microns, 5 microns, 6 microns, 7 microns, or even 8 microns. For example, a scratch-resistant layer 150 may have a thickness from about 50 nm to about 10 microns, from about 100 nm to about 10 microns, from about 150 nm to about 10 microns, from about 500 nm to 7500 nm, from about 500 nm to about 6000 nm, from about 500 nm to about 5000 nm, and all thickness levels and ranges between the foregoing ranges. In other implementations, the scratch-resistant layer 150 may have a thickness from about 100 nm to about 10,000 nm, from about 1000 nm to about 3000 nm, or from about 1500 nm to about 2500 nm.

As shown in FIGS. 1A-1D, and outlined above, the transparent articles 100 of the disclosure include an optical film structure 120 with one or more of an outer structure 130a and inner structure 130b. The optical film structure 120 includes a plurality of alternating low RI and high RI layers, 130A and 130B, respectively. In embodiments, each, or one of, the outer and inner structures 130a, 130b includes a plurality of alternating low RI and high RI layers, 130A and 130B, respectively. In embodiments, each, or one of, the outer and inner structures 130a, 130b includes a plurality of alternating medium RI and high RI layers, 130C and 130B, respectively. In some preferred implementations, the outer structure 130a includes at least one medium RI layer 130C in contact with one of the high RI layers 130B and the scratch-resistant layer 150. In some preferred implementations, the outer structure 130a is inclusive of at least one outermost capping layer 131, as depicted in exemplary form in FIGS. 1A-1D.

According to embodiments, each of the outer and inner structures 130a and 130b includes a period 132 of two or more layers, such as the low RI layer 130A and high RI layer 130B; or a low RI layer 130A, high RI layer 130B and a low RI layer 130A; or a high RI layer 130B and a medium RI layer 130C. Further, each of the outer and inner structures 130a and 130b of the optical film structure 120 may include a plurality of periods 132, such as 1 to 30 periods, 1 to 25 periods, 1 to 20 periods, and all periods within the foregoing ranges. In addition, the number of periods 132, the number of layers of the outer and inner structures 130a and 130b, and/or the number of layers within a given period 132 can differ or they may be the same. Further, in some implementations, the total amount of the plurality of alternating low RI and high RI layers 130A and 130B and the scratch-resistant layer 150 may range from 6 to 50 layers, 6 to 40 layers, 6 to 30 layers, 6 to 28 layers, 6 to 26 layers, 6 to 24 layers, 6 to 22 layer, 6 to 20 layers, 6 to 18 layers, 6 to 16 layers, and 6 to 14 layers, and all ranges of layers and amounts of layers between the foregoing values.

As an example, in FIGS. 1A-1D the periods 132 of the outer or inner structures 130a, 130b include a low RI layer 130A and a high RI layer 130B or a medium RI layer 130C and a high RI layer 130B. When a plurality of periods is included in either or both of the outer and inner structures 130a and 130b, the low RI layers 130A (designated as “L”), the medium RI layers 130C (designated “M”), and the high RI layers 130B (designated as “H”) can alternate in the following sequence of layers: L/H/L/H . . . , H/L/H/L . . . , M/H/M/H . . . , H/M/H/M . . . , such that the low RI layers 130A and the high RI layers 130B, or the medium RI layers 130C and the high RI layers 130B, alternate along the physical thickness of the outer and inner structures 130a, 130b of the optical film structure 120. In preferred implementations, as shown in FIGS. 1A-1D, the periods 132 in the outer structures 130a are configured as H/M/H/M . . . above the scratch-resistant layer 150; and the periods 132 in the inner structures 130b are configured as L/H/L/H . . . above the substrate 110 and beneath the scratch-resistant layer 150.

In an implementation of the transparent article 100, as shown in FIG. 1A, the number of periods 132 of the outer and inner structures 130a and 130b can be configured such that the outer structure 130a includes a total of six (6) alternating layers (e.g., alternating medium and high RI layers 130C and 130B); and the inner structure 130b includes at least fifteen (15) layers (e.g., alternating low RI and high RI layers 130A, 130B, respectively). Further, in this implementation, the outer structure 130a of the optical film structure 120 includes a capping layer 131 (similar in structure and thickness to a low RI layer 130A) over the outer structure 130a; and a scratch-resistant layer 150 between the outer and inner structures 130a and 130b.

In an implementation of the transparent article 100, as shown in FIG. 1B, the number of periods 132 of the outer and inner structures 130a and 130b can be configured such that the outer structure 130a includes a total of ten (10) alternating layers (e.g., alternating medium and high RI layers 130C and 130B); and the inner structure 130b includes at least fifteen (15) layers (e.g., alternating low RI and high RI layers 130A, 130B, respectively). Further, in this implementation, the outer structure 130a of the optical film structure 120 includes a capping layer 131 (similar in structure and thickness to a low RI layer 130A) over the outer structure 130a; and a scratch-resistant layer 150 between the outer and inner structures 130a and 130b.

In an implementation of the transparent article 100, as shown in FIG. 1C, the number of periods 132 of the outer and inner structures 130a and 130b can be configured such that the outer structure 130a includes a total of six (6) alternating layers (e.g., alternating medium and high RI layers 130C and 130B) and an additional, repeating medium RI layer 130C adjacent to another medium RI layer 130C; and the inner structure 130b includes at least fifteen (15) layers (e.g., alternating low RI and high RI layers 130A, 130B, respectively). Further, in this implementation, the outer structure 130a of the optical film structure 120 includes a capping layer 131 (similar in structure and thickness to a low RI layer 130A) over the outer structure 130a; and a scratch-resistant layer 150 between the outer and inner structures 130a and 130b.

In an implementation of the transparent article 100, as shown in FIG. 1D, the number of periods 132 of the outer and inner structures 130a and 130b can be configured such that the outer structure 130a includes a total of four (4) alternating layers (e.g., alternating medium and high RI layers 130C and 130B); and the inner structure 130b includes at least eleven (11) layers (e.g., alternating low RI and high RI layers 130A, 130B, respectively). Further, in this implementation, the outer structure 130a of the optical film structure 120 includes a capping layer 131 (similar in structure and thickness to a low RI layer 130A) over the outer structure 130a; and a scratch-resistant layer 150 between the outer and inner structures 130a and 130b.

According to another implementation of the transparent articles 100 of the disclosure (not shown), the number of periods 132 of the outer and inner structures 130a and 130b can be configured such that the outer structure 130a includes at least two (2) layers (e.g., an alternating low and high RI layer 130A and 130B) and the inner structure 130b includes at least five (5) layers (e.g., two periods 132 of alternating low RI and high RI layers 130A, 130B, and an additional period 132 of three (3) layers, alternating low RI/high RI/low RI layers 130A, 130B). Also, in this implementation, the optical film structure 120 includes a capping layer 131 (similar in structure and thickness to a low RI layer 130A) over the outer structure 130a; and a scratch-resistant layer 150 between the outer and inner structures 130a and 130b. In embodiments of this implementation, the transparent article 100 does not include any medium RI layer 130C.

According to some embodiments of the transparent article 100 depicted in FIGS. 1A-1D, the outermost capping layer 131 of the optical film structure 120 and outer structure 130a may not be exposed but instead have a top coating 140 disposed thereon. In some implementations of the transparent article 100, the scratch-resistant layer 150 and each high RI layer 130B of the optical film structure 120, along with the outer and inner structures 130a, 130b, comprises a nitride, a silicon-containing nitride (e.g., SiN_{y}, Si₃N₄), an oxynitride, or a silicon-containing oxynitride (e.g., SiAlₓO_{y}N_{z} or SiOₓN_{y}). Further, according to some embodiments, each low RI layer 130A of the optical film structure 120, along with the outer and inner structures 130a, 130b, comprises an oxide, a silicon-containing oxide (e.g., SiO₂, SiOₓ or SiO₂ as doped with Al, N or F), or a silicon-containing oxynitride (e.g., SiOₓN_{y}). In addition, according to some embodiments, each medium RI layer 130C of the optical film structure 120, along with the outer and inner structures 130a, 130b, comprises an oxynitride or a silicon-containing oxynitride (e.g., SiAlₓO_{y}N_{z} or SiOₓN_{y}).

In one or more embodiments of the transparent article 100 depicted in FIGS. 1A-1D, the term “low RI”, when used with the low RI layers 130A and/or capping layer 131, includes a refractive index range of less than 1.55, from about 1.3 to about 1.55, and all indices within these ranges. In one or more embodiments, the term “medium RI”, when used with the medium RI layers 130C, includes a refractive index range from 1.55 to 1.80, 1.56 to 1.80, 1.6 to 1.75, and all indices within these ranges. In one or more embodiments, the term “high RI”, when used with the high RI layers 130B and/or scratch-resistant layer 150, includes a refractive index range of greater than 1.80, greater than 1.90, from about 1.8 to about 2.5, from about 1.8 to about 2.3, or from about 1.90 to about 2.5, and all indices between these ranges. Further, in a specific implementation, the medium RI layer(s) of the transparent articles 100 of the disclosure (see, e.g., FIGS. 1A-1D), may include a refractive index range from 1.55 to 1.90 or 1.55 to 1.85, and all values between these ranges, which may overlap in refractive index with the high RI layers 130B (e.g., as having a refractive index of greater than 1.80) of the optical film structure 120 or may not overlap in refractive index with the high RI layers 130B (e.g., as having a refractive index of greater than 1.90). In one or more embodiments, the difference in the refractive index of each of the low RI layers 130A (and/or capping layer 131), the medium RI layers 130C, and/or the high RI layers 130B (and/or scratch-resistant layer 150) may be about 0.01 or greater, about 0.05 or greater, about 0.1 or greater, or even about 0.2 or greater.

Example materials suitable for use in the outer and inner structures 130a and 130b of the optical film structure 120 of the transparent article 100 depicted in FIGS. 1A-1D include, without limitation, SiO₂, SiOₓ, Al₂O₃, SiAlₓO_{y}, GeO₂, SiO, AlOₓN_{y}, AlN, AlNₓ, SiAlₓN_{y}, SiN_{y}, SiOₓN_{y}, SiAlₓO_{y}N_{z}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, diamond-like carbon and combinations thereof. Some examples of suitable materials for use in a low RI layer 130A and the outermost capping layer 131 include, without limitation, SiO₂, SiOₓ, Al₂O₃, SiAlₓO_{y}, GeO₂, SiO, AlOₓN_{y}, SiOₓN_{y}, SiAlₓO_{y}N_{z}, MgO, MgAlₓO_{y}, MgF₂, BaF₂, CaF₂, DyF₃, YbF₃, YF₃, and CeF₃. In some implementations of the transparent article 100, each of its low RI layers 130A includes a silicon-containing oxide (e.g., SiO₂ or SiOₓ) or a silicon-containing oxynitride (e.g., SiOₓN_{y}). The nitrogen content of the materials for use in a low RI layer 130A may be minimized (e.g., in materials such as SiOₓN_{y}, Al₂O₃ and MgAlₓO_{y}). Some examples of suitable materials for use in a high RI layer 130B include, without limitation, SiAlₓO_{y}N_{z}, Ta₂O₅, Nb₂O₅, AlN, AlNₓ, SiAlₓN_{y}, AlN/SiAlₓN_{y}, Si₃N₄, AlOₓN_{y}, SiOₓN_{y}, SiN_{y}, SiNₓ:H_{y}, HfO₂, TiO₂, ZrO₂, Y₂O₃, Al₂O₃, MoO₃, and diamond-like carbon. Some examples of suitable materials for use in a medium RI layer 130C include, without limitation, SiAlₓO_{y}N_{z}, AlOₓN_{y}, SiOₓN_{y}, HfO₂, Y₂O₃, and Al₂O₃. According to some implementations, each high RI layer 130B of the outer and inner structures 130a, 130b includes a silicon-containing nitride or a silicon-containing oxynitride (e.g., Si₃N₄, SiN_{y}, or SiOₓN_{y}). In one or more embodiments, each of the high RI layers 130B may have high hardness (e.g., hardness of greater than 8 GPa), and the high RI materials listed above may comprise high hardness and/or scratch resistance.

The oxygen content of the materials for the high RI layer 130B may be minimized, especially in SiN_{y} materials. Further, exemplary SiOₓN_{y} high RI materials may comprise from about 0 atom % to about 20 atom % oxygen, or from about 5 atom % to about 15 atom % oxygen, while including 30 atom % to about 50 atom % nitrogen. The foregoing materials may be hydrogenated up to about 30% by weight. Where a material having a medium refractive index is desired as a medium RI layer 130C, some embodiments may utilize SiOₓN_{y}, e.g., with a relatively low level of nitrogen (e.g., less than 3%). It should be understood that a scratch-resistant layer 150 may comprise any of the materials disclosed as suitable for use in a high RI layer 130B.

In one or more embodiments of the transparent article 100, the optical film structure 120 includes a scratch-resistant layer 150 that can be integrated as a high RI layer 130B, and one or more low RI layers 130A, high RI layers 130B, and/or a capping layer 131 may be positioned over the scratch-resistant layer 150. Also, with regard to the scratch-resistant layer 150, as shown in FIGS. 1A-1D, an optional top coating 140 may also be positioned over the layer 150. The scratch-resistant layer 150 may be alternately defined as the thickest high RI layer 130B in the overall optical film structure 120 and/or in the outer and the inner structures 130a, 130b.

Without being bound by theory, it is believed that the transparent article 100 depicted in FIGS. 1A-1D may exhibit increased hardness at low indentation depths (e.g., 100-125 nm) when one or more medium RI layers 130C (e.g., as comprising SiOₓN_{y}) is placed in direct contact with one or more high RI layers 130B (e.g., SiOₓN_{y}, SiN_{y}) in the outer structure 130a; the sum of the physical thicknesses of the low RI layers 130A and/or the capping layer 131 in the outer structure 130a is minimized; and the total thickness of the layers in the outer structure 130A is minimized. In some implementations, an additional, repeating medium RI layer 130C can be deployed in the outer structure 130a in contact with another medium RI layer 130C to also increase hardness at shallow depths within the optical film structure 120, as depicted in the article 100 shown in FIG. 1C. According to some implementations, the sum of the physical thicknesses of the low RI layers 130A and/or the capping layer 131 in the outer structure 130a is configured to be less than about 275 nm, less than about 250 nm, less than about 225 nm, less than about 200 nm, less than about 175 nm, less than about 150 nm, less than about 125 nm, less than 110 nm, less than 100 nm, less than 90 nm, less than 75 nm, less than 65 nm, less than 50 nm, or even less than 25 nm, which can also increase hardness at shallow depths within the optical film structure 120. For example, the sum of the physical thicknesses of the low RI layers 130A and/or the capping layer 131 in the outer structure 130a can be 250 nm, 225 nm, 200 nm, 175 nm, 150 nm, 125 nm, 120 nm, 110 nm, 100 nm, 90 nm, 80 nm, 70 nm, 60 nm, 50 nm, 40 nm, 30 nm, 20 nm, 10 nm, and all total thickness values between the foregoing values. Further, in some implementations, the total physical thickness of the layers in the outer structure 130a of the transparent articles 100 depicted in FIGS. 1A-1D can be configured to be less than 500 nm, less than 450 nm, less than 400 nm, less than 350 nm, less than 300 nm, less than 250 nm, less than 200 nm, or even less than 150 nm, and all total thickness values in the foregoing ranges.

Referring again to the transparent articles 100 depicted in FIGS. 1A-1D, these articles may also exhibit a correlation between achievable reflectance levels and the amount of low RI material (e.g., volume of low RI layer(s) 130A) in the outer structure 130a of the optical film structure 120. Thus, for optical film structures 120 with photopic average first-surface reflectance values of about 3.5-7%, the sum of the physical thicknesses of all of the low RI layers 130A (e.g., SiO₂ or SiOₓN_{y} with an RI (refractive index, n)<1.55) in the outer structure 130a can be limited to about 75 nm or less, and in the best cases, less than 20 nm, which leads to especially high hardness at shallow indentation depths of about 125 nm. For those embodiments of the articles 100 (including some of the actual Examples below) achieving lower photopic average first-surface reflectance values of 1-2.5%, first-surface reflectance at 940 nm wavelength of less than 4%, and average reflectance from 1000-1700 nm of less than 10.5%, the sum of the physical thicknesses of all of the low RI layer(s) 130A (e.g., SiO₂ or SiOₓN_{y} with n<1.55) in the outer structure 130a can be limited to about 200 nm or less, and in the best cases, less than 65 nm.

Referring again to the transparent articles 100 depicted in FIGS. 1A-1D, according to some embodiments, each of the low RI layers 130A of the optical film structure 120 may have a hardness greater than 5 GPa, each of the medium RI layers 130C may have a hardness greater than 10 GPa, and each of the high RI layers 130B and the scratch resistant layer 150 may have a hardness greater than 12 GPa, as measured by a Berkovich Hardness Test. Without being bound by theory, the use of medium RI layers 130C contributes to creating high hardness at shallow depths through two mechanisms: 1) reduction of the amount of low RI, low hardness material in the outer structure 130a of the optical film structure 120 (e.g., minimizing the volume of low RI layer(s) 130A); and 2) the inclusion of the relatively higher hardness of the medium RI materials employed in the medium RI layer(s) 130C, as compared to the low RI materials of the low RI layer(s) 130A that are replaced by medium RI materials in the optical film structure 120.

According to some embodiments of the transparent articles 100, the articles may exhibit increased hardness at indentation depths when a relatively thin amount of material is deposited over the scratch-resistant layer 150. However, the inclusion of low RI and high RI layers 130A, 130B over the scratch-resistant layer 150 may enhance the optical properties of the transparent article 100. In some embodiments, relatively few layers (e.g., only 1, 2, 3, 4, or 5 layers) may be positioned over the scratch-resistant layer 150 and these layers may each be relatively thin (e.g., less than 100 nm, less than 75 nm, less than 50 nm, or even less than 25 nm).

In one or more embodiments, the transparent article 100 depicted in FIGS. 1A-1D may include one or more additional top coatings 140 disposed on the outer structure 130a of the optical film structure 120. In one or more embodiments, the additional top coating 140 may include an easy-to-clean coating. An example of a suitable easy-to-clean coating is described in U.S. Patent Application Publication No. 2014/0113083, published on Apr. 24, 2014, entitled “Process for Making of Glass Articles with Optical and Easy-to-Clean Coatings”, which is incorporated herein by reference in its entirety. The easy-to-clean coating may have a thickness in the range from about 5 nm to about 50 nm and may include known materials such as fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating of the top coating 140 may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm, from about 7 nm to about 10 nm, from about 1 nm to about 90 nm, from about 5 nm to about 90 nm, from about 10 nm to about 90 nm, or from about 5 nm to about 100 nm, and all ranges and sub-ranges therebetween.

The top coating 140 may include a scratch-resistant layer or layers which comprise any of the materials disclosed as being suitable for use in the scratch-resistant layer 150. In some embodiments, the additional top coating 140 includes a combination of easy-to-clean material and scratch-resistant material. In one example, the combination includes an easy-to-clean material and diamond-like carbon. Such an additional top coating 140 may have a thickness in the range from about 5 nm to about 20 nm. The constituents of the additional coating 140 may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a-C—H.

According to embodiments of the transparent article 100 depicted in FIGS. 1A-1D, each of the high RI layers 130B of the outer and inner structures 130a, 130b of the optical film structure 120 can have a physical thickness that ranges from about 5 nm to 5000 nm, 5 nm to 2000 nm, about 5 nm to 1500 nm, about 5 nm to 1000 nm, and all thicknesses and ranges of thickness between these values. For example, these high RI layers 130B can have a physical thickness of 5 nm, 10 nm, 20 nm, 30 nm, 40 nm, 50 nm, 60 nm, 70 nm, 80 nm, 90 nm, 100 nm, 250 nm, 500 nm, 750 nm, 1000 nm, 1250 nm, 1500 nm, 1750 nm, 2000 nm, 2500 nm, 3000 nm, 4000 nm, 5000 nm, and all thickness values between these levels. Further, each of the high RI layers 130B of the inner structure 130b can have a physical thickness that ranges from about 5 nm to 500 nm, about 5 nm to 400 nm, about 5 nm to 300 nm, and all thicknesses and ranges of thickness between these values. As an example, each of these high RI layers 130B can have a physical thickness of 5 nm, 10 nm, 20 nm, 30 nm, 40 nm, 50 nm, 60 nm, 70 nm, 80 nm, 90 nm, 100 nm, 200 nm, 300 nm, 400 nm, 500 nm, and all thickness values between these levels.

In addition, according to some embodiments of the transparent article 100 depicted in FIGS. 1A-1D, each of the low RI layers 130A and medium RI layers 130C of the outer and inner structures 130a, 130b can have a physical thickness from about 5 nm to 300 nm, about 5 nm to 250 nm, about 5 nm to 200 nm, and all thicknesses and ranges of thickness between these values. For example, each of these low RI layers 130A can have a physical thickness of 5 nm, 10 nm, 20 nm, 30 nm, 40 nm, 50 nm, 60 nm, 70 nm, 80 nm, 90 nm, 100 nm, 150 nm, 200 nm, 250 nm, 300 nm, and all thickness values between these levels.

In one or more embodiments, at least one of the layers (such as a low RI layer 130A, a high RI layer 130B, and/or a medium RI layer 130C) of the outer and inner structures 130a, 130b of the optical film structure 120 may include a specific optical thickness (or optical thickness range). As used herein, the term “optical thickness” refers to the product of the physical thickness and the refractive index of a layer. In one or more embodiments, at least one of the layers of the outer and inner structures 130a, 130b may have an optical thickness in the range from about 2 nm to about 200 nm, from about 10 nm to about 100 nm, from about 15 nm to about 100 nm, from about 15 nm to about 500 nm, or from about 15 nm to about 5000 nm. In some embodiments, all of the layers in the outer and inner structures 130a, 130b may each have an optical thickness in the range from about 2 nm to about 200 nm, from about 10 nm to about 100 nm, from about 15 nm to about 100 nm, from about 15 nm to about 500 nm, or from about 15 nm to about 5000 nm. In some embodiments, at least one layer of either or both of the outer and inner structures 130a, 130b has an optical thickness of about 50 nm or greater. In some embodiments, each of the low RI layers 130A and/or the medium RI layers 130C have an optical thickness in the range from about 2 nm to about 200 nm, from about 10 nm to about 100 nm, from about 15 nm to about 100 nm, from about 15 nm to about 500 nm, or from about 15 nm to about 5000 nm. In some embodiments, each of the high RI layers 130B has an optical thickness in the range from about 2 nm to about 200 nm, from about 10 nm to about 100 nm, from about 15 nm to about 100 nm, from about 15 nm to about 500 nm, or from about 15 nm to about 5000 nm. In some embodiments, the scratch-resistant layer 150 is the thickest layer in the optical film structure 120, and/or has an RI higher than that of any other layer in the film structure.

The substrate 110 of the transparent article 100 depicted in FIGS. 1A-1D may include an inorganic material with amorphous and crystalline portions. The substrate 110 may be formed from man-made materials and/or naturally occurring materials (e.g., quartz). In some specific embodiments, the substrate 110 may specifically exclude polymeric, plastic and/or metal substrates. The substrate 110 may be characterized as an alkali-including substrate (i.e., the substrate includes one or more alkalis). In one or more embodiments, the substrate 110 exhibits a refractive index in the range from about 1.5 to about 1.6. In specific embodiments, the substrate 110 (e.g., a glass-ceramic substrate) may exhibit an average strain-to-failure at a surface on one or more opposing primary surfaces 112, 114 that is 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater or even 2% or greater, as measured using an ROR Test using at least 5, at least 10, at least 15, or at least 20 samples to determine the average strain-to-failure value. In specific embodiments, the substrate 110 may exhibit an average strain-to-failure at its surface on one or more opposing primary surfaces 112, 114 of about 1.2%, about 1.4%, about 1.6%, about 1.8%, about 2.2%, about 2.4%, about 2.6%, about 2.8%, or about 3% or greater.

The term “strain-to-failure” refers to the strain at which cracks propagate in the outer or inner structures 130a, 130b of the optical film structure 120, substrate 110, or both simultaneously without application of additional load, typically leading to catastrophic failure in a given material, layer or film and perhaps even bridge to another material, layer, or film, as defined herein. That is, breakage of the optical film structure 120 (i.e., as including outer and/or inner structures 130a, 130b) without breakage of the substrate 110 constitutes failure, and breakage of the substrate 110 also constitutes failure. The term “average” when used in connection with average strain-to-failure or any other property is based on the mathematical average of measurements of such property on 5 samples. Typically, crack onset strain measurements are repeatable under normal laboratory conditions, and the standard deviation of crack onset strain measured in multiple samples may be as little as 0.01% of observed strain. Average strain-to-failure as used herein was measured using an ROR Test. However, unless stated otherwise, strain-to-failure measurements described herein refer to measurements from the ring-on-ring testing, as described in International Publication No. WO2018/125676, published on Jul. 5, 2018, entitled “Coated Articles with Optical Coatings Having Residual Compressive Stress,” and incorporated herein by reference in its entirety.

Suitable substrates 110 (e.g., a glass-ceramic substrate) may exhibit an elastic modulus (or Young's modulus) in the range from about 60 GPa to about 130 GPa. In some instances, the elastic modulus of the substrate 110 may be in the range from about 70 GPa to about 120 GPa, from about 80 GPa to about 110 GPa, from about 80 GPa to about 100 GPa, from about 80 GPa to about 90 GPa, from about 85 GPa to about 110 GPa, from about 85 GPa to about 105 GPa, from about 85 GPa to about 100 GPa, from about 85 GPa to about 95 GPa, and all ranges and sub-ranges therebetween (e.g., ~103 GPa). In some implementations, the elastic modulus of the substrate 110 may be greater than 85 GPa, greater than 90 GPa, greater than 95 GPa, or even greater than 100 GPa. In some examples, Young's modulus may be measured by sonic resonance (ASTM E1875), resonant ultrasound spectroscopy, or nanoindentation using Berkovich indenters. Further, suitable substrates 110 (e.g., glass-ceramic substrates) may exhibit a shear modulus in the range from about 20 GPa to about 60 GPa, from about 25 GPa to about 55 GPa, from about 30 GPa to about 50 GPa, from about 35 GPa to about 50 GPa, and shear modulus ranges and sub-ranges therebetween (e.g., ~43 GPa). In some implementations, the substrate 110 may have a shear modulus of greater than 35 GPa, or even greater than 40 GPa. Further, the substrates 110 can exhibit a fracture toughness of greater than 0.8 MPa·√m, greater than 0.9 MPa·√m, greater than 1 MPa·√m, or even greater than 1.1 MPa·√m in some instances (e.g., ~1.15 MPa·√m).

In one or more embodiments, an amorphous substrate 110 may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of lithia. In one or more alternative embodiments, the substrate 110 may include crystalline substrates such as glass ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

In one or more embodiments, the substrate 110 includes one or more glass-ceramic materials and may be strengthened or non-strengthened. In one or more embodiments, the substrates 110 as a glass-ceramic material may comprise one or more crystalline phases such as lithium disilicate, lithium metasilicate, petalite, beta quartz, and/or beta spodumene, as potentially combined with residual glass in the structure. In an embodiment, the substrate 110 comprises a disilicate phase. In another implementation, the substrate 110 comprises a disilicate phase and a petalite phase. According to an embodiment, the substrate 110 has a crystallinity of at least 40% by weight. In some implementations, the substrate 110 has a crystallinity of at least about 40%, 45%, 50%, 55%, 60%, 65%, 70%, 75%, 80%, 85%, or greater (by weight), with the residual as a glass phase. Further, according to some embodiments, each of the crystalline phases of the substrate 110 has an average crystallite size of less than 100 nm, less than 75 nm, less than 50 nm, less than 40 nm, less than 30 nm, and all crystallite sizes within or less than these levels. According to one exemplary embodiment, the substrate 110 comprises lithium disilicate and petalite phases with 40 wt. % lithium disilicate, 45 wt. % petalite, and the remainder as residual glass (i.e., ~85% crystalline, and ~15% residual amorphous/glass); each crystalline phase having a majority of crystals with an average crystallite size in the range of 10 nm to 50 nm.

Embodiments of the substrate 110 employed in the transparent article 100 of the disclosure (see, e.g., FIGS. 1A-1D) can exhibit a refractive index that is higher than refractive indices of conventional glass substrates or strengthened glass substrates. For example, the refractive index of the substrates 110 can range from about 1.52 to 1.65, from about 1.52 to 1.64, from about 1.52 to 1.62, or from about 1.52 to 1.60, and all refractive indices within the foregoing ranges (e.g., as measured at a visible wavelength of 589 nm). As such, conventional optical coatings, which are typically optimized for glass substrates and their refractive index ranges, are not necessarily suitable for use with substrates 110 as comprising glass-ceramic material of the transparent articles 100 of the disclosure. In particular, the layers of the optical film structure 120 between the substrate 110 and the scratch-resistant layer 150 can be modified to achieve low reflectance and low color generated by the transition zone between the glass-ceramic substrate 110 and the scratch-resistant layer 150. This layer re-design requirement can also be described as optical impedance matching between the substrate 110 and the scratch-resistant layer 150.

According to implementations, the substrate 110 is substantially optically clear, transparent and free from light scattering. In such embodiments, the substrate 110 may exhibit an average light transmittance over the optical wavelength regime of about 80% or greater, about 81% or greater, about 82% or greater, about 83% or greater, about 84% or greater, about 85% or greater, about 86% or greater, about 87% or greater, about 88% or greater, about 89% or greater, about 90% or greater, about 91% or greater, about 92% or greater, about 93% or greater, or even about 94% or greater. In some embodiments, these light reflectance and transmittance values may be a total reflectance or total transmittance (taking into account reflectance or transmittance on both primary surfaces 112, 114 of the substrate 110) or may be observed on a single-side of the substrate 110 (i.e., on the primary surface 112 only, without taking into account the opposite surface 114). Unless otherwise specified, the average reflectance or transmittance of the substrate 110 alone is measured at an incident illumination angle of 0 degrees relative to the primary surface 112 (however, such measurements may be provided at incident illumination angles of 45 degrees or 60 degrees).

Additionally or alternatively, the physical thickness of the substrate 110 may vary along one or more of its dimensions for aesthetic and/or functional reasons. For example, the edges of the substrate 110 may be thicker as compared to more central regions of the substrate 110. In other implementations, the edges of the substrate 110 may be thinner as compared to more central regions of the substrate 110. Further, in some embodiments, portions of the substrate 110 (e.g., edge portions) may be non-planar (e.g., beveled, chamfered, curved, etc.). The length, width and physical thickness dimensions of the substrate 110 may also vary according to the application or use of the article 100.

The substrate 110 may be provided using a variety of different processes. For instance, where the substrate 110 includes an amorphous portion or phase such as glass, various forming methods can include float glass processes and down-draw processes such as fusion draw and slot draw.

Once formed, a substrate 110 may be strengthened to form a strengthened substrate, e.g., through chemical strengthening by an ion exchange process, thermal tempering, and/or utilizing a mismatch of the coefficient of thermal expansion between portions of the substrate to create compressive stress and central tension regions.

Where the substrate 110 is chemically strengthened by an ion exchange process, the ions in the surface layer of the substrate 110 are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate 110 in a salt bath (or baths), use of multiple salt baths, additional steps such as annealing, washing, and the like, are generally determined by the composition of the substrate 110 and the desired compressive stress (CS), depth of compressive stress layer (or depth of layer) of the substrate 110 that result from the strengthening operation. By way of example, ion exchange of alkali metal-containing substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 530° C., while immersion times range from about 15 minutes up to about 40 hours. However, temperatures and immersion times different from those described above may also be used.

The degree of chemical strengthening achieved by ion exchange may be quantified based on the parameters of central tension (CT), surface CS, depth of compression (DOC) (i.e., the point in the substrate in which the stress state changes from compression to tension), and depth of layer of potassium ions (DOL). Compressive stress (including surface CS) is measured by a surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass-ceramic material. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Refracted near-field (RNF) method or a scattered light polariscope (SCALP) technique may be used to measure the stress profile. When the RNF method is utilized to measure the stress profile, the maximum CT value provided by SCALP is utilized in the RNF method. In particular, the stress profile measured by RNF is force balanced and calibrated to the maximum CT value provided by a SCALP measurement. The RNF method is described in U.S. Pat. No. 8,854,623, issued Oct. 7, 2014, entitled “Systems and Methods for Measuring a Profile Characteristic of a Glass Sample”, which is incorporated herein by reference in its entirety. In particular, the RNF method includes placing the glass-ceramic article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass-ceramic sample from the normalized detector signal. The maximum CT values are measured using a scattered light polariscope (SCALP) technique known in the art.

In one embodiment of the transparent article 100 (see FIGS. 1A-1D), a strengthened substrate 110 can have a surface CS of 200 MPa or greater, 250 MPa or greater, 300 MPa or greater, or 350 MPa or greater. In another implementation, a strengthened substrate can exhibit a residual surface compressive stress (CS) of from about 200 MPa to about 1200 MPa, from about 200 MPa to about 1000 MPa, from about 200 MPa to about 800 MPa, from about 200 MPa to about 600 MPa, from about 200 MPa to about 500 MPa, from about 200 MPa to about 400 MPa, from about 225 MPa to about 400 MPa, from 250 MPa to about 400 MPa, and all CS sub-ranges and values in the foregoing ranges. The strengthened substrate 110 may have a DOL of from 1 μm to 5 μm, from 1 μm to 10 μm, or from 1 μm to 15 μm and/or a central tension (CT) of 50 MPa or greater, 75 MPa or greater, 100 MPa or greater, 125 MPa or greater (e.g., 80 MPa, 90 MPa, or 100 MPa or greater) but less than 250 MPa (e.g., 200 MPa or less, 175 MPa or less, 150 MPa or less, etc.). In such implementations of the transparent articles 100 with substrates 110 having a CT from about 50 MPa to about 200 MPa or 80 MPa to about 200 MPa, the thickness of the substrate 110 should be limited to about 0.6 mm or less to ensure that the substrate is not frangible. For implementations employing thicker substrates, e.g., with a thickness up to 0.8 mm, 0.9 mm, 1.0 mm, 1.1 mm, 1.2 mm, 1.3 mm, 1.4 mm, or even up to 1.5 mm, the upper limit of CT should be held to levels below 200 MPa to ensure that the substrate is not frangible (e.g., 150 MPa for a thickness of 0.8 mm).

The depth of compression (DOC) of the substrate 110 may be from 0.1. (thickness (t) of the substrate) to about 0.25·t, for example from about 0.15·t to about 0.25·t, or from about 0.15·t to about 0.20·t, and all DOC values between the foregoing ranges. For example, the substrate 110 can have a DOC of 20% of the thickness of the substrate, as compared to 15% or less for ion-exchanged glass substrates. In some implementations, the DOC of the substrate 110 can be from about 5 μm to about 150 μm, from about 5 μm to about 125 μm, from about 5 μm to about 100 μm, and all DOC values between the foregoing ranges. In some embodiments, the depths of compression for the substrate materials can from ~8% to ~20% of the thickness of the substrate 110. Note that the foregoing DOC values are as measured from one of the primary surfaces 112 or 114 of the substrate 110. As such, for a substrate 110 with a thickness of 600 μm, the DOC may be 20% of the thickness of the substrate, ~120 μm from each of the primary surfaces 112, 114 of the substrate 110, or 240 μm in total for the entire substrate. In one or more specific embodiments, the strengthened substrate 110 can exhibit one or more of the following mechanical properties: a surface CS of from about 200 MPa to about 400 MPa, a DOL of greater than 30 μm, a DOC of from about 0.08·t to about 0.25·t, and a CT from about 80 MPa to about 200 MPa.

According to embodiments of the disclosure, the substrate 110 (without the optical film structure 120 disposed thereon for measurement purposes) can exhibit a maximum hardness of 8.5 GPa or greater, 9 GPa or greater, or 9.5 GPa or greater (or even greater than 10 GPa in some instances), as measured by a Berkovich Hardness Test over an indentation depth range from 100 nm to about 500 nm in the substrate 110. For example, the substrate 110 can exhibit a maximum hardness of 8.5 GPa, 8.75 GPa, 9 GPa, 9.25 GPa, 9.5 GPa, 9.75 GPa, 10 GPa, and higher hardness levels, as measured by a Berkovich Hardness Test over an indentation depth range from 100 nm to about 500 nm in the substrate 110. Further, substrates 110 of the disclosure can exhibit a Vicker's hardness of greater than 700, or even greater than 800, as measured using a 200 g load. In addition, substrates 110 of the disclosure can exhibit a Mohs hardness of greater than 6.5, or even greater than 7.

As noted earlier, the substrate 110 may be non-strengthened or strengthened, and with a suitable composition to support strengthening. Examples of suitable glass ceramics for the substrate 110 may include a Li₂O—Al₂O₃—SiO₂ system (i.e., an LAS system) glass ceramics, MgO—Al₂O₃—SiO₂ system (i.e., an MAS System) glass ceramics, and/or glass ceramics that include a predominant crystal phase including β-quartz solid solution, β-spodumene ss, cordierite, and lithium disilicate. Such glass-ceramic substrates as substrate 110 may be strengthened using the chemical strengthening processes disclosed herein. In one or more embodiments, MAS-System glass-ceramic substrates may be strengthened in Li₂SO₄ molten salt, whereby an exchange of 2Li⁺ for Mg²⁺ can occur.

According to some embodiments of the transparent article 100 of the disclosure, the substrate 110 may be a glass-ceramic material of an LAS system with the following composition: 70-80% SiO₂, 5-10% Al₂O₃, 10-15% Li₂O, 0.01-1% Na₂O, 0.01-1% K₂O, 0.1-5% P₂O₅ and 0.1-7% ZrO₂ (in wt. %, oxide basis). In some implementations of the transparent article 100 of the disclosure, the substrate 110 may be an LAS system with the following composition: 70-80% SiO₂, 5-10% Al₂O₃, 10-15% Li₂O, 0.01-1% Na₂O, 0.01-1% K₂O, 0.1-5% P₂O₅ and 0.1-5% ZrO₂ (in wt. %, oxide basis). According to another embodiment, the substrate 110 may be an LAS system with the following composition: 70-75% SiO₂, 5-10% Al₂O₃, 10-15% Li₂O, 0.05-1% Na₂O, 0.1-1% K₂O, 1-5% P₂O₅, 2-7% ZrO₂ and 0.1-2% CaO (in wt. %, oxide basis). According to a further embodiment, the substrate 110 can have the following composition: 71-72% SiO₂, 6-8% Al₂O₃, 10-13% Li₂O, 0.05-0.5% Na₂O, 0.1-0.5% K₂O, 1.5-4% P₂O₅, 4-7% ZrO₂ and 0.5-1.5% CaO (in wt. %, oxide basis). More generally, these compositions of the substrate 110 are advantageous for the transparent articles 100 of the disclosure because they exhibit low haze levels, high transparency, high fracture toughness, and high elastic modulus, and are ion-exchangeable.

According to embodiments of the transparent article 100, the substrates 110 as glass-ceramic materials are selected with any of the compositions of the disclosure and further processed to the crystallinity levels of the disclosure to exhibit a combination of high fracture toughness (e.g., greater than 1 MPa·√m) and high elastic modulus (e.g., greater than 100 GPa). These mechanical properties can be derived from the presence of the crystalline phase (e.g., the lithium disilicate phase), which exhibits a relatively high modulus; and the microstructure of the final substrate 110, which includes some residual glass phase. Notably, the residual glass phase (and its alkali-containing composition) ensures that the substrate 110 can be ion-exchange strengthened to a high level of central tension (CT) (e.g., greater than 80 MPa) and compressive stress (CS) (e.g., greater than 200 MPa). Further, the ceramming (i.e., the post-melt processing, heat treatment conditions) can be chosen to minimize the grain size of the substrate 110 such that the grain size is smaller than the wavelength of visible light, thereby ensuring that the substrate 110 and article 100 is transparent or substantially transparent. Ultimately, the composition and processing of the substrate 110 as comprising a glass-ceramic material is advantageously selected to achieve a balance of high fracture toughness, high elastic modulus and optical transparency to ensure that the transparent article 100, as employing these substrates 110 and an optical film structure 120, exhibits this balance of mechanical and optical properties, along with a surprising level of damage resistance.

The substrate 110 according to one or more embodiments can have a physical thickness ranging from about 100 μm to about 5 mm in various portions of the substrate 110. Example substrate 110 physical thicknesses range from about 100 μm to about 500 μm (e.g., 100, 200, 300, 400 or 500 μm), from about 500 μm to about 1000 μm (e.g., 500, 600, 700, 800, 900 or 1000 μm), and from about 500 μm to about 1500 μm (e.g., 500, 750, 1000, 1250, or 1500 μm), for example. In some implementations, the substrate 110 may have a physical thickness greater than about 1 mm (e.g., about 2, 3, 4, or 5 mm). In one or more specific embodiments, the substrate 110 may have a physical thickness of 2 mm or less, or less than 1 mm. The substrate 110 may be acid polished or otherwise treated to remove or reduce the effect of surface flaws.

With regard to the hardness of the transparent articles 100 depicted in FIGS. 1A-1D, typically, in nanoindentation measurement methods (such as by using a Berkovich indenter) where the coating is harder than the underlying substrate, the measured hardness may appear to increase initially due to development of the plastic zone at shallow indentation depths (e.g., less than 25 nm or less than 50 nm) and then increases and reaches a maximum value or plateau at deeper indentation depths (e.g., from 50 nm to about 500 nm or 1000 nm). Thereafter, hardness begins to decrease at even deeper indentation depths due to the effect of the underlying substrate. Where a substrate 110 having a greater hardness compared to the optical film structure 120 is utilized, the same effect can be seen; however, the hardness increases at deeper indentation depths due to the effect of the underlying substrate.

With further regard to the transparent articles 100 depicted in FIGS. 1A-1D, the indentation depth range and the hardness values at certain indentation depth ranges can be selected to identify a particular hardness response of the optical film structure 120 and the layers of the outer and inner structures 130a, 130b thereof, described herein, without the effect of the underlying substrate 110. When measuring hardness of the optical film structure 120 (when disposed on a substrate 110) with a Berkovich indenter, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate 110. The influence of the substrate 110 on hardness occurs at deeper indentation depths (i.e., typically at depths greater than about 10% of the total thickness of the optical film structure 120). Moreover, a further complication is that the hardness response requires a certain minimum load to develop full plasticity during the indentation process. Prior to that certain minimum load, the hardness shows a generally increasing trend.

At small indentation depths (which also may be characterized as small loads) (e.g., up to about 50 nm) in the optical film structure 120, the apparent hardness of a material appears to increase dramatically versus indentation depth. This small indentation depth regime does not represent a true metric of hardness but, instead, reflects the development of the aforementioned plastic zone, which is related to the finite radius of curvature of the indenter. At intermediate indentation depths, the apparent hardness approaches maximum levels. At deeper indentation depths, the influence of the substrate 110 becomes more pronounced as the indentation depths increase. Hardness may begin to drop dramatically once the indentation depth exceeds about 30% of the optical coating thickness.

In one or more embodiments, the transparent article 100, as depicted in FIGS. 1A-1D, may exhibit a hardness that is greater than about 15 GPa, 16 GPa, 17 GPa, 18 GPa, or 19 GPa, at an indentation depth of 100-125 nm, or at a depth of 125 nm, as measured from the outer surface 120a of the optical film structure 120 by a Berkovich Indenter Hardness Test, which is indicative of high shallow hardness.

In one or more embodiments, the transparent article 100 may exhibit a maximum hardness of about 10 GPa or greater, about 11 GPa or greater, about 12 GPa or greater, about 13 GPa or greater, or about 14 GPa or greater, as measured from the outer surface 120a of the optical film structure 120 by a Berkovich Indenter Hardness Test over an indentation depth from about 100 nm to about 500 nm, or over an indentation depth from about 100 nm to about 900 nm. For example, the transparent article 100 can exhibit a maximum hardness of 10 GPa, 11 GPa, 12 GPa, 13 GPa, 14 GPa, 15 GPa, 16 GPa, 17 GPa, 18 GPa, 19 GPa, 20 GPa, or greater, as measured from the outer surface 120a of the optical film structure 120 by a Berkovich Indenter Hardness Test over an indentation depth from about 100 nm to about 500 nm. In some implementations, the maximum hardness of the transparent article 100 is greater than 8 GPa, 10 GPa, 11 GPa, 12 GPa, 13 GPa, 14 GPa, 15 GPa, 16 GPa, 17 GPa, 18 GPa, or 19 GPa, at an indentation depth of 100 nm. In some implementations, the maximum hardness of the transparent article 100 is greater than 8 GPa, 10 GPa, 12 GPa, 14 GPa, 16 GPa, 17 GPa, 18 GPa, or 19 GPa, at an indentation depth of 500 nm. Further, according to some implementations, the transparent article 100 may exhibit a maximum hardness of about 8 GPa or greater, about 10 GPa or greater, about 12 GPa or greater, or about 14 GPa or greater, 15 GPa or greater, 16 GPa or greater, 17 GPa or greater, or even 18 GPa or greater, as measured from the outer surface 120a of the optical film structure 120 by a Berkovich Indenter Hardness Test over indentation depth ranges from about 100 nm to 500 nm, from about 100 nm to about 900 nm, or from about 200 nm to about 900 nm.

In one or more embodiments of the disclosure, the transparent article 100, as depicted in FIGS. 1A-1D and with a substrate 110 comprising a glass-ceramic material, exhibits an average failure stress level of 500 MPa or greater, 600 MPa or greater, 700 MPa or greater, 750 MPa or greater, 800 MPa or greater, or even 850 MPa or greater, as measured in an ROR Test with the outer surface 120a of the optical film structure 120 of these articles placed in tension. Essentially, these article-level average failure stress levels are unexpectedly indicative of transparent articles 100 with optical film structures 120 that have not experienced any loss, or have not experienced any substantial loss, in failure strength relative to the strength of their bare glass-ceramic substrates. In some embodiments, the transparent article 100 exhibits an average failure stress level of 500 MPa, 550 MPa, 600 MPa, 650 MPa, 700 MPa, 725 MPa, 750 MPa, 775 MPa, 800 MPa, 825 MPa, 850 MPa, 875 MPa, 900 MPa, 925 MPa, 950 MPa, 975 MPa, 1000 MPa, 1025 MPa, 1050 MPa, 1075 MPa, 1100 MPa, and all average failure stress levels between the foregoing values, as measured in an ROR Test with the outer surface 120a of the optical film structure 120 of the article placed in tension.

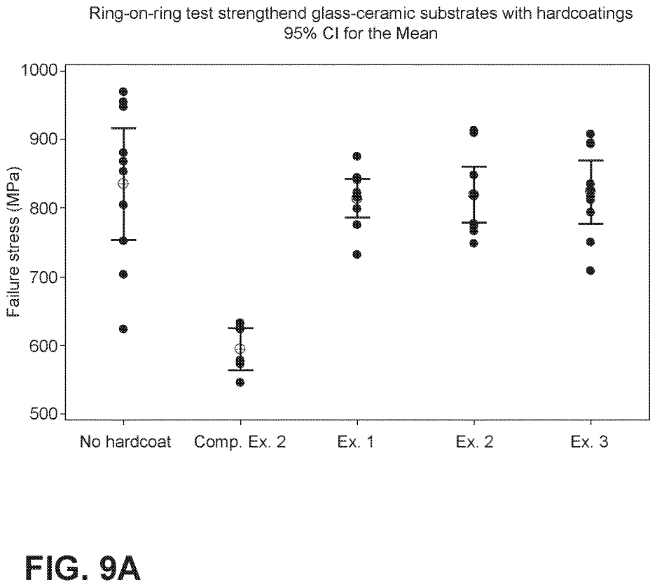

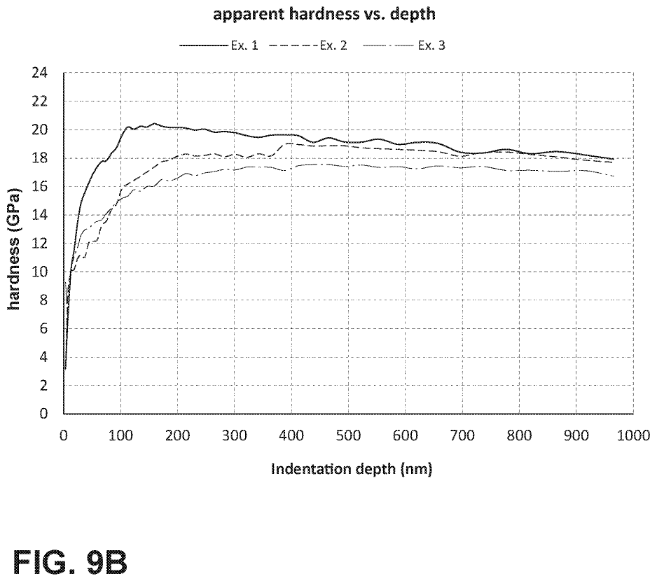

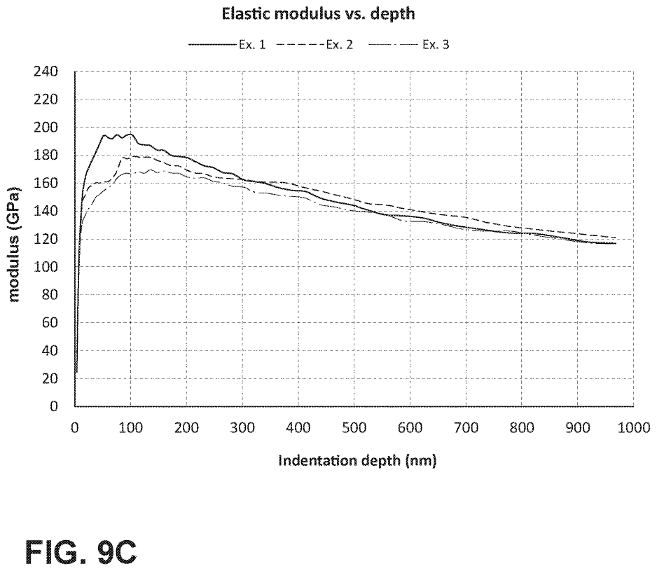

Referring again to the transparent articles 100 (see FIGS. 1A-1D) with average ROR failure stress levels of 700 MPa or greater, it should be understood that these failure stress levels can be achieved through the control of the composition, arrangement and/or processing of the optical film structures 120 employed in the transparent articles 100. Notably, the composition, arrangement and/or processing of the optical film structures 120 can be adjusted to obtain residual compressive stress levels of at least 700 MPa (e.g., from 700 to 1100 MPa) and a maximum elastic modulus of at least 120 GPa (e.g., from 120 to 200 GPa, from 140 to 200 GPa, from 140 to 170 GPa, or from 140 to 180 GPa). In some cases, it is useful to quantify the elastic modulus of the optical film structure 120 at a depth equal to 15% of the total thickness of the optical film structure 120 to more accurately compare the modulus of the optical film structure 120 for different thicknesses. Using this metric, the preferred range of elastic modulus at a depth equal to 15% of the total thickness of the optical film structure 120 can be adjusted to the range of 120 to 180 GPa or 120 to 160 GPa. These mechanical properties of the optical film structures 120 unexpectedly correlate to average failure stress levels of 500 MPa or greater, 600 MPa or greater, or 700 MPa or greater in the transparent articles 100 employing these optical film structures (see FIG. 9A and the subsequent corresponding description below), as measured in an ROR Test with the outer surface 120a of the optical film structure of the article placed in tension.

With further regard to the residual compressive stress and elastic modulus levels (along with hardness levels) of the optical film structure 120, these properties can be controlled through adjustments to the stoichiometry and/or thicknesses of the low RI layers 130A, high RI layers 130B, medium RI layers 130C, capping layer 131 and scratch-resistant layer 150. In embodiments, the residual compressive stress and elastic modulus levels (and hardness levels) exhibited by the optical film structure 120 can be controlled through adjustments to the processing conditions for sputtering the layers of the optical film structure 120, particularly its high RI layers 130B and scratch-resistant layer 150. In some implementations, for example, a reactive sputtering process can be employed to deposit high RI layers 130B comprising a silicon-containing nitride or a silicon-containing oxynitride. Further, these high RI layers 130B can be deposited by applying power to a silicon sputter target in a reactive gaseous environment containing argon gas (e.g., at flow rates from 50 to 150 sccm), nitrogen gas (e.g., at flow rates from 200 to 250 sccm) and oxygen gas, with residual compressive stress and elastic modulus levels largely dictated by the selected oxygen gas flow rate. For example, a relatively low oxygen gas flow rate (e.g., 45 sccm) can be employed according to the foregoing argon and nitrogen gas flow conditions to produce high RI layers 130B with a SiOₓN_{y} stoichiometry such that its optical film structure 120 exhibits a residual compressive stress of about 942 MPa, hardness of 17.8 GPa and an elastic modulus of 162.6 GPa. As another example, a relatively high oxygen gas flow rate (e.g., 65 sccm) can be employed according to the foregoing argon and nitrogen gas flow conditions to produce high RI layers 130B with a SiOₓN_{y} stoichiometry such that the optical film structure 120 exhibits a residual compressive stress of about 913 MPa, hardness of 16.4 GPa and an elastic modulus of 148.4 GPa. Accordingly, the stoichiometry of the optical film structure 120, particularly its high RI layers 130B and scratch resistant layer 150, can be controlled to achieve targeted residual compressive stress and elastic modulus levels, which unexpectedly correlate to the advantageously high average failure stress levels in the transparent articles 100 (e.g., greater than or equal to 700 MPa).

According to embodiments, the transparent articles 100 depicted in FIGS. 1A-1D may exhibit an average two-sided or two-surface (i.e., through both primary surfaces 112, 114 of the substrate 110) photopic transmittance, or average visible transmittance, over an optical wavelength regime from 400 to 700 nm, of about 85% or greater, about 88% or greater, about 90% or greater, about 91% or greater, about 92% or greater, about 93% or greater, or even about 94% or greater at normal incidence, from 0 to 10 degrees, from 0 to 20 degrees, from 0 to 30 degrees, from 0 to 40 degrees, from 0 to 50 degrees, or even from 0 to 60 degrees. In some embodiments, the transparent articles 100 can exhibit an average two-sided transmittance in the infrared spectrum (e.g., at 940 nm) of about 85% or greater, about 88% or greater, about 90% or greater, about 91% or greater, about 92% or greater, about 93% or greater, or even about 94% or greater at normal incidence, from 0 to 10 degrees, from 0 to 20 degrees, from 0 to 30 degrees, from 0 to 40 degrees, from 0 to 50 degrees, or even from 0 to 60 degrees. In some embodiments, the transparent articles 100 can exhibit an average two-sided transmittance in the near-infrared spectrum (e.g., an average transmittance from 1000 to 1700 nm) of about 80% or greater, about 85% or greater, about 88% or greater, about 90% or greater, about 91% or greater, about 92% or greater, or even about 93% or greater at normal incidence, from 0 to 10 degrees, from 0 to 20 degrees, from 0 to 30 degrees, from 0 to 40 degrees, from 0 to 50 degrees, or even from 0 to 60 degrees.

According to some implementations, the transparent articles 100 depicted in FIGS. 1A-1D may exhibit a two-surface transmitted color with a D65 illuminant from −4 to +4, −3 to +3, −2.5 to +2.5, or −2 to +2, in both a* and b*, as measured over all incidence angles from 0 to 90 degrees. For example, the transparent articles 100 can exhibit a transmitted color of −4, −3.5, −3.0, −2.5, −2.0, −1.5, −1.0, −0.5, 0, +0.5, +1.0, +1.5, +2.0, +2.5, +3.0, +3.5, +4.0, and all values therebetween, in both a* and b*.

According to some implementations, the transparent articles 100 depicted in FIGS. 1A-1D may exhibit a transmitted color with a D65 illuminant, as given by √(a*²+b*²), of less than 4, less than 3.5, less than 3, less than 2.5, less than 2, less than 1.5, or even less than 1, as measured at normal incidence, from 0 to 10 degrees, or over all incidence angles from 0 to 90 degrees. For example, the transparent articles 100 can exhibit a transmitted color of less than 6, 5.5, 5.0, 4.5, 4, 3.75, 3.5, 3.25, 3, 2.75, 2.5, 2.25, 2, 1.5, 1.0, 0.5, or even lower, as measured at normal incidence, from 0 to 10 degrees, or over all incidence angles from 0 to 90 degrees.

According to embodiments, the transparent articles 100 depicted in FIGS. 1A-1D may exhibit an average single-sided or first-surface (i.e., through one of the primary surfaces 112, 114 of the substrate 110) photopic reflectance, or average reflectance over an optical wavelength regime from 400 to 700 nm through one or both primary surfaces of the substrate 110 (i.e., first-surface or a two-surface reflectance), of less than about 10%, less than about 9%, less than about 8%, less than about 7%, less than about 6%, less than about 5%, less than about 4%, less than about 2%, or even less than 1%, at normal incidence, near-normal incidence (~8°), or from 0 to 10 degrees. For example, the transparent articles 100 can exhibit a first-surface average photopic reflectance of less than 10%, less than 8%, less than 6%, less than 5%, less than 2%, or even less than 1%.

According to embodiments, the transparent articles 100 depicted in FIGS. 1A-1D may exhibit an average single-sided or first-surface (i.e., through one of the primary surfaces 112, 114 of the substrate 110) reflectance, or average reflectance at an infrared wavelength (e.g., at 940 nm) or infrared wavelength range (e.g., 900-950 nm) through one or both primary surfaces of the substrate 110 (i.e., first-surface or a two-surface reflectance), of less than about 8%, less than about 7%, less than about 6%, less than about 5%, less than 4.5%, less than 4.3%, less than about 4%, less than about 3%, or even less than 2%, at normal incidence, near-normal incidence (~8°), or from 0 to 10 degrees. For example, the transparent articles 100 can exhibit a first-surface reflectance at an infrared wavelength (e.g., ~940 nm) of less than 8%, less than 7%, less than 6%, less than 5%, less than 4%, or even less than 2%.

According to embodiments, the transparent articles 100 depicted in FIGS. 1A-1D may exhibit an average single-sided or first-surface (i.e., through one of the primary surfaces 112, 114 of the substrate 110) reflectance, or average reflectance at a near-infrared wavelength (e.g., at 1500 nm) or a near-infrared wavelength range (e.g., 1000-1700 nm, 1500-1600 nm) through one or both primary surfaces of the substrate 110 (i.e., first-surface or a two-surface reflectance), of less than about 15%, less than about 12.5%, less than about 10%, less than about 9%, less than about 8%, less than about 7%, less than about 6%, less than about 5%, less than about 4%, less than about 3%, or even less than 2.5%, at normal incidence, near-normal incidence (~8°), or from 0 to 10 degrees. For example, the transparent articles 100 can exhibit a first-surface reflectance at a near-infrared wavelength (e.g., ~1500 nm, ~1600 nm, etc.) of less than 15%, less than 13%, less than 12%, less than 10%, less than 9%, less than 8%, less than 7%, less than 6%, less than 5%, less than 4%, less than 3%, or even less than 2.5%.

According to some implementations, the transparent articles 100 depicted in FIGS. 1A-1D may exhibit a first-surface reflected color with a D65 illuminant from −5 to +5, −4 to +4, −3 to +3, or −2 to +2, in a*, and −12 to +4, −10 to +3, or −8 to +2, in b*, as measured over all incidence angles from 0 to 90 degrees. For example, the transparent articles 100 can exhibit a first-surface reflected color of −5, −4.5, −4, −3.5, −3.0, −2.5, −2.0, −1.5, −1.0, −0.5, 0, +0.5, +1.0, +1.5, +2.0, +2.5, +3.0, +3.5, +4.0, +4.5, +5.5, and all values therebetween, in a*, and −12, −11, −10, −9, −8, −7, −6, −5, −4, −3, −2, −1, 0, +1, +2, +3, +4, and all values therebetween, in b*

According to some implementations, the transparent articles 100 depicted in FIGS. 1A-1D may exhibit a first-surface (i.e., through one of the primary surfaces 112, 114 of the substrate 110), reflected color with a D65 illuminant, as given by √(a*²+b*²), of less than 15, less than 12.5, less than 10, less than 8, less than 6, less than 4, less than 3, or even less than 2, as measured at normal incidence, from 0 to 10 degrees, or over all incidence angles from 0 to 90 degrees. For example, the transparent articles 100 can exhibit a reflected color of less than 15, 14, 13, 12, 11, 10, 9, 8, 7, 6, 5, 4, 3.75, 3.5, 3.25, 3, 2.75, 2.5, 2.25, 2, 1.9, 1.8, 1.7, 1.75, 1.6, 1.5, 1.4, 1.3, 1.25, 1.2, 1.1, 1, or even lower, as measured at normal incidence, from 0 to 10 degrees, or over all incidence angles from 0 to 90 degrees.

In some implementations, the transparent articles 100 depicted in FIGS. 1A-1D may exhibit maximum-to-minimum oscillations in the average reflectance over a near-infrared optical wavelength regime from 1000 to 1700 nm, of less than 6%, less than 5%, less than 4%, less than 3%, less than 2%, or even less than about 1%, at normal incidence, near-normal incidence (~8°), or from 0 to 10 degrees. For example, the transparent articles 100 can exhibit oscillations in their reflectance spectra of 6%, 5.5%, 5.0%, 4.5%, 4.0%, 3.5%, 3.0%, 2.5%, 2%, 1.5%, 1.0%, 0.75%, or even lower, at normal incidence, near-normal incidence (~8°), or from 0 to 10 degrees. Note that these oscillation reflectance values are in absolute reflectance or transmittance units, on a scale of 0-100% for reflectance. Hence, an embodiment of the transparent article 100 with a 1% average reflectance from 1000 nm to 1700 nm and less than 0.5% reflectance oscillations will have a range of reflectance values between 0.5% and 1.5% over the specified wavelength range. Further, the transparent articles 100 may exhibit a maximum reflectance over the near-infrared optical wavelength regime from 1000 to 1700 nm of less than 12%, less than 10%, or less than 6%, at normal incidence, near-normal incidence (~8°), or from 0 to 10 degrees.

According to some implementations, the transparent articles 100 depicted in FIGS. 1A-1D may exhibit color and reflectance uniformity associated with variations in thickness of the optical film structure 120 that results from line-of-sight layer, film and optical structure deposition methods together with non-planar portions of the substrate 110, e.g., as associated with substrates 110 having flat, angled, or curved regions. In particular, these transparent articles 100 can exhibit a color shift in first-surface reflectance and/or two-surface transmittance, as given by √(a*²+b*²), of less than 4, less than 3, or even less than 2, for optical film structure thickness scaling factors that range from 70 to 100%, 60 to 100%, 50 to 100%, 40 to 100%, or even 35 to 100%.

In some implementations of the articles 100 depicted in FIGS. 1A-1D, the substrate 110 is faceted or curved such that the normal angle of a first portion of the article is different from the normal angle of the second portion of the angle (not shown in FIGS. 1A-1D), and a physical thickness of the optical film structure 120 in the first portion is different than a physical thickness of the optical film structure 120 in the second portion. According to an embodiment, the physical thickness of the optical film structure 120 in the second portion is 85-90% of the physical thickness of the optical film structure 120 in the first portion, and the article 100 exhibits a color shift of less than 5, 4, 3, 2, or 1.5 in both the first and second portions. Further, the first portion and the second portion of the optical film structure 120 exhibits a first-surface average reflectance difference that is less than 2%, less than 1.5%, or even less than 1% in absolute reflectance value. According to another embodiment, the physical thickness of the optical film structure 120 in the second portion is 85-90% of the physical thickness of the optical film structure 120 in the first portion, and the article 100 exhibits a color shift of less than 10, 7.5, 5, 4, 3, or 2, in both the first and second portions. Further, the first portion and the second portion of the optical film structure 120 exhibit a first-surface average reflectance difference that is less than 3%, less than 2%, or even less than 1%, in absolute reflectance value.

In some implementations, certain of the transparent articles 100 of the disclosure (e.g., as depicted in FIGS. 1E-1G, described below) employ thinner optical film structures 120 that exhibit high or higher shallow hardness levels as compared to conventional transparent articles and other transparent articles of this disclosure. Further, recent testing supports accuracy and reliability of hardness measurements at shallower depths (e.g., from 20 nm to 40 nm). Advantageously, these transparent articles have lower manufacturing costs (e.g., less material in the layers, less deposition time for each layer, etc.) and lower as-deposited warp levels.

Referring generally to the transparent articles 100 depicted in FIGS. 1E-1G, the optical film structures 120 of these articles exhibit high hardness at shallow depths. Further, these optical film structures 120 employ one or more medium RI layers 130C (e.g., n=1.5 to 1.9, SiOₓN_{y} material), sometimes in combination with one or more high RI layers 130B (e.g., n=1.9 or greater, SiNₓ), in the outer structure 130a. This strategy tends to enable a minimized use of lower-index materials (e.g., low RI layers 130A) in the optical film structure 120 and the outer structure 130a, which is an important factor in boosting the hardness of the overall optical film structure 120, particularly at shallow indentation depths (as measured from the air-side surface 120a) such as 20 nm, 40 nm, 100 nm, and 125 nm.

Referring to the transparent article 100 depicted in FIG. 1E, the article employs an optical film structure 120 with an outer structure 130a disposed over a scratch resistant layer 150, and an inner structure 130b disposed between the scratch resistant layer 150 and the substrate 110. In this configuration, the inner structure 130b can employ four layers in the following sequence over the substrate 110 and below the scratch resistant layer 150: a low RI layer 130A (shown in contact with the substrate 110), a medium RI layer 130C, a high RI layer 130B, and a medium RI layer 130C. Other configurations for the inner structure 130b are also viable, e.g., from three to nine layers in total. Further, in these particular embodiments of the transparent article 100 depicted in FIG. 1E, the scratch resistant layer 150 is relatively thin, e.g., 100 nm to 300 nm, 125 nm to 250 nm, 150 nm to 250 nm, and all thicknesses between these ranges. In embodiments, the scratch resistant layer 150 employs a high RI layer 130B material (e.g., SiNₓ). In addition, the outer structure 130a can employ two layers over the scratch resistant layer 150 in the following sequence: a medium RI layer 130C and a capping layer 131. However, other configurations for the outer structure 130a are also viable, e.g., from one to five layers. Overall, the transparent articles 100 exemplified by FIG. 1E advantageously minimize the amount of low RI material (i.e., lower numbers of low RI and capping layers 130A, 131 and/or thicknesses of these layer(s) in the optical film structure 120), which tends to improve shallow high hardness of the article 100.

Referring now to the transparent article 100 depicted in FIG. 1F, the article employs an optical film structure 120 with an outer structure 130a disposed over a scratch resistant layer 150, and an inner structure 130b disposed between the scratch resistant layer 150 and the substrate 110. In this configuration, the inner structure 130b can employ two layers in the following sequence over the substrate 110 and below the scratch resistant layer 150: a low RI layer 130A (shown in contact with the substrate 110), and a medium RI layer 130C. Other configurations for the inner structure 130b are also viable, e.g., from one to nine layers in total. Further, the scratch resistant layer 150 is relatively thin, e.g., 150 nm to 300 nm, 175 nm to 275 nm, 200 nm to 275 nm, 225 nm to 275 nm, and all thicknesses between these ranges. In embodiments, the scratch resistant layer 150 employs a high RI layer 130B material (e.g., SiNₓ). In addition, the outer structure 130a can employ two layers over the scratch resistant layer 150 in the following sequence: a medium RI layer 130C and a capping layer 131. However, other configurations for the outer structure 130a are also viable, e.g., from one to five layers. Overall, the transparent articles 100 exemplified by FIG. 1F advantageously minimize the amount of low RI material (i.e., lower numbers of low RI and capping layers 130A, 131 and/or thicknesses of these layer(s) in the optical film structure 120) and employ a relatively thicker scratch resistant layer 150 (e.g., >200 nm), which tends to improve shallow high hardness of the article 100 while the outer structure 130a still enables low reflectance and desirable color attributes.

According to embodiments of the transparent article 100 depicted in FIGS. 1E and 1F, the optical film structure 120 has a total thickness of less than 800 nm, 700 nm, 600 nm, 500 nm, or even 450 nm, while the article exhibits a photopic average first-surface reflectance of less than 6% and a maximum hardness of greater than 12 GPa, 13 GPa, 14 GPa, 15 GPa, or even 16 GPa, as measured by a Berkovich Hardness Test at any indentation depth (e.g., from 20 to 200 nm). For example, the optical film structure 120 can have a total thickness of 775 nm, 750 nm, 725 nm, 700 nm, 650 nm, 600 nm, 550 nm, 500 nm, 450 nm, 425 nm, 400 nm, and all thickness between these thickness levels. Further, the article 100 can exhibit a maximum hardness of 12, 12.5, 13, 13.5, 14, 14.5, 15, 15.5, 16, 16.5, 17, 17.5, or even 18 GPa, and all hardness values between these maximum hardness levels, and a photopic average first-surface reflectance of 1, 1.25, 1.5, 1.75, 2, 2.5, 3, 3.5, 4, 4.5, 5, 5.5, 5.75 and up to 6%, and all reflectance values between these levels. In some implementations, these articles 100 can have a photopic average first-surface reflectance of less than 6%, 4%, 2%, 1.8%, or even less than 1.6%, while exhibiting any of the following hardness levels: a hardness at a 20 nm indentation depth of greater than 9 GPa, a hardness at a 40 nm indentation depth of greater than 10 GPa, a hardness at a 100 nm indentation depth of greater than 12 GPa, or a hardness at a 125 nm indentation depth of greater than 12 GPa, as measured by a Berkovich Hardness Test.

Referring now to the transparent article 100 depicted in FIG. 1G, the article employs an optical film structure 120 with an outer structure 130a disposed over a scratch resistant layer 150, and an inner structure 130b disposed between the scratch resistant layer 150 and the substrate 110. In this configuration, the inner structure 130b can employ seven layers in the following sequence over the substrate 110 and below the scratch resistant layer 150: a low RI layer 130A (shown in contact with the substrate 110), a medium RI layer 130C, a low RI layer 130A, a medium RI layer 130C, a low RI layer 130A, a medium RI layer 130C, and a low RI layer 130A. In some embodiments of the transparent article 100 depicted in FIG. 1G, the inner structure 130b employs two (2) to twelve (12) periods 132 of alternating low RI and medium RI layers 130A/130C and an additional low RI layer 130A. In some embodiments of the transparent article 100 depicted in FIG. 1G, the inner structure 130b can include any number of layers from five (5) to twenty-five (25) layers.

Further, in some embodiments of the transparent article 100 depicted in FIG. 1G, the inner structure 130b can comprise a refractive index gradient (not shown in FIG. 1G) rather than, for example, a plurality of low and high RI layers 130A, 130B. Thus, in these embodiments, the transparent article 100 may comprise in order: 1) substrate 110; 2) a refractive index gradient structure as the inner structure 130b; 3) a scratch resistant layer 150; and 4) an outer structure 130a enabling high shallow hardness. The refractive index gradient may be formed by a compositional gradient. In such embodiments, the composition at or adjacent to the substrate primary surface 112 may be tuned to have a refractive index within about 0.05 refractive index units of the refractive index of the substrate 110 itself (e.g., from about 1.45 to 1.55), while the composition at or adjacent to the scratch resistant layer 150 may be tuned to have a refractive index within about 0.1 refractive index units of the refractive index of the scratch resistant layer 150 (e.g., from about 1.65 to 1.95). The thickness of the refractive index gradient region (i.e., as the inner structure 130b) may preferably be in the range from about 100 nm to 500 nm.

In some embodiments of the transparent article 100 depicted in FIG. 1G with an inner structure 130b comprising a refractive index gradient, the gradient is derived from a compositional gradient formed from materials such as Si, Al, N, O, C, and/or combinations thereof. In one or more specific embodiments, the composition gradient is formed from Si, N and/or O. In one example, the refractive index gradient may include an oxygen-content gradient in which the oxygen content decreases or remains constant along the thickness of the refractive index gradient in the direction from the substrate surface to the scratch resistant layer. In yet another example, the refractive index gradient may include a nitrogen-content gradient in which the nitrogen content increases or remains constant along the thickness of the refractive index gradient in the direction from the substrate surface to the scratch resistant layer. In one or more alternative embodiments, the optical film structure 120 may include a density gradient and/or an elastic modulus gradient, in addition to or instead of the refractive index gradient otherwise described herein. In embodiments, an elastic modulus gradient can be utilized to further improve certain mechanical performance aspects of the transparent article 100, such as maintaining or improving retained strength, reducing warp, or reducing delamination.

Referring again to the transparent article 100 depicted in FIG. 1G, the scratch resistant layer 150 can be relatively thick, e.g., 200 nm to 5000 nm, 400 nm to 5000 nm, 800 nm to 5000 nm, 1500 nm to 5000 nm, 1500 nm to 3000 nm, 1500 nm to 2500 nm, and all thicknesses between these ranges. In embodiments, the scratch resistant layer 150 employs a medium RI layer 130C material (e.g., SiOₓN_{y}). In addition, the outer structure 130a, as depicted in FIG. 1G, can employ six layers over the scratch resistant layer 150 in the following sequence: a medium RI layer 130C, a high RI layer 130B, a medium RI layer 130C, a high RI layer 130B, a medium RI layer 130C, and a capping layer 131. Further, the outer structure 130a can employ a series of periods 132 (e.g., N=2 to 5) comprising alternating medium RI and high RI layers 130C, 130B or alternating high RI and medium RI layers 130B, 130C, and an additional medium RI layer 130C or high RI layer 130B, and a outermost capping layer 131. In addition, other configurations for the outer structure 130a are viable, e.g., from four to fourteen layers. Overall, the transparent articles 100 exemplified by FIG. 1G advantageously minimize the amount of low RI material (i.e., lower numbers of low RI and capping layers 130A, 131 and/or thicknesses of these layer(s) in the optical film structure 120), employ a relatively thick high RI layer 130B in the outer structure 130a, and a relatively thick scratch resistant layer 150, all of which tend to improve shallow high hardness of the article 100.

According to embodiments of the transparent articles 100 depicted in FIGS. 1E-1G, the optical film structure 120 can have an overall thickness of from 200 nm to 5000 nm with a hardness of greater than 11 GPa at a 20 nm indentation depth, a hardness of greater than 11 or 12 GPa at a 40 nm indentation depth, a hardness of greater than 15 GPa at a 100 nm indentation depth, or a hardness of greater than 16 GPa at an indentation depth of 125 nm, as measured by a Berkovich Hardness Test. In some of these embodiments, the article 100 exhibits a photopic average first-surface reflectance of less than 6%, 5%, 4.5%, 4%, 3%, 2%, 1.75%, or even 1.6%.

Referring generally to the transparent articles 100 detailed above and depicted in exemplary form in FIGS. 1A-1G, embodiments of these articles employ optical film structures 120 that can possess a significant amount of compressive stress, as deposited in the substrate 110, which can aid in the overall retained strength of the article. On the other hand, the residual compressive stress in the optical film structure 120 can also lead to undesirable warpage to the article 100, necessitating costly additional processing of the substrate 110 (e.g., asymmetric polishing and material removal) prior to the deposition of the layers that make up the optical film structure 120. That is, some embodiments of the optical film structure 120 are such that some asymmetric removal of material of the substrate 110 is required before deposition of the optical film structure 120 to effectively counteract the residual compressive stress of the optical film structure to ensure that the resulting article 100 does not exhibit substantial warpage.

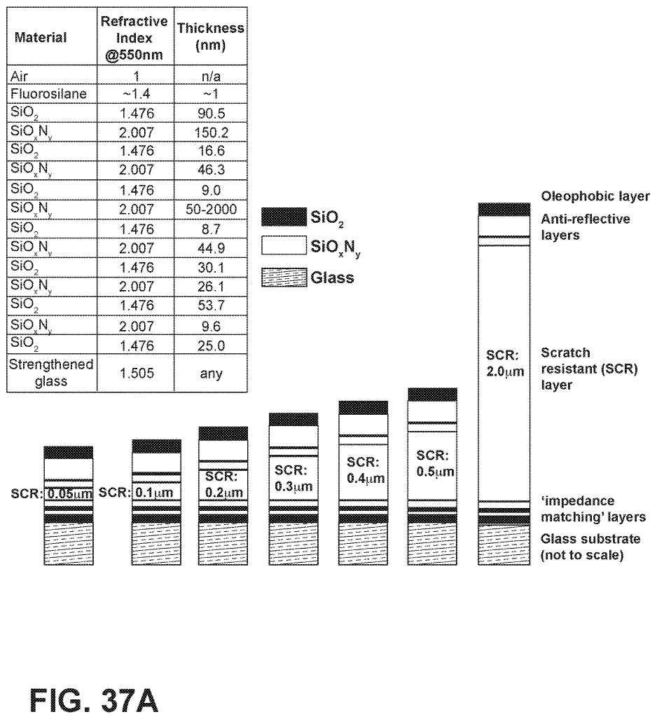

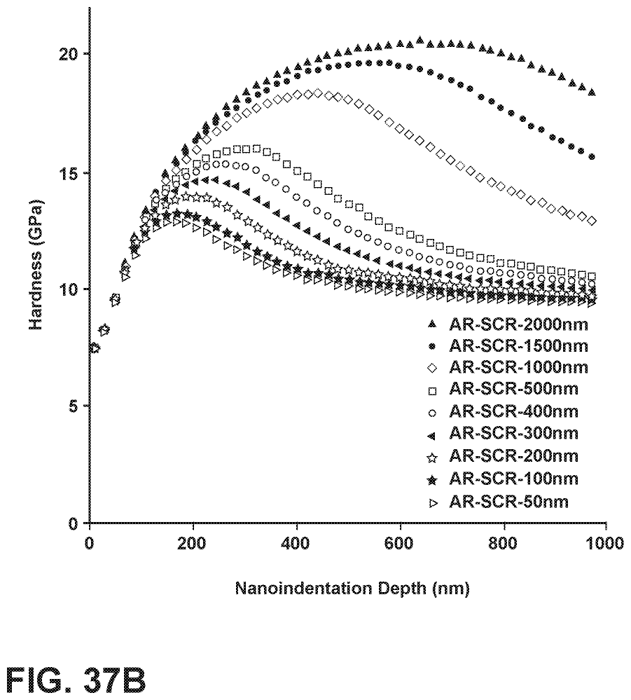

Without being bound by theory, it is generally understood that reducing the thickness of the optical film structure 120 can reduce the degree of warpage caused by the optical film structure 120, as deposited on the substrate 110. Referring to FIG. 37A, a schematic is provided of a comparative article having an optical film structure with a scratch resistant layer having varying thickness levels. Further, FIG. 37B is a schematic plot of hardness (GPa) vs. indentation depth, as modeled to be indicative of the results from a Berkovich Hardness Test of the optical film structure of the comparative articles of FIG. 37A. While some conventional optical film structure designs, such as shown in FIG. 37A, employ a relatively thick scratch resistant layer (e.g., 50-2000 nm, SiOₓN_{y} or SiNₓ), reducing the thickness of these scratch resistant layers with the goal of reduced warpage can significantly and undesirably reduce the hardness of the article. Indeed, as shown in FIGS. 37A and 37B, optical structure designs that employ a substantial volume of low RI material (e.g., SiO₂) in the outer structure 130a above the scratch resistant layer tend to exhibit a substantial degree of hardness sensitivity as a function of scratch resistant layer thickness. That is, warpage problems cannot readily be solved by reducing the thickness of the scratch resistant layers of optical film structure designs in conventional articles.

Nevertheless, embodiments of the transparent articles 100 of the disclosure (see, e.g., FIGS. 1A-1G) employ optical film structures 120 with outer structures 130a having multiple high RI layers 130B (e.g., SiNₓ) and medium RI layers 130C (e.g., SiOₓN_{y}) in which the outer structure 130a itself provides a significant hardness response. That is, without being bound by theory, these embodiments are configured with less low RI material in the outer structure 130a and the net result is that the outer structure 130a itself has more influence on the hardness response of the transparent article 100. Accordingly, the scratch resistant layer 150 in these transparent articles 100 plays a less substantial role and, therefore, its thickness is advantageously less influential on the hardness response of the article. Hence, embodiments of these articles 100 can advantageously employ thinner scratch resistant layers to reduce warpage, while not sacrificing hardness levels and retained strength, as described in further detail in the subsequent passages.

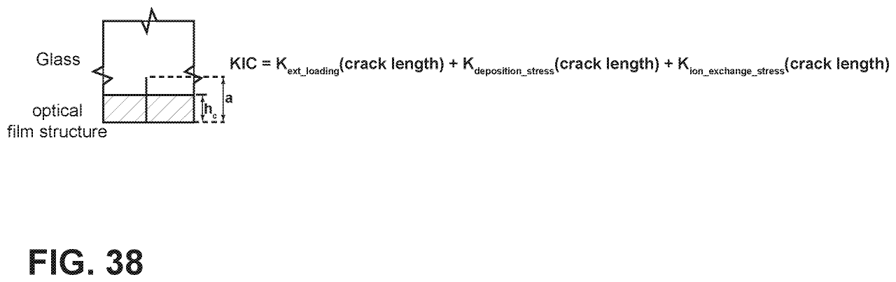

Referring to FIG. 38, a schematic is provided of the basic fracture mechanics principles of embodiments of the transparent articles 100 of the disclosure. As shown in the figure, from basic fracture mechanics principles, the stress intensity factor, K_{I}, for a flaw at the surface of the ‘composite’ of the optical film structure 120 and the substrate 110, can be written as shown in FIG. 38. As is evident from the figure, when K_{I} becomes equal to the fracture toughness of the glass substrate 110, K_{IC}, the glass fails. It can be seen that the stress intensity factor is directly proportional to the total crack length ‘a’ i.e., larger the crack, higher is the stress intensity factor and lower is the strength of the composite system. Accordingly, a thicker optical film structure (h_{c}) (see FIG. 38) has a greater probability of having a lower strength.

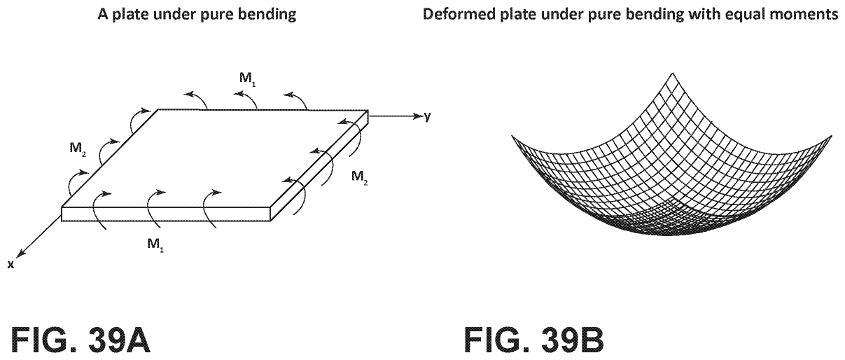

Besides the sensitivity of optical film structure thickness on retained strength conveyed by FIG. 38, warpage of the article is also influenced by the thickness of the optical film structure. Referring now to FIGS. 39A and 39B, schematics are provided of a transparent article 100 of the disclosure, as subjected to pure bending with equal moments, to assess warp as a function of the thickness of the optical film structure 120. In particular, the warp on the substrate 110 from the optical film structure 120 can be approximated by:

$$w = \frac{M}{2 D ( 1 + v )} ( {x}^{2} + {y}^{2} )$$

where D is the stiffness or flexural rigidity of the substrate 110, as given by:

$$D = \frac{E {t}^{3}}{12 ( 1 - {v}^{2} )} .$$

Further, the moment M here is due to the stress in the optical film structure 120 which be approximated as:

$$M = σ {h}_{c} \frac{t}{2}$$

where σ is the average coating stress, h_{c} is the thickness of the optical film structure 120 and t is the thickness of the substrate 110. As is evident from these relationships and the depictions in FIGS. 39A and 39B, the warp in the transparent articles 100 is directly proportional to the thickness of the optical film structure 120 for a constant value of average optical film structure stress. Therefore, to decrease warp, either the average stress in the optical film structure 120 needs to be decreased, or the thickness of the optical film structure 120 needs to be decreased, or both simultaneously.

Accordingly, embodiments of the transparent articles 100 of the disclosure (e.g., as shown in FIGS. 1A-1G) advantageously can be configured to reduce warpage, while retaining strength and hardness, through reductions in the thickness of the scratch resistant layer 150 (e.g., to thicknesses from about 100 nm to less than 2000 nm, from about 500 nm to less than 2000 nm, etc.) employed in the optical film structure 120. That is, any of the transparent articles 100 of the disclosure can benefit from these concepts with a reduction in the stated thickness of its scratch resistant layer 150.

One benefit of these embodiments is that the reductions to the thickness of the scratch resistant layer 150 means that a lesser amount of material is used in the optical film structure 120, leading to shorter sputter times and associated costs savings and throughput increases. Another benefit is that decreasing the thickness of the scratch resistant layer 150 can maintain or even slightly improve the retained strength of the article 100. Another benefit is that decreasing the thickness of the scratch resistant layer 150 can provide a drastic improvement on the degree of warp observed in the substrate 110 after deposition of the optical film structure 120; consequently, the lower degrees of warp necessitate much less processing (e.g., asymmetric polishing) prior to deposition of the optical film structure 120. Another potential benefit, without being bound by theory, is that reducing the thickness of the scratch resistant layer 150 can reduce the optical film structure force (F=σh_{c}), which should reduce the likelihood of delamination between the optical film structure 120 at the edges 116, 118 of the transparent article 100.

Embodiments of the transparent articles 100 of the disclosure, e.g., as exemplified by FIGS. 1A-1G, may further comprise features (not shown in FIGS. 1A-1G) at one or more of the primary surfaces 112, 114 of the substrate 110 that can enable a combination of antireflective (AR) and antiglare (AG) optical properties, along with mechanical strength and wear resistance. Antireflective structure and function is generally defined here as a reflectance reduction based on thin film interference, while antiglare structure and function is generally defined here as a textured surface that imparts some degree of light scattering, and usually serves to reduce the specular reflectance of an article surface or interface. These transparent articles 100 advantageously possess lower first surface specular reflectance levels (e.g., below 0.3%) as compared to articles solely with AR or AG properties and characteristics, which also facilitates higher display contrast ratios, color gamut and neutral reflected color levels. More particularly, these transparent articles 100 can have one or more textured, AG substrate surfaces (e.g., diffractive, roughened, and other textured morphologies) (e.g., at one or more of the primary surfaces 112, 114) with an optical film structure 120 having high hardness at shallow depths, which can include a scratch resistant layer 150. Further, as the AG textured surface region of these articles 100 can scatter light in both transmission and reflection, it can also reduce the appearance of buried reflections in the display. Moreover, these transparent articles 100 and their substrates 110 employ a textured surface region with optimized antiglare properties, such as low pixel power deviation (PPD₁₄₀) and low transmitted haze.

As used herein, the terms “pixel power deviation” and “PPD” refer to the quantitative measurement for display sparkle. Further, as used herein, the term “sparkle” is used interchangeably with “pixel power deviation” and “PPD.” PPD is calculated by image analysis of display pixels according to the following procedure. A grid box is drawn around each LCD pixel. The total power within each grid box is then calculated from CCD camera data and assigned as the total power for each pixel. The total power for each LCD pixel thus becomes an array of numbers, for which the mean and standard deviation may be calculated. The PPD value is defined as the standard deviation of total power per pixel divided by the mean power per pixel (times 100). The total power collected from each LCD pixel by the eye simulator camera is measured and the standard deviation of total pixel power (PPD) is calculated across the measurement area, which typically comprises about 30×30 LCD pixels.

The details of a measurement system and image processing calculation that are used to obtain PPD values are described in U.S. Pat. No. 9,411,180 entitled “Apparatus and Method for Determining Sparkle,” the salient portions of which that are related to PPD measurements are incorporated by reference herein in their entirety. Further, unless otherwise noted, the SMS-1000 system (Display-Messtechnik & Systeme GmbH & Co. KG) is employed to generate and evaluate the PPD measurements of this disclosure. The PPD measurement system includes: a pixelated source comprising a plurality of pixels (e.g., a Lenovo Z50 140 ppi laptop), wherein each of the plurality of pixels has referenced indices i and j; and an imaging system optically disposed along an optical path originating from the pixelated source. The imaging system comprises: an imaging device disposed along the optical path and having a pixelated sensitive area comprising a second plurality of pixels, wherein each of the second plurality of pixels are referenced with indices m and n; and a diaphragm disposed on the optical path between the pixelated source and the imaging device, wherein the diaphragm has an adjustable collection angle for an image originating in the pixelated source. The image processing calculation includes: acquiring a pixelated image of the transparent sample, the pixelated image comprising a plurality of pixels; determining boundaries between adjacent pixels in the pixelated image; integrating within the boundaries to obtain an integrated energy for each source pixel in the pixelated image; and calculating a standard deviation of the integrated energy for each source pixel, wherein the standard deviation is the power per pixel dispersion. As used herein, all “PPD” and “sparkle” values, attributes and limits are calculated and evaluated with a test setup employing a display device (e.g., transparent article 100) having a pixel density of 140 pixels per inch (PPI) (also referred herein as “PPD₁₄₀”). Further, unless otherwise noted herein, sparkle is reported in units of “%” to denote the percentage of sparkle observed on a display device having a pixel density of 140 pixels per inch.

As used herein, the terms “transmission haze” and “haze” refer to the percentage of transmitted light scattered outside an angular cone of about +2.5° in accordance with ASTM D1003, entitled “Standard Test Method for Haze and Luminous Transmittance of Transparent Plastics,” the contents of which are incorporated by reference herein in their entirety.

As also used herein, an “average texture height (Rₜₑₓₜ)” is a characteristic of the structural features of the textured surface region of a primary surface (e.g., one or more primary surfaces 112, 114) of a substrate (e.g., substrate 110) of the transparent articles 100 of the disclosure and reported in units of nanometers (nm). Further, for a textured surface region that comprises a roughened surface region (e.g., as produced through an etching and/or sandblasting process), Rₜₑₓₜ is defined as the average surface roughness (R_{q}) of the roughened surface region and can be reported in units of root-mean-squared (RMS) nanometers (nm). For a textured surface region that comprises a diffractive surface region, as described in this disclosure, Rₜₑₓₜ is defined as the average difference in height between the two heights (or the average difference between the maximum and minimum characteristic heights) or depths of the structural features (e.g., pillars, holes, etc.) associated with the diffractive surface region.

Further, as noted earlier in this disclosure, these transparent articles 100 with one or more textured, AG substrate surfaces also include an optical film structure 120 with a plurality of alternating high refractive index (e.g., high RI layers 130B), medium refractive index (e.g., medium RI layers 130C), and/or low refractive index layers (e.g., low RI layers 130A) which, in some embodiments, can enable the article to exhibit a hardness at 20 nm depth of greater than 11 GPa, a hardness at 40 nm depth of greater than 11 GPa, a hardness at 100 nm depth of greater than 15 GPa, or a hardness at 125 nm depth of greater than 16 GPa, as measured by a Berkovich Indenter Hardness Test or modeled according to the hardness models described here.

Further, the AG textured surface regions on or at one or more of the primary surfaces 112, 114 of the substrate 110 can enable the transparent articles 100 employing them to exhibit a PPD₁₄₀ of less than 5%, and a transmitted haze of less than 50%. Moreover, it is desirable in embodiments to combine these light-scattering AG textured surface regions with a relatively thin multilayer optical film structure 120 having a total thickness of from 200 nm to 800 nm, and hardness at 20 nm depth of greater than 9 GPa, a hardness at 40 nm depth of greater than 10 GPa, a hardness at 100 nm depth of greater than 12 GPa, or a hardness at 125 nm depth of greater than 12 GPa.

In some aspects, the textured surface region is a surface with randomly or semi-randomly formed structural features that are formed through various chemical etching, combined chemical precipitation and etching, and/or sandblasting processes (in these embodiments, the surface texture would not be considered a diffractive surface with a multi-modal distribution of surface heights) directed at one or more primary surfaces 112, 114 of the substrate 110, as understood by those of ordinary skill in the art. According to some embodiments, the majority of the structural features of the roughened surface region have lateral etched feature dimensions (i.e., X-Y dimensions) that range from 1 μm to 125 μm, 1 μm to 100 μm, 1 μm to 75 μm, 1 μm to 50 μm, 1 μm to 40 μm, 1 μm to 30 μm, 5 μm to 125 μm, 5 μm to 100 μm, 5 μm to 75 μm, 5 μm to 60 μm, 5 μm to 50 μm, 5 μm to 40 μm, 5 μm to 30 μm, 10 μm to 60 μm, 10 μm to 100 μm, and lateral dimensions within the foregoing ranges.

In embodiments of the transparent articles 100, the textured surface region possesses an average surface roughness (R_{q}) from 20 nm to 2000 nm RMS variation. According to further implementations, the textured surface region possesses an average surface roughness (R_{q}) in RMS variation from 10 nm to 2500 nm, 10 nm to 2000 nm, 10 nm to 1500 nm, 20 nm to 2500 nm, 20 nm to 2000 nm, 20 nm to 1500 nm, 40 to 2000 nm, 40 to 500 nm, 40 to 250 nm, 50 nm to 2500 nm, 50 nm to 2000 nm, 50 nm to 1500 nm, 50 nm to 1000 nm, 50 nm to 500 nm, 50 nm to 250 nm, 100 nm to 2500 nm, 100 nm to 2000 nm, 100 nm to 1500 nm, 100 nm to 1000 nm, 100 nm to 500 nm, 100 nm to 250 nm, and all surface roughness values between the foregoing ranges.

In some implementations of the transparent articles 100, the textured surface region can be described such that its structural features have a first average height and a second average height (e.g., a diffractive surface with a multimodal distribution of surface heights). The first average height corresponds to the average height of the peaks of the textured surface region and the second average height corresponds to the depth of the troughs between the peaks. In such configurations, the difference between the first and second average heights or the difference between the highest average height and the lowest average height of the textured surface region can range from 10 nm to 500 nm, 10 nm to 250 nm, 25 nm to 500 nm, 25 nm to 250 nm, 50 nm to 500 nm, 100 to 600 nm, 100 to 800 nm, 50 nm to 250 nm, 50 nm to 150 nm, 100 nm to 200 nm, 120 nm to 200 nm, and all height differences between the foregoing ranges.

In embodiments of the transparent articles 100, the textured surface region possesses an average texture height (Rₜₑₓₜ) from 20 nm to 2000 nm. According to further implementations, the textured surface region possesses an average texture height (Rₜₑₓₜ) from 10 nm to 2500 nm, 10 nm to 2000 nm, 10 nm to 1500 nm, 20 nm to 2500 nm, 20 nm to 2000 nm, 20 nm to 1500 nm, 50 nm to 2500 nm, 50 nm to 2000 nm, 50 nm to 1500 nm, 50 nm to 1000 nm, 50 nm to 500 nm, 50 nm to 250 nm, 100 nm to 2500 nm, 100 nm to 2000 nm, 100 nm to 1500 nm, 100 nm to 1000 nm, 100 nm to 500 nm, 100 nm to 250 nm, and all texture height values between the foregoing ranges. Further, for a textured surface region that comprises a roughened surface region (e.g., as produced through an etching and/or sandblasting process), Rₜₑₓₜ can be defined as the average surface roughness (R_{q}) of the structural features of the roughened surface region and is reported in units of root-mean-squared (RMS) nanometers. For a textured surface region that comprises a diffractive surface region (see below), as described in this disclosure, Rₜₑₓₜ is defined as the average difference in height between the two heights or depths (in the case of a bimodal surface height distribution) or the average difference in height between the highest height and the lowest depth (in the case of a multimodal surface height distribution with more than 2 height modes) of the structural features (e.g., pillars, holes, etc.) associated with the diffractive surface region.

Referring again to the transparent articles 100 of the disclosure (e.g., as exemplified by FIGS. 1A-1G), embodiments of these articles can further comprise diffractive, AG surfaces and methods of making the same, particularly articles comprising a substrate 110 with one or more primary surfaces 112, 114 having a diffractive surface region and AG characteristics. In general, these transparent articles 100 and substrates 110 employ an engineered diffractive surface region with AG properties, such as low distinctness of image (DOI), low pixel power deviation (PPD₁₄₀) and low transmitted haze. The diffractive surface regions, according to aspects of the disclosure, possess structural features, such as holes, pillars, ellipses, and/or interconnected spinodal features with controlled surface frequency content. Further, these diffractive surface regions can enable the transparent articles 100 employing them to exhibit a first-surface reflectance DOI of less than 95%, a PPD 140 of less than 5%, and a transmitted haze of less than 50%. Further, the diffractive surface region, in some embodiments, can have a multimodal distribution (e.g., a bimodal distribution) of surface heights with a maximum height and/or depth of from 120 to 200 nm or from 100 to 600 nm, which can reduce specular reflectance through diffractive interference.

As used herein, “DOI” is equal to 100* (Rₛ−R_{0.3°})/Rₛ, where Rₛ is the specular reflectance flux measured from incident light (at 20° from normal) directed onto the diffractive surface region of the transparent article 100 of the disclosure and R_{0.3°} is the reflectance flux measured from the same incident light at 0.3° from the specular reflectance flux, Rₛ. Unless otherwise noted, the DOI values and measurements reported in this disclosure are obtained according to the ASTM D5767-18, entitled “Standard Test Method for Instrumental Measurement of Distinctness-of-Image (DOI) Gloss of Coated Surfaces using a Rhopoint IQ Gloss Haze & DOI Meter” (Rhopoint Instruments Ltd.).

As used herein, the “multimodal distribution” can have a plurality of surface height modes, e.g., the distribution may be bimodal, tri-modal, four-modal, five-modal, etc. In embodiments, the diffractive AG surface region is configured such that each of these modes is characterized by a distinct peak of surface height vs. area fraction within the distribution of surface heights. These peaks may be distinguished by a decrease in area fraction of at least 20%, at least 50% or at least 80% from the peak surface height value between the distinct peaks associated with each of the modes. Further, the peaks of each of the modes may have a varying width, and the area fraction does not need to drop to zero between the peaks of the distribution. In some embodiments, however, the area fraction for heights in between each of the peaks on a surface height vs. area chart may drop to zero or close to zero.

According to some embodiments of the transparent article 100, the diffractive surface region is configured such that each of the structural features has an aspect ratio of more than 10. Unless otherwise noted, the aspect ratio of each of the structural features is given by the average diameter divided by the respective average height. In some implementations, the aspect ratio of the structural features of the diffractive surface region is more than 10, more than 20, more than 50, or more than 100. For example, a first portion of structural features with an average diameter of 20 μm and an average height of 0.2 μm corresponds to an aspect ratio of 100. More generally, the diffractive surface region, as characterized by these aspect ratios, is substantially flat or planar, at least as viewed under ambient lighting without any magnification aids.

According to some implementations of the transparent article 100, the structural features of the diffractive surface region can be configured according to an average lateral spatial period (relating to an average lateral pitch or an average lateral feature size) to effect antiglare properties. In some implementations of the transparent article 100, the structural features of the diffractive surface region are configured with a period that ranges from 1 μm to 200 μm, from 5 μm to 200 μm, from 5 μm to 150 μm, from 5 μm to 100 μm, from 5 μm to 50 μm, from 5 μm to 30 μm, from 20 μm to 150 μm, from 20 μm to 100 μm, from 10 μm to 30 μm, from 10 μm to 20 μm, and all period values between the foregoing ranges.

These implementations of the transparent articles 100 of the disclosure, as including a diffractive AG surface region, offer several advantages over articles with conventional approaches to achieving antireflective characteristics. For example, these transparent articles 100 can suppress specular reflectance by a factor of 10× or more using diffractive light scattering, while also achieving a combination of low haze, low sparkle and high mechanical durability. The high mechanical durability is associated with the relatively low aspect ratio of the structural features of the diffractive surface region. In addition, some transparent articles 100 according to the disclosure employ a diffractive surface region and a multilayer optical film structure 120 to achieve specular reductions of greater than 20×, 50× or even 100×. According to some implementations, the spacing and/or dimensions of the average lateral spatial period or feature shapes are semi-randomized to minimize color and/or Moiré artifacts. The level and type of feature randomization in the X-Y dimension can be very important to achieving low PPD while also minimizing other display artifacts such as Moiré or color banding. Put another way, traditional, perfectly ordered grating-like structures are not preferred in embodiments of these transparent articles 100 of the disclosure.

More generally, a two-dimensional array of structural features of the diffractive surface region can be fabricated by many processes, such as optical lithography (photomask), ink jet printing, laser patterning and/or screen printing once the intended structure for the surface region has been defined. The selection of the process depends on the resolution of the structural features (e.g., in terms of diameter, period, and/or pitch) and the technical capabilities of the given process. In some embodiments of the transparent article 100, once the structural parameters of the diffractive surface region has been defined (e.g., pillars or holes, average heights, pitch, diameter, period, etc.), the design can be converted to a computer-aided design (CAD) file and then used with any of the foregoing processes to transfer it to a substrate to create the ‘engineered’ diffractive surface region.

Another advantage of these transparent articles 100 is that their planar step-like and semi-planar morphology, together with the controlled structure depths of less than 1 micron, or less than 250 nm, of the diffractive surface region allows them to be easily fabricated with much lower consumption of glass material and etching chemicals (such as HF) compared to conventional etched, antiglare glass substrates, leading to less environmental waste and potential cost benefits. Various processes can be employed to create these structures (e.g., organic mask and etching, organic mask and vapor deposition, organic mask and liquid phase deposited oxide), which can aid in maintaining low manufacturing costs. A further advantage of these transparent articles 100 is that they can exhibit a combination of antiglare, optical properties not achievable from conventional antiglare approaches. For example, these transparent articles 100 of the disclosure, as incorporating a diffractive surface region, have achieved a DOI of less than 80%, a PPD140 of less than 2% and a haze of less than 5%.

In embodiments of the transparent article 100, a photomask/optical lithography process can be used to develop the diffractive surface region structures which form a light scattering surface texture having texture depth Rₜₑₓₜ. In this case, a light-sensitive polymer (i.e., a photoresist) is exposed and developed to form three-dimensional relief images on the substrate (e.g., a substrate 110). In general, the ideal photoresist image has the exact shape of the designed or intended pattern in the plane of the substrate, with vertical walls through the thickness of the resist (<3 μm for spin-coatable resists, <20 μm for dry film resists, and <15 μm for screen-coatable photoresists). When exposed, the final resist pattern is binary with parts of the substrate covered with resist while other parts are completely uncovered. The general sequence of processing steps for a typical photolithography process is as follows: substrate preparation (clean and dehydration followed by an adhesion promoter for spin-coatable resist, e.g., hexamethyl disilazane (HMDS), photoresist spin coat, prebake, exposure, and development, followed by a wet etching process to transfer the binary image onto the substrate (e.g., a glass or glass-ceramic substrate). The final step is to strip the resist after the resist pattern has been transferred into the underlying layer. In some cases, post bake and post exposure bake steps are required to ensure resist adhesion during wet etching process.

After fabrication of the antiglare surfaces by any of the above-mentioned methods, the textured antiglare surface can be advantageously over-coated with the high shallow hardness optical film structure 120 designs of the present disclosure, yielding transparent articles 100 that combine preferred combinations of low specular reflectance, low reflected image visibility, and high abrasion resistance in a variety of use cases.

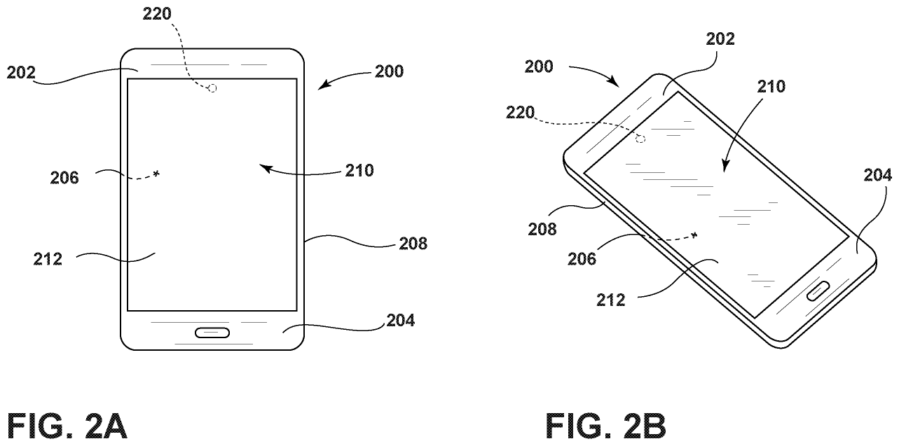

The transparent articles 100 disclosed herein (e.g., as shown in FIGS. 1A-1G) may be incorporated into a device article, for example, a device article with a display (or display device articles) (e.g., consumer electronics, including mobile phones, tablets, computers, navigation systems, wearable devices (e.g., watches) and the like), augmented-reality displays, heads-up displays, glasses-based displays, architectural device articles, transportation device articles (e.g., automotive, trains, aircraft, sea craft, etc.), appliance device articles, or any device that benefits from transparency, scratch resistance, abrasion resistance, damage resistance, or a combination thereof. An exemplary device article incorporating any of the articles disclosed herein (e.g., as consistent with the transparent articles 100 depicted in FIGS. 1A-1G) is shown in FIGS. 2A and 2B. Specifically, FIGS. 2A and 2B show a consumer electronic device 200 including a housing 202 having a front 204, a back 206, and side surfaces 208; electrical components (not shown) that are at least partially inside or entirely within the housing and including at least a controller, a memory, and a display 210 at or adjacent to the front surface of the housing; and cover substrate 212 at or over the front surface of the housing such that it is over the display. In some embodiments, the cover substrate 212 may include any of the transparent articles 100 disclosed herein.

### EXAMPLES

The following examples describe various features and advantages provided by the disclosure, and are in no way intended to limit the invention and appended claims.

In these examples (Exs. 1-28E) and comparative examples (i.e., Comp. Exs. 1-5), transparent articles were formed according to the methods of the disclosure and as delineated in each of the Tables 1-35. More specifically, the optical film structures of these examples, unless otherwise noted, were formed using a metal-mode, reactive sputtering process in a rotary drum coater, with independent control of sputtering power in the metal deposition and the inductively coupled plasma (ICP) (gas reaction) zones. Reactive gases (e.g., N₂ gas and O₂ gas) are isolated from the metal target in the ICP (gas reaction) zone. Further, the metal sputtering zone employs only inert gas flow (i.e., Ar gas).

Optical transmission and reflectance properties were measured on experimental samples prepared according to these examples using an Agilent Cary 5000 UV-Vis-NIR spectrophotometer. Hardness values for the transparent articles reported in the following examples were obtained using the Berkovich Hardness Test method outlined earlier in the disclosure.

More specifically, the inventive examples (Exs. 1-3 and 10), as combined with the strengthened glass-ceramic substrate, exhibit very high shallow hardness and low reflectance in the visible, IR and near-IR spectra, among other mechanical and optical properties, and as exemplary of the transparent articles 100 of the disclosure (see FIGS. 1A-1D and corresponding description). Further, the inventive examples (Exs. 4-9 and 11-14), as comprising glass or glass-ceramic substrates, exhibit, or are otherwise expected to exhibit, high shallow hardness and low reflectance in the visible, IR and near-IR spectra, among other mechanical and optical properties.

Similarly, the inventive examples (Exs. 17-28), as combined with a strengthened glass or glass-ceramic substrate, exhibit very high shallow high hardness, low reflectance, minimized optical film structure thickness and various retained properties, e.g., retained strength, hardness and minimal warp.

### Comparative Example 1

A comparative transparent article including a strengthened glass-ceramic substrate was prepared for this example with the structure delineated below in Table 1. The glass-ceramic substrate is an ion-exchanged, LAS glass-ceramic substrate having a thickness of 600 μm and a refractive index of 1.533. Further, the glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

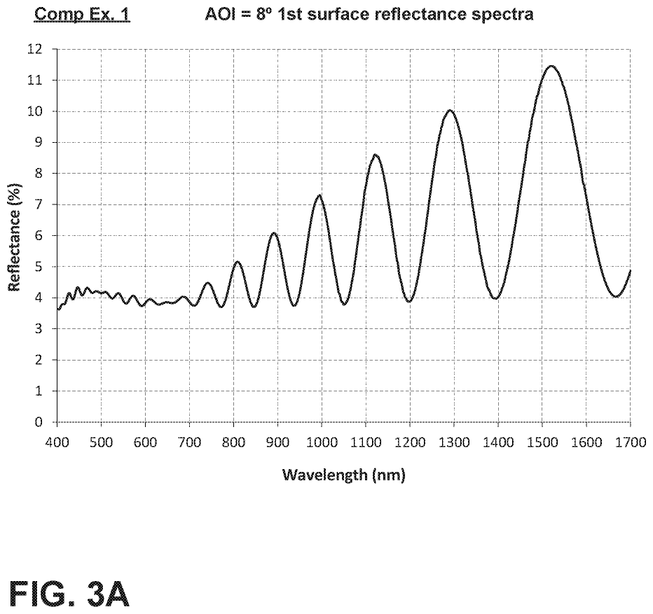

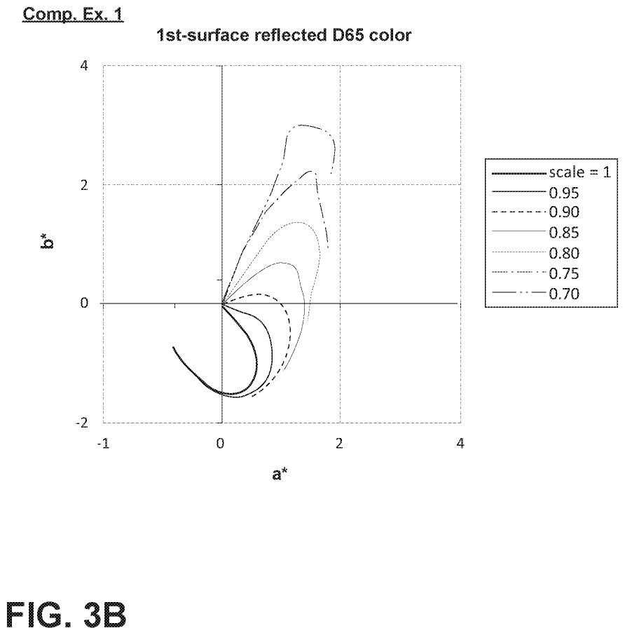

Referring to FIG. 3A, a plot is provided of first-surface reflectance vs. wavelength for this comparative example, as measured at a near-normal incident angle of 8°. Notably, this comparative example exhibits high maximum and minimum reflectance oscillations in the 1000 to 1700 nm wavelength band of greater than 7%. It is also evident from FIG. 3A that this comparative example exhibits high reflectance in the near-infrared spectrum, e.g., over 8% at 1100 nm, ~10% at 1300 nm, and over 11% at 1500 nm.

Referring to FIG. 3B, a plot is provided of single-sided, reflected color for this comparative example, as measured at incident angles from 0° to 90° with various optical film structure thickness scaling factors.

TABLE 1
Comp. Ex. 1 transparent article design with
strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25.0 | 1.476 |
| 2 | SiOxNy | 11.8 | 1.946 |
| 3 | SiO2 | 52.1 | 1.476 |
| 4 | SiOxNy | 27.8 | 1.946 |
| 5 | SiO2 | 30.1 | 1.476 |
| 6 | SiOxNy | 45.7 | 1.946 |
| 7 | SiO2 | 8.8 | 1.476 |
| 8 | SiOxNy | 2060.0 | 1.946 |
| 9 | SiO2 | 19.6 | 1.476 |
| 10 | SiNy | 30.3 | 2.014 |
| 11 | SiO2 | 63.1 | 1.476 |
| | Medium | Air | 1 |

Total thickness (nm): 2374.2
AR layers (outer structure) thickness (nm): 113.0
Low-RI in AR thickness (nm): 82.7

### Comparative Example 2

A comparative transparent article including a strengthened glass substrate was prepared for this example with the structure delineated below in Table 2. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. Further, the layers of the optical film structure were deposited according to vapor deposition conditions set forth in U.S. Patent Application Publication No. 2020/0158916, the salient portions of which are incorporated herein by reference.

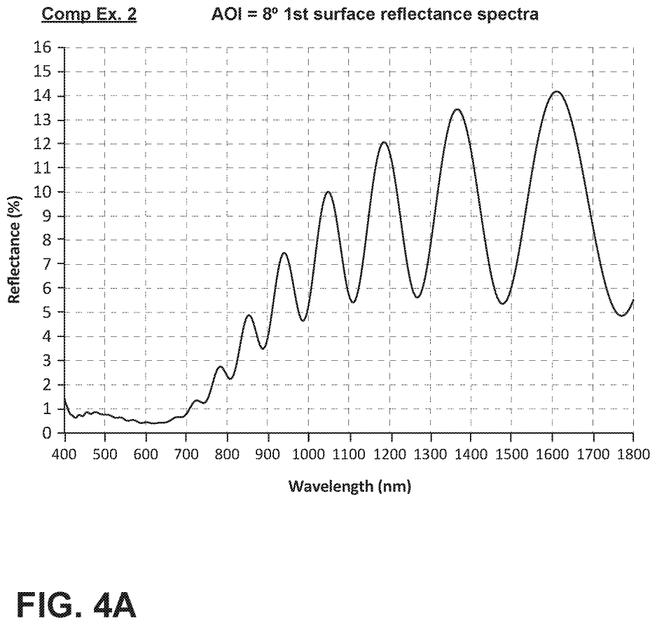

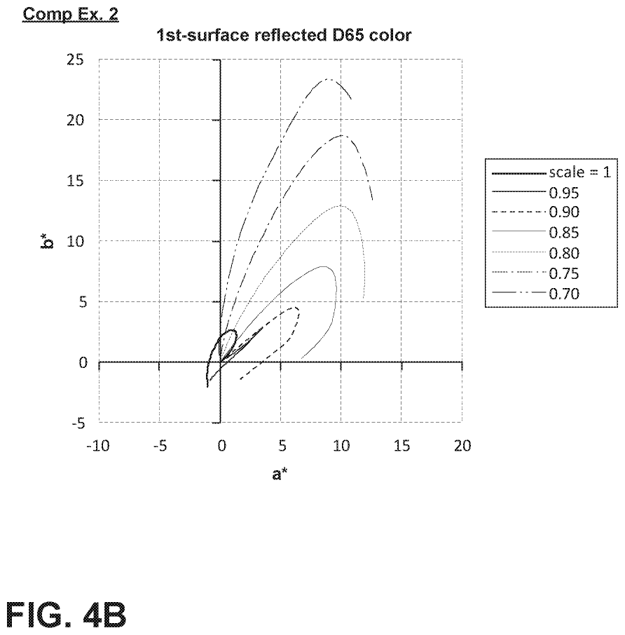

Referring to FIG. 4A, a plot is provided of first-surface reflectance vs. wavelength for this comparative example, as measured at a near-normal incident angle of 8°. Notably, this comparative example exhibits high maximum and minimum reflectance oscillations in the 1000 to 1700 nm wavelength band of greater than 8%. It is also evident from FIG. 4A that this comparative example exhibits high reflectance in the near-infrared spectrum, e.g., over 7% at 940 nm, over 12% at 1200 nm, over 13% at 1350 nm, and over 11% at 1500 nm.

Referring to FIG. 4B, a plot is provided of single-sided, reflected color for this comparative example, as measured at incident angles from 0° to 90° with various optical film structure thickness scaling factors. As is evident from FIG. 4B, the color shift exhibited by this comparative example is less than 4 only for a narrow range of optical film structure thickness scaling factors from about 95 to 100%.

TABLE 2
Comp. Ex. 2 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 9.62 | 1.943 |
| 3 | SiO2 | 53.7 | 1.476 |
| 4 | SiOxNy | 26.14 | 1.943 |
| 5 | SiO2 | 30.12 | 1.476 |
| 6 | SiOxNy | 44.88 | 1.943 |
| 7 | SiO2 | 8.71 | 1.476 |
| 8 | SiOxNy | 2000 | 1.943 |
| 9 | SiO2 | 9 | 1.476 |
| 10 | SiNy | 46.3 | 2.014 |
| 11 | SiO2 | 16.6 | 1.476 |
| 12 | SiNy | 150.2 | 2.014 |
| 13 | SiO2 | 90.5 | 1.476 |
| | Medium | Air | 1 |

Total thickness (nm): 2510.8
AR layers (outer structure) thickness (nm): 312.6
Low-RI in AR thickness (nm): 116.1

### Comparative Example 3

A comparative transparent article including a strengthened glass substrate was prepared for this example with the structure delineated below in Table 3. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. Further, the layers of the optical film structure were deposited according to vapor deposition conditions set forth in U.S. Patent Application Publication No. 2020/0158916, the salient portions of which are incorporated herein by reference.

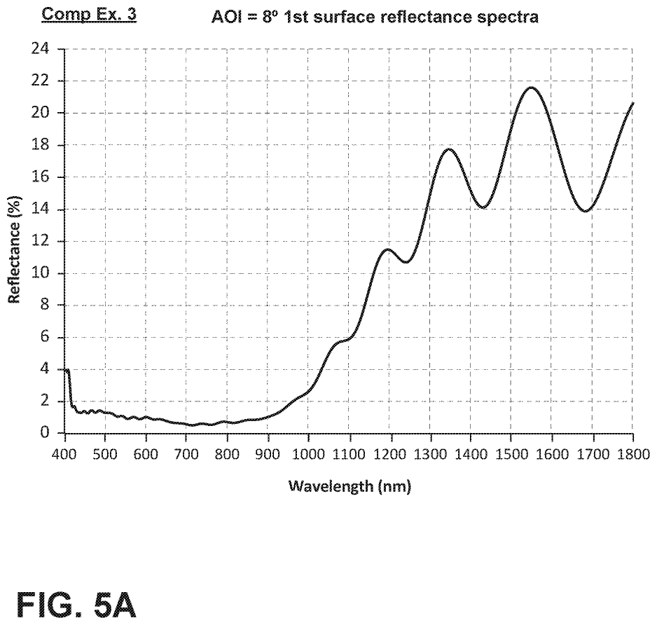

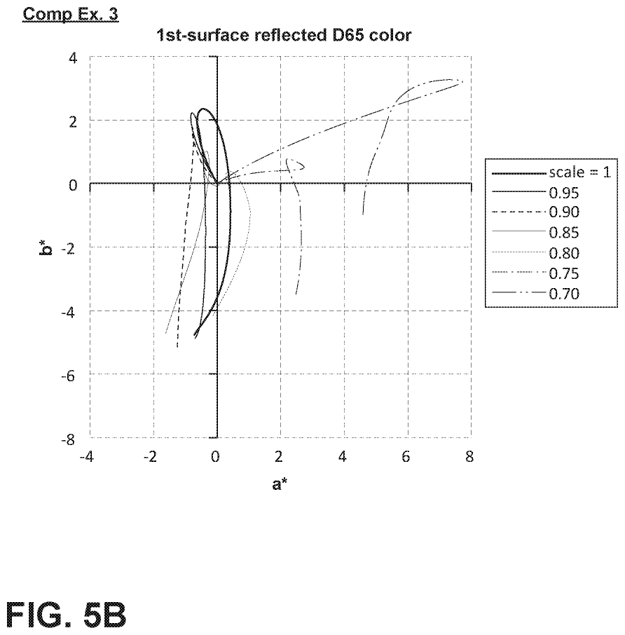

Referring to FIG. 5A, a plot is provided of first-surface reflectance vs. wavelength for this comparative example, as measured at a near-normal incident angle of 8°. Notably, this comparative example exhibits high maximum and minimum reflectance oscillations in the 1000 to 1700 nm wavelength band of greater than 7%. It is also evident from FIG. 5A that this comparative example exhibits high reflectance in the near-infrared spectrum, e.g., over 11% at 1200 nm, over 17% at 1350 nm, and over 21% at 1550 nm.

Referring to FIG. 5B, a plot is provided of single-sided, reflected color for this comparative example, as measured at incident angles from 0° to 90° with various optical film structure thickness scaling factors. As is evident from FIG. 5B, the color shift exhibited by this comparative example is fairly consistent for optical film structure thickness scaling factors from about 75 to 100%, the range of color shift marginally exceeds 4 for almost all scaling factors.

TABLE 3
Comp. Ex. 3 transparent article design with strengthened glass substrate

| | | thickness | Index |
|---|---|---|---|
| Layer | Material | (nm) | (550 nm) |
| | Glass | Substrate | 1.51 |
| 1 | SiO2 | 20 | 1.476 |
| 2 | SiOxNy | 8.14 | 1.943 |
| 3 | SiO2 | 67.12 | 1.476 |
| 4 | SiOxNy | 21.57 | 1.943 |
| 5 | SiO2 | 50.82 | 1.476 |
| 6 | SiOxNy | 39.32 | 1.943 |
| 7 | SiO2 | 26.68 | 1.476 |
| 8 | SiOxNy | 56.09 | 1.943 |
| 9 | SiO2 | 8 | 1.476 |
| 10 | SiOxNy | 1500 | 1.943 |
| 11 | SiO2 | 14.56 | 1.476 |
| 12 | SiNy | 38.39 | 2.014 |
| 13 | SiO2 | 46.3 | 1.476 |
| 14 | SiNy | 25.19 | 2.014 |
| 15 | SiO2 | 81.14 | 1.476 |
| 16 | SiNy | 24.93 | 2.014 |
| 17 | SiO2 | 44.65 | 1.476 |
| 18 | SiNy | 152.62 | 2.014 |
| 19 | SiO2 | 102.28 | 1.476 |
| | Medium | Air | 1 |

Total thickness (nm): 2327.8
AR layers (outer structure) thickness (nm): 530.1
Low-RI in AR thickness (nm): 288.9

### Example 1

A transparent article including a strengthened glass-ceramic substrate was prepared for this example with the structure delineated below in Table 4. The glass-ceramic substrate is an ion-exchanged, LAS glass-ceramic substrate having a thickness of 600 μm and a refractive index of 1.533. Further, the glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

Referring again to the transparent article of this example, the layers (e.g., layers 17-23 in Table 4) of the optical film structure above the scratch-resistant layer (e.g., layer 16 in Table 4) are configured to achieve high shallow hardness while not negatively affecting the optical properties of the article, including reflectance in the visible, IR, and near-IR spectra. As is evident from the optical film structure design of Table 4, medium index layers (SiOₓN_{y} layers 18, 20 and 22) are disposed adjacent to high index layers (SiN_{y} layers 17, 19 and 21), which drive shallow high hardness levels in the article. Similarly, as is evident in Table 4, the total thickness of the low refractive index layers (e.g., SiO₂ layer 23) in the outer structure of the optical film structure above the scratch-resistant layer is minimized to a level that is less than 25 nm, which also helps drive shallow high hardness levels in the article.

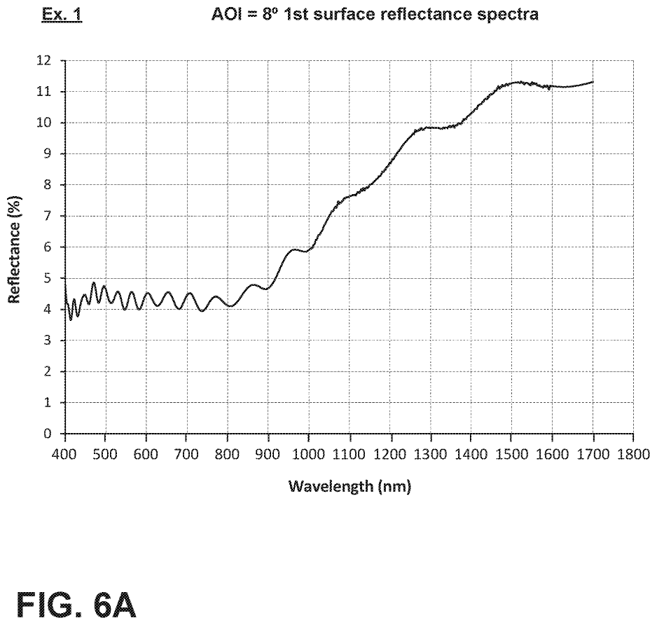

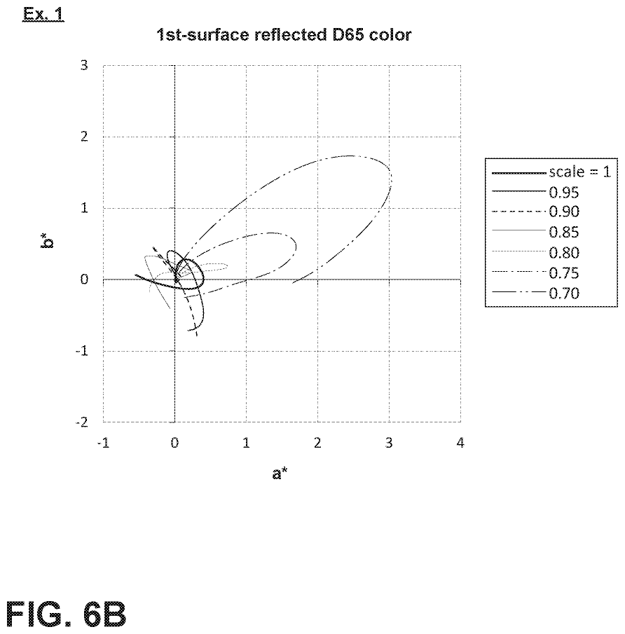

Referring to FIG. 6A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 6%. It is also evident from FIG. 6A that this example exhibits a maximum reflectance of less than 12% in the near-infrared spectrum from 1000 to 1700 nm.

Referring to FIG. 6B, a plot is provided of single-sided, reflected color for this inventive example, as measured at incident angles from 0° to 90° with various optical film structure thickness scaling factors. As is evident from FIG. 6B, the color shift exhibited by this inventive example is fairly consistent and less than 4 for a wide range of optical film structure thickness scaling factors from about 70 to 100%.

TABLE 4
Ex. 1 transparent article design with
strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25 | 1.476 |
| 2 | SiOxNy | 12.54 | 1.829 |
| 3 | SiO2 | 71.63 | 1.476 |
| 4 | SiOxNy | 21.03 | 1.829 |
| 5 | SiO2 | 73.87 | 1.476 |
| 6 | SiOxNy | 29.33 | 1.829 |
| 7 | SiO2 | 63.3 | 1.476 |
| 8 | SiOxNy | 40.23 | 1.829 |
| 9 | SiO2 | 48.18 | 1.476 |
| 10 | SiOxNy | 52.74 | 1.829 |
| 11 | SiO2 | 32.29 | 1.476 |
| 12 | SiOxNy | 64.81 | 1.829 |
| 13 | SiO2 | 18.38 | 1.476 |
| 14 | SiOxNy | 72.37 | 1.829 |
| 15 | SiO2 | 8 | 1.476 |
| 16 | SiOxNy | 2000 | 1.829 |
| 17 | SiNy | 19.48 | 2.058 |
| 18 | SiOxNy | 26.77 | 1.744 |
| 19 | SiNy | 63.87 | 2.058 |
| 20 | SiOxNy | 8 | 1.744 |
| 21 | SiNy | 61.67 | 2.058 |
| 22 | SiOxNy | 76.23 | 1.744 |
| 23 | SiO2 | 14 | 1.476 |
| | Medium | Air | 1 |

Total thickness (nm): 2903.7
AR layers (outer structure) thickness (nm): 270.0
Low-RI in AR thickness (nm): 14

### Example 2

A transparent article including a strengthened glass-ceramic substrate was prepared for this example with the structure delineated below in Table 5. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. The layers of the optical film structure were deposited according to vapor deposition conditions set forth in U.S. Patent Application Publication No. 2020/0158916, the salient portions of which are incorporated herein by reference.

Referring again to the transparent article of this example, the layers (e.g., layers 17-27 in Table 5) of the optical film structure above the scratch-resistant layer (e.g., layer 16 in Table 5) are configured to achieve high shallow hardness while not negatively affecting the optical properties of the article, including reflectance in the visible, IR, and near-IR spectra. As is evident from the optical film structure design of Table 5, medium index layers (SiOₓN_{y} layers 18, 20, 22, 24 and 26) are disposed adjacent to high index layers (SiN_{y} layers 17, 19, 21, 23, and 25), which drive shallow high hardness levels in the article. Similarly, as is evident in Table 5, the total thickness of the low refractive index layers (e.g., SiO₂ layer 27) in the outer structure of the optical film structure above the scratch-resistant layer is minimized to a level that is less than 25 nm, which also helps drive shallow high hardness levels in the article.

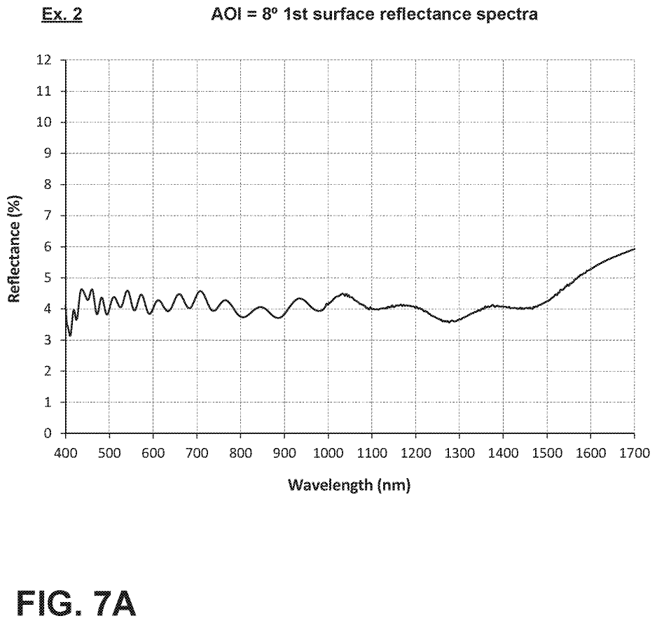

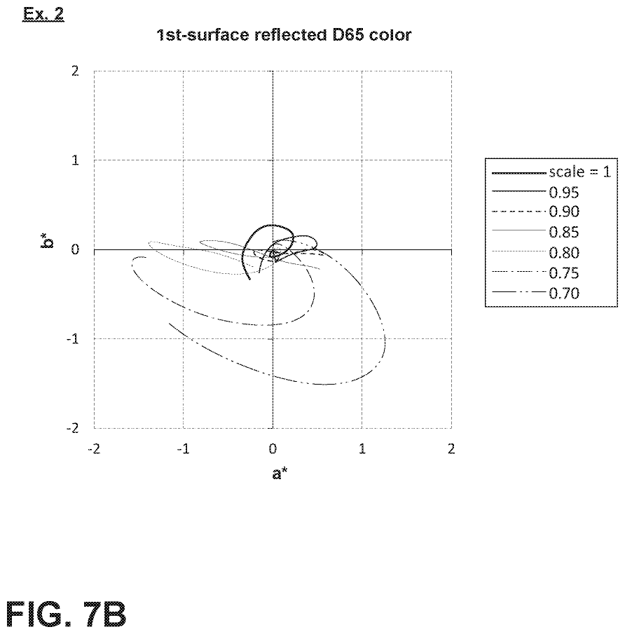

Referring to FIG. 7A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 2.5%. It is also evident from FIG. 7A that this example exhibits a low maximum reflectance of less than 6% in the near-infrared spectrum from 1000 to 1700 nm.

Referring to FIG. 7B, a plot is provided of single-sided, reflected color for this inventive example, as measured at incident angles from 0° to 90° with various optical film structure thickness scaling factors. As is evident from FIG. 7B, the color shift exhibited by this inventive example is fairly consistent and less than 4 for the full range of optical film structure thickness scaling factors from about 50 to 100% depicted in this figure.

TABLE 5
Ex. 2 transparent article design with strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25 | 1.476 |
| 2 | SiOxNy | 12.54 | 1.829 |
| 3 | SiO2 | 71.63 | 1.476 |
| 4 | SiOxNy | 21.03 | 1.829 |
| 5 | SiO2 | 73.87 | 1.476 |
| 6 | SiOxNy | 29.33 | 1.829 |
| 7 | SiO2 | 63.3 | 1.476 |
| 8 | SiOxNy | 40.23 | 1.829 |
| 9 | SiO2 | 48.18 | 1.476 |
| 10 | SiOxNy | 52.74 | 1.829 |
| 11 | SiO2 | 32.29 | 1.476 |
| 12 | SiOxNy | 64.81 | 1.829 |
| 13 | SiO2 | 18.38 | 1.476 |
| 14 | SiOxNy | 72.37 | 1.829 |
| 15 | SiO2 | 8 | 1.476 |
| 16 | SiOxNy | 2000 | 1.829 |
| 17 | SiNy | 18.66 | 2.058 |
| 18 | SiOxNy | 34.63 | 1.744 |
| 19 | SINy | 45.71 | 2.058 |
| 20 | SiOxNy | 19.13 | 1.744 |
| 21 | SiNy | 86.77 | 2.058 |
| 22 | SiOxNy | 8 | 1.744 |
| 23 | SINy | 70.54 | 2.058 |
| 24 | SiOxNy | 33.86 | 1.744 |
| 25 | SiNy | 28.58 | 2.058 |
| 26 | SiOxNy | 103.04 | 1.655 |
| 27 | SiO2 | 14 | 1.476 |
| | Medium | Air | 1 |

Total thickness (nm): 3096.6
AR layers (outer structure) thickness (nm): 462.9
Low-RI in AR thickness (nm): 14

### Example 3

A transparent article including a strengthened glass-ceramic substrate was prepared for this example with the structure delineated below in Table 6. The glass-ceramic substrate is an ion-exchanged, LAS glass-ceramic substrate having a thickness of 600 μm and a refractive index of 1.528. Further, the glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. The layers of the optical film structure were deposited according to vapor deposition conditions set forth in U.S. Patent Application Publication No. 2020/0158916, the salient portions of which are incorporated herein by reference.

Referring again to the transparent article of this example, the layers (e.g., layers 17-23 in Table 6) of the optical film structure above the scratch-resistant layer (e.g., layer 16 in Table 6) are configured to achieve high shallow hardness while not negatively affecting the optical properties of the article, including reflectance in the visible, IR, and near-IR spectra. As is evident from the optical film structure design of Table 6, medium index layers (SiOₓN_{y} layers 18, 20, and 22) are disposed adjacent to high index layers (SiN_{y} layers 17, 19, and 21), which drive shallow high hardness levels in the article. Similarly, as is evident in Table 6, the total thickness of the low refractive index layers (e.g., SiO₂ layer 24) in the outer structure of the optical film structure above the scratch-resistant layer is minimized to a level that is less than 25 nm, which also helps drive shallow high hardness levels in the article. In addition, as is also evident in Table 6, the outer structure of this example includes a repeating medium index layer (e.g., layer 23) adjacent to another medium index layer (e.g., layer 22), which can also positively influence the hardness levels of the article at shallow indentation depths.

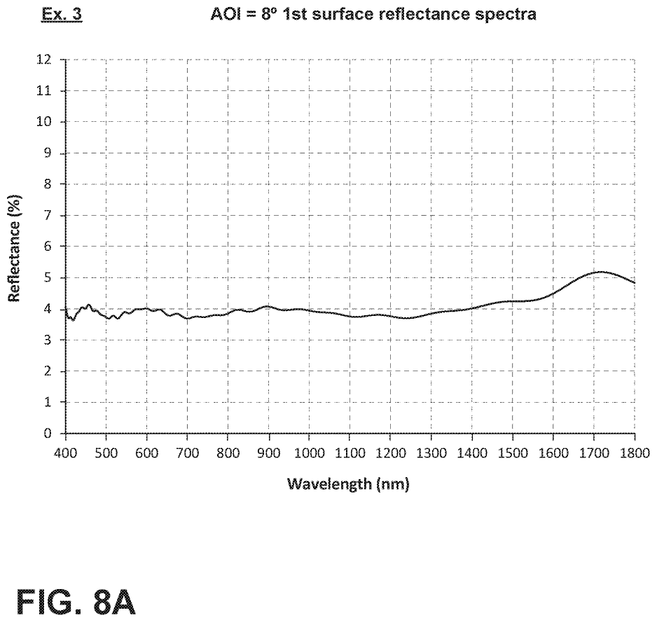

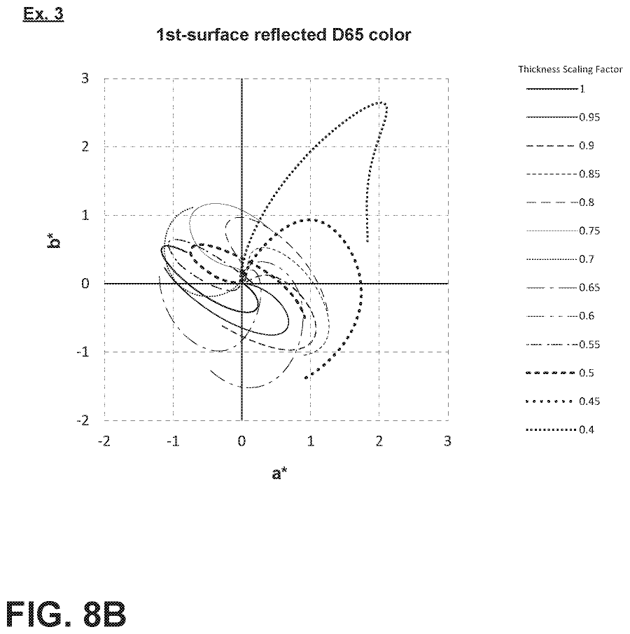

Referring to FIG. 8A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 2%. It is also evident from FIG. 8A that this example exhibits a low maximum reflectance of less than 5.5% in the near-infrared spectrum from 1000 to 1700 nm.

Referring to FIG. 8B, a plot is provided of single-sided, reflected color for this inventive example, as measured at incident angles from 0° to 90° with various optical film structure thickness scaling factors. As is evident from FIG. 8B, the color shift exhibited by this inventive example is fairly consistent and less than 4 for the full range of optical film structure thickness scaling factors from about 40 to 100% depicted in this figure.

TABLE 6
Ex. 3 transparent article design with strengthened glass-ceramic substrate

| | | thickness | Index |
|---|---|---|---|
| Layer | Material | (nm) | (550 nm) |
| | Glass-Ceramic | Substrate | 1.528 |
| 1 | SiO2 | 25 | 1.462 |
| 2 | SiOxNy | 8.99 | 1.945 |
| 3 | SiO2 | 70.16 | 1.462 |
| 4 | SiOxNy | 15.52 | 1.945 |
| 5 | SiO2 | 72.99 | 1.462 |
| 6 | SiOxNy | 23.13 | 1.945 |
| 7 | SiO2 | 62.88 | 1.462 |
| 8 | SiOxNy | 32.66 | 1.945 |
| 9 | SiO2 | 49.17 | 1.462 |
| 10 | SiOxNy | 42.2 | 1.945 |
| 11 | SiO2 | 35.96 | 1.462 |
| 12 | SiOxNy | 48.1 | 1.945 |
| 13 | SiO2 | 24.86 | 1.462 |
| 14 | SiOxNy | 40.77 | 1.945 |
| 15 | SiO2 | 8.75 | 1.462 |
| 16 | SiOxNy | 2000 | 1.829 |
| 17 | SiNy | 13.5 | 2.050 |
| 18 | SiOxNy | 45.7 | 1.754 |
| 19 | SiNy | 25.77 | 2.050 |
| 20 | SiOxNy | 54.2 | 1.754 |
| 21 | SiNy | 19.57 | 2.050 |
| 22 | SiOxNy | 120.71 | 1.754 |
| 23 | SiOxNy | 94.76 | 1.589 |
| 24 | SiO2 | 14 | 1.462 |
| | Medium | Air | 1 |

Total thickness (nm): 2949.4
AR layers (outer structure) thickness (nm): 388.2
Low-RI in AR thickness (nm): 14

### Mechanical Properties of Examples 1-3

Referring now to FIG. 9A, a box plot is provided of average article failure stress, as measured in a ring-on-ring test, for the transparent articles of Exs. 1-3, Comp. Ex. 2 and a control glass-ceramic substrate without an optical film structure. As is evident form FIG. 9A, the inventive examples demonstrate average failure stress levels of at least 800 MPa, which are comparable to the average failure stress level of a bare glass-ceramic substrate without an optical film structure (denoted “no hardcoat” in FIG. 9A). In contrast, the comparative example (Comp. Ex. 2) demonstrates an average failure stress level of less than 600 MPa, well below the average failure stress levels of the inventive examples (Exs. 1-3).

Referring now to FIGS. 9B and 9C, plots are provided of hardness and elastic modulus vs. displacement, as measured in a Berkovich Hardness Test of the optical film structures of the transparent articles of Exs. 1-3. As is evident from FIG. 9B, each of the inventive examples (Exs. 1-3) exhibits a hardness of about 15 GPa or greater at shallow indentation depths from 100 to 125 nm. As is evident from FIG. 9C, each of the inventive examples (Exs. 1-3) exhibits a maximum elastic modulus in the range of 160-200 GPa, and an elastic modulus at 15% of the total thickness of the optical film structure (~450 nm for these examples) of 120-160 GPa.

### Example 4

A transparent article including a strengthened glass-ceramic substrate was prepared for this example with the structure delineated below in Table 7. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

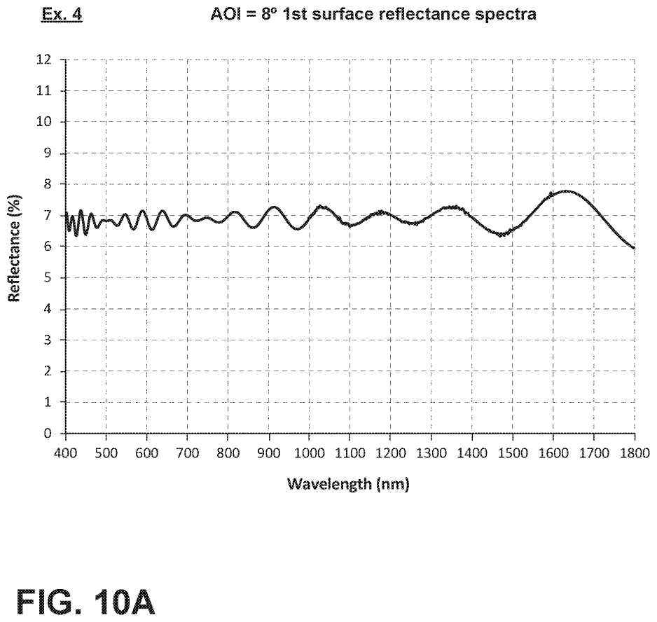

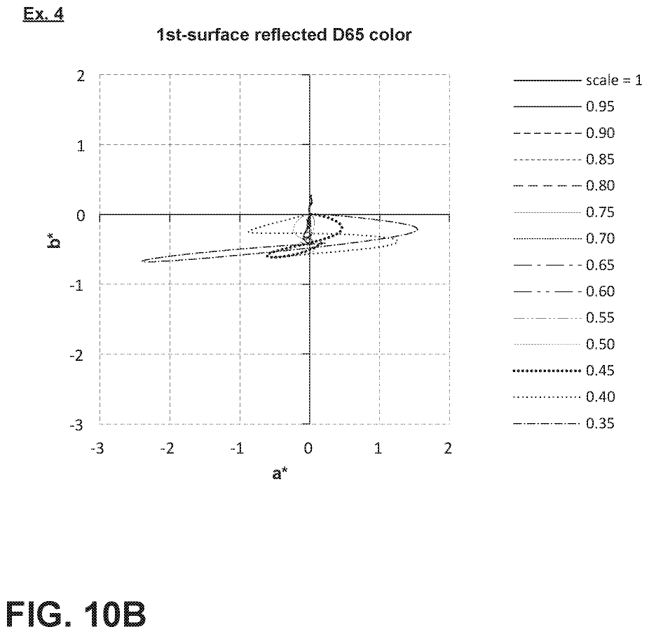

Referring to FIG. 10A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 2%.

Referring to FIG. 10B, a plot is provided of single-sided, reflected color for this inventive example, as measured at incident angles from 0° to 90° with various optical film structure thickness scaling factors. As is evident from FIG. 10B, the color shift exhibited by this inventive example is fairly consistent and less than 4 for the full range of optical film structure thickness scaling factors from about 35 to 100% depicted in this figure.

TABLE 7
Ex. 4 transparent article design with strengthened glass-ceramic substrate

| Layer | Material | thickness (nm) | Index (550 nm) |
|---|---|---|---|
| | Glass-ceramic | Substrate | 1.533 |
| 1 | SiO2 | 25 | 1.476 |
| 2 | SiOxNy | 14.37 | 1.744 |
| 3 | SiO2 | 66 | 1.476 |
| 4 | SiOxNy | 26.64 | 1.744 |
| 5 | SiO2 | 58.9 | 1.476 |
| 6 | SiOxNy | 40.48 | 1.744 |
| 7 | SiO2 | 40.9 | 1.476 |
| 8 | SiOxNy | 56.21 | 1.744 |
| 9 | SiO2 | 22.2 | 1.476 |
| 10 | SiOxNy | 69.21 | 1.744 |
| 11 | SiO2 | 8 | 1.476 |
| 12 | SiOxNy | 1960 | 1.744 |
| 13 | SiO2 | 18 | 1.476 |
| | Medium | Air | 1 |

Total thickness (nm): 2405.9
Low-RI in AR layers thickness (nm): 18.0

### Example 5

A transparent article including a strengthened glass-ceramic substrate was prepared for this example with the structure delineated below in Table 8. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

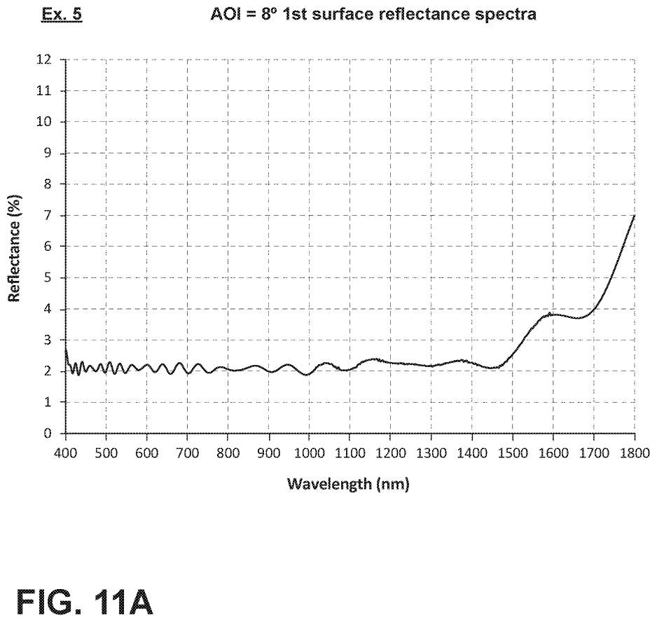

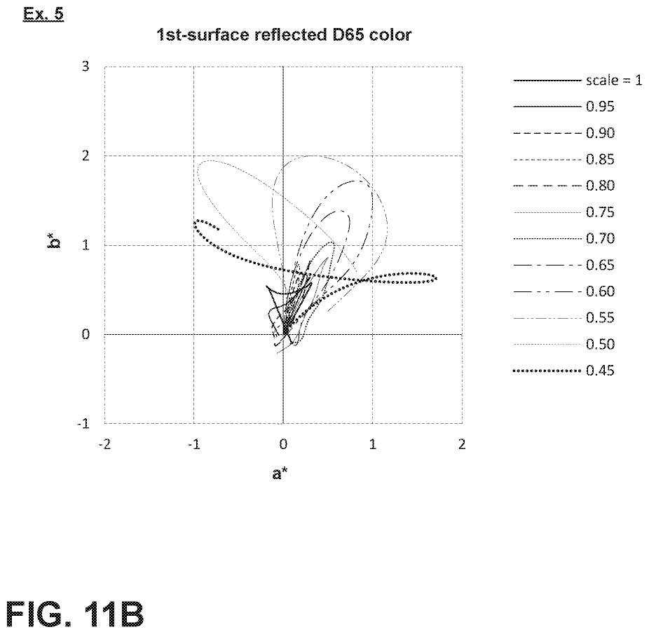

Referring to FIG. 11A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 2.5%.

Referring to FIG. 11B, a plot is provided of single-sided, reflected color for this inventive example, as measured at incident angles from 0° to 90° with various optical film structure thickness scaling factors. As is evident from FIG. 11B, the color shift exhibited by this inventive example is fairly consistent and less than 4 for the full range of optical film structure thickness scaling factors from about 45 to 100% depicted in this figure.

TABLE 8
Ex. 5 transparent article design with strengthened glass-ceramic substrate

| Layer | Material | thickness (nm) | Index (550 nm) |
|---|---|---|---|
| | MGC | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiOxNy | 24.99 | 1.744 |
| 14 | SiNy | 11.11 | 2.042 |
| 15 | SiOxNy | 56.38 | 1.744 |
| 16 | SiNy | 6.85 | 2.042 |
| 17 | SiOxNy | 214.84 | 1.744 |
| 18 | SiNy | 12.22 | 2.042 |
| 19 | SiOxNy | 48.56 | 1.744 |
| 20 | SiNy | 33.69 | 2.042 |
| 21 | SiOxNy | 21.47 | 1.744 |
| 22 | SiNy | 164.48 | 2.042 |
| 23 | SiOxNy | 17.65 | 1.744 |
| 24 | SiNy | 17.99 | 2.042 |
| 25 | SiOxNy | 71.13 | 1.744 |
| 26 | SiO2 | 95 | 1.476 |
| | Medium | Air | 1 |

Total thickness (nm): 3174.7
AR layers (outer structure) thickness (nm): 796.4
Low-RI in AR thickness (nm): 95

### Example 6

A transparent article including a strengthened glass substrate was prepared for this example with the structure delineated below in Table 9. In this example, the substrate used was Gorilla® Glass 3 (commercially available from Corning, Inc.). Examples of Gorilla® Glass 3 compositions are described in U.S. Pat. Nos. 7,666,511, 4,483,700, and 5,674,790, the salient contents of which are hereby incorporated by reference in this disclosure. The layers of the optical film structure were deposited according to vapor deposition conditions set forth in U.S. Patent Application Publication No. 2020/0158916, the salient portions of which are incorporated herein by reference.

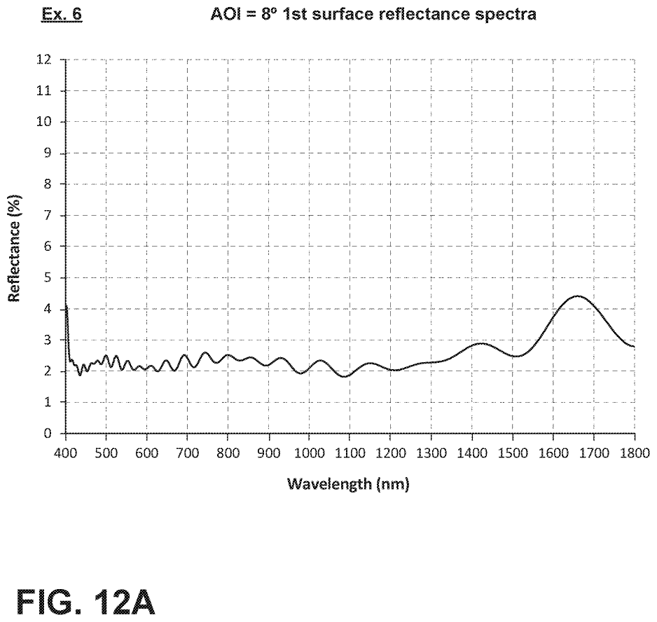

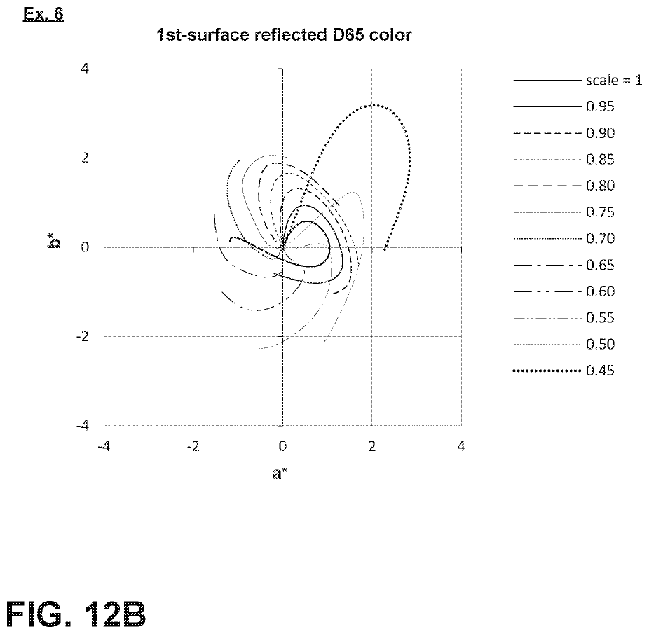

Referring to FIG. 12A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 3%.

Referring to FIG. 12B, a plot is provided of single-sided, reflected color for this inventive example, as measured at incident angles from 0° to 90° with various optical film structure thickness scaling factors. As is evident from FIG. 12B, the color shift exhibited by this inventive example is fairly consistent and less than 4 for the full range of optical film structure thickness scaling factors from about 45 to 100% depicted in this figure.

TABLE 9
Ex. 6 transparent article design with strengthened glass substrate

| Layer | Material | Thickness (nm) | Index (550 nm) |
|---|---|---|---|
| | Gorilla ® Glass 3 | Substrate | 1.510 |
| 1 | SiO2 | 20 | 1.476 |
| 2 | SiOxNy | 9.13 | 1.943 |
| 3 | SiO2 | 70.52 | 1.476 |
| 4 | SiOxNy | 21.35 | 1.943 |
| 5 | SiO2 | 59.3 | 1.476 |
| 6 | SiOxNy | 35.98 | 1.943 |
| 7 | SiO2 | 39.4 | 1.476 |
| 8 | SiOxNy | 51.4 | 1.943 |
| 9 | SiO2 | 20.2 | 1.476 |
| 10 | SiOxNy | 63.7 | 1.943 |
| 11 | SiO2 | 6.4 | 1.476 |
| 12 | SiOxNy | 2050 | 1.943 |
| 13 | SiO2 | 16.28 | 1.476 |
| 14 | SiNy | 38.06 | 2.042 |
| 15 | SiO2 | 43.88 | 1.476 |
| 16 | SiNy | 23 | 2.042 |
| 17 | SiO2 | 129.82 | 1.476 |
| | Medium | Air | 1 |

Total thickness (nm): 2698.4
AR layers (outer structure) thickness (nm): 251.0
Low-RI in AR thickness (nm): 190.0

### Example 7

A transparent article including a strengthened glass-ceramic substrate was prepared for this example with the structure delineated below in Table 10. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

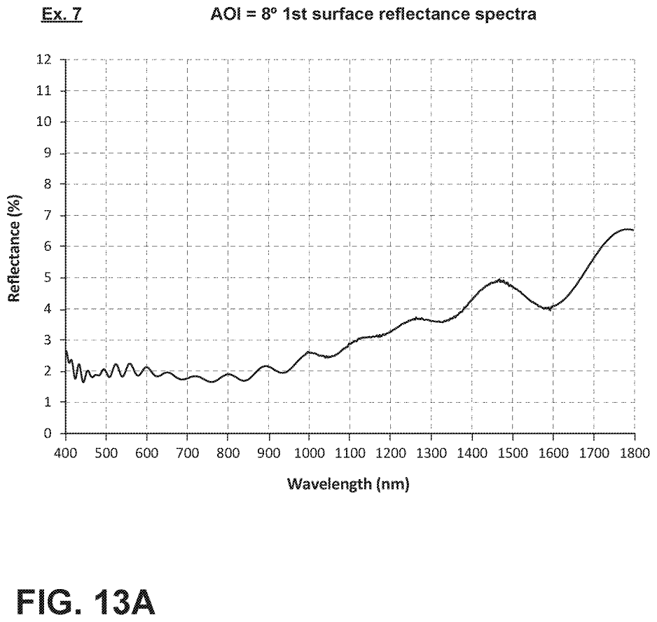

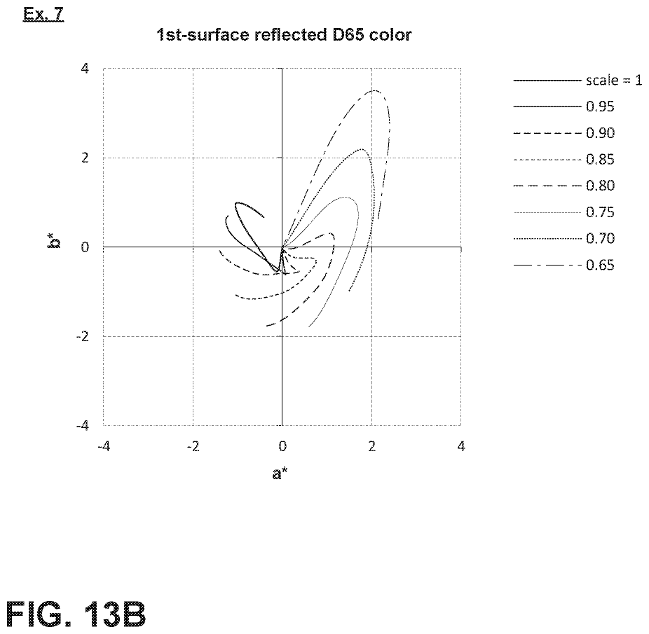

Referring to FIG. 13A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 4%.

Referring to FIG. 13B, a plot is provided of single-sided, reflected color for this inventive example, as measured at incident angles from 0° to 90° with various optical film structure thickness scaling factors. As is evident from FIG. 13B, the color shift exhibited by this inventive example is fairly consistent and less than 4 for the full range of optical film structure thickness scaling factors from about 65 to 100% depicted in this figure.

TABLE 10
Ex. 7 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiO2 | 17.73 | 1.476 |
| 14 | SiNy | 13.8 | 2.042 |
| 15 | SiO2 | 18.86 | 1.476 |
| 16 | SiNy | 10.35 | 2.042 |
| 17 | SiO2 | 105 | 1.476 |
| | Medium | Air | 1 |

Total thickness (nm): 2544.0
AR layers (outer structure) thickness (nm): 165.7
Low-RI in AR thickness (nm): 141.6

### Example 8

A transparent article including a strengthened glass-ceramic substrate was prepared for this example with the structure delineated below in Table 11. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

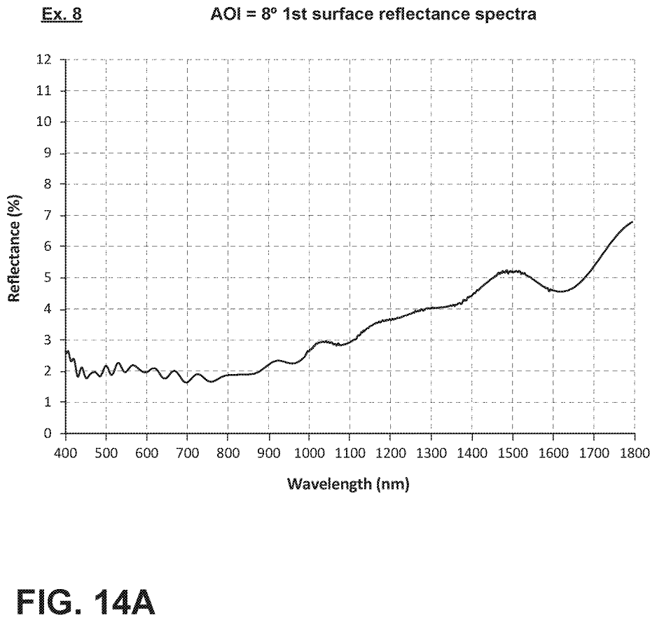

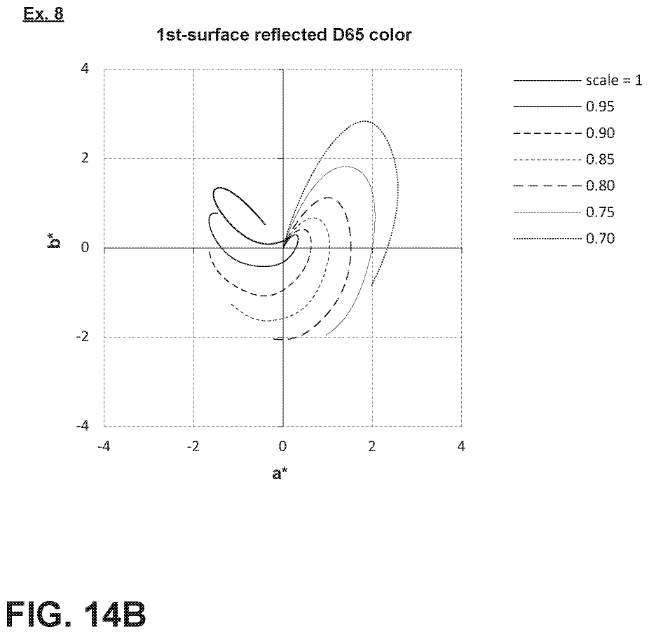

Referring to FIG. 14A, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than about 3%.

Referring to FIG. 14B, a plot is provided of single-sided, reflected color for this inventive example, as measured at incident angles from 0° to 90° with various optical film structure thickness scaling factors. As is evident from FIG. 14B, the color shift exhibited by this inventive example is fairly consistent and less than 4 for the full range of optical film structure thickness scaling factors from about 70 to 100% depicted in this figure.

TABLE 11
Ex. 8 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiNy | 8.25 | 2.042 |
| 14 | SiOxNy | 98.33 | 1.744 |
| 15 | SiO2 | 99.92 | 1.476 |
| | Medium | Air | 1 |

Total thickness (nm): 2584.8
AR layers (outer structure) thickness (nm): 206.5
Low-RI in AR thickness (nm): 99.9

### Example 9

A transparent article including a strengthened glass-ceramic substrate was prepared for this example with the structure delineated below in Table 12. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

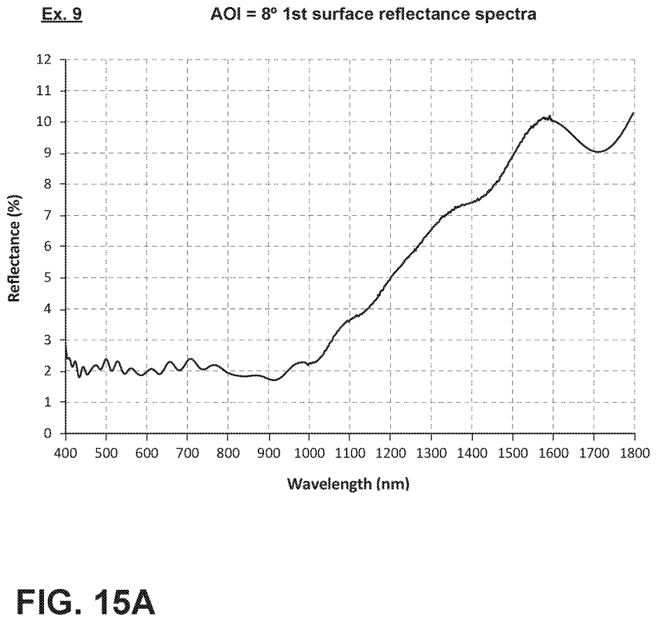

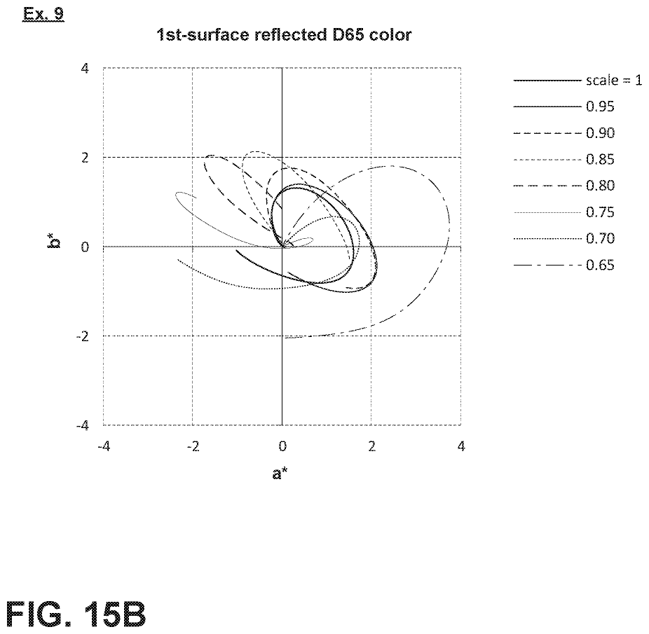

Referring to FIG. 15A, a plot is provided of first-surface reflectance vs. wavelength for this inventive example, as measured at a near-normal incident angle of 8°. This example exhibits low maximum reflectance in the 1000 to 1700 nm wavelength band of less than 10.5%.

Referring to FIG. 15B, a plot is provided of single-sided, reflected color for this inventive example, as measured at incident angles from 0° to 90° with various optical film structure thickness scaling factors. As is evident from FIG. 15B, the color shift exhibited by this inventive example is fairly consistent and less than 4 for the full range of optical film structure thickness scaling factors from about 65 to 100% depicted in this figure.

TABLE 12
Ex. 9 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiNy | 25.3 | 2.042 |
| 14 | SiO2 | 11.5 | 1.476 |
| 15 | SiNy | 148.0 | 2.042 |
| 16 | SiOxNy | 42.9 | 1.744 |
| 17 | SiNy | 12.4 | 2.042 |
| 18 | SiO2 | 81.5 | 1.476 |
| | Medium | Air | 1 |

Total thickness (nm): 2699.9
AR layers (outer structure) thickness (nm): 321.6
Low-RI in AR thickness (nm): 93.0

### Example 10

A transparent article including a strengthened glass-ceramic substrate was prepared for this example with the structure delineated below in Table 13. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. The layers of the optical film structure were deposited according to vapor deposition conditions set forth in U.S. Patent Application Publication No. 2020/0158916, the salient portions of which are incorporated herein by reference.

Referring again to the transparent article of this example, the layers (e.g., layers 13-17 in Table 13) of the optical film structure above the scratch-resistant layer (e.g., layer 12 in Table 13) are configured to achieve high shallow hardness while not negatively affecting the optical properties of the article, including reflectance in the visible, IR, and near-IR spectra. As is evident from the optical film structure design of Table 13, medium index layers (SiOₓN_{y} layers 14, and 16) are disposed adjacent to high index layers (SiN_{y} layers 13, and 15), which drive shallow high hardness levels in the article. Similarly, as is evident in Table 13, the total thickness of the low refractive index layers (e.g., SiO₂ layer 17) in the outer structure of the optical film structure above the scratch-resistant layer is minimized to a level that is less than 75 nm, which also helps drive shallow high hardness levels in the article.

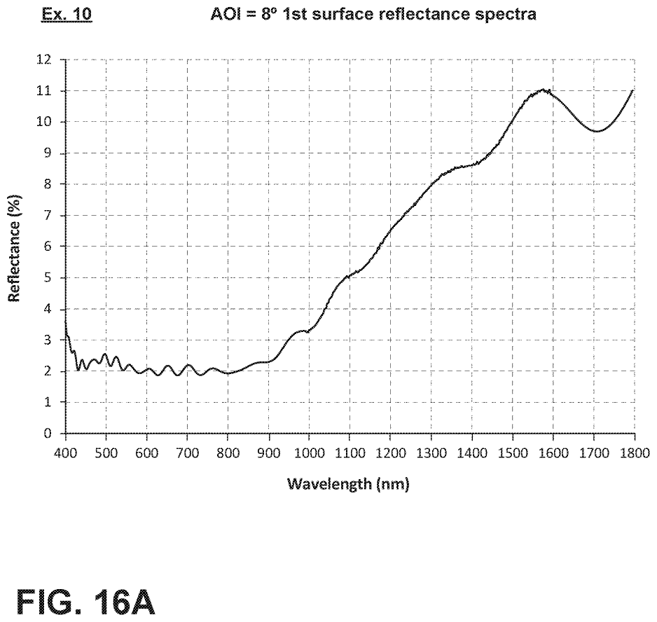

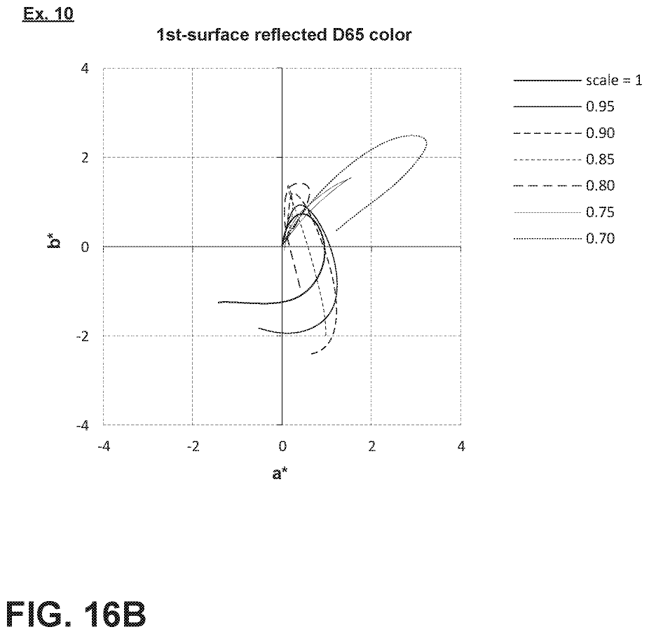

Referring to FIG. 16A, a plot is provided of first-surface reflectance vs. wavelength for this example, as measured at a near-normal incident angle of 8°. This example exhibits a maximum reflectance of less than 11.5% in the near-IR spectrum from 1000 to 1700 nm.

Referring to FIG. 16B, a plot is provided of single-sided, reflected color for this inventive example, as measured at incident angles from 0° to 90° with various optical film structure thickness scaling factors. As is evident from FIG. 16B, the color shift exhibited by this inventive example is fairly consistent and less than 4 for the full range of optical film structure thickness scaling factors from about 70 to 100% depicted in this figure.

TABLE 13
Ex. 10 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiNy | 20.8 | 2.042 |
| 14 | SiOxNy | 23.4 | 1.744 |
| 15 | SiNy | 141.5 | 2.042 |
| 16 | SiOxNy | 59.9 | 1.744 |
| 17 | SiO2 | 60 | 1.476 |
| | Medium | Air | 1 |

Total thickness (nm): 2684.0
AR layers (outer structure) thickness (nm): 305.7
Low-RI in AR thickness (nm): 60.0

### Example 11

A transparent article including a strengthened glass-ceramic substrate was prepared for this example with the structure delineated below in Table 14. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

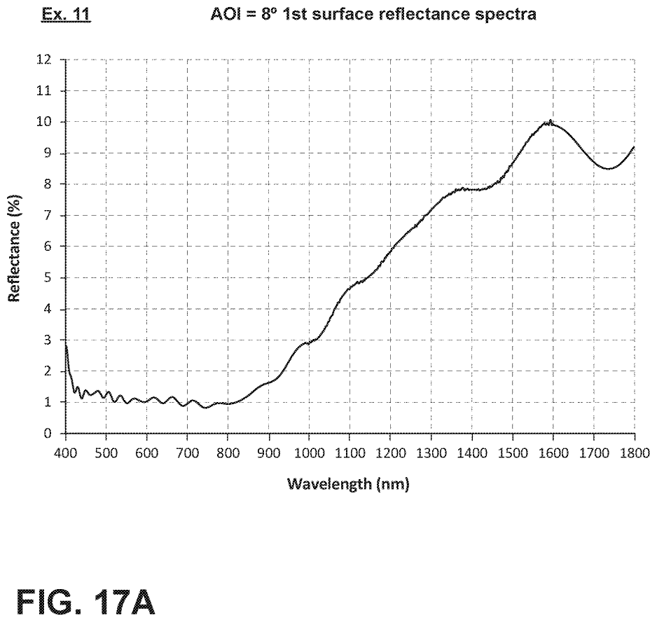

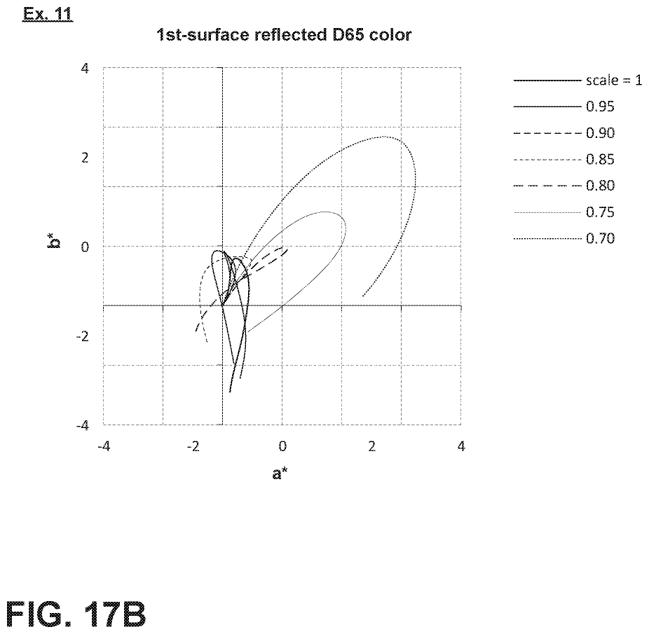

Referring to FIG. 17A, a plot is provided of first-surface reflectance vs. wavelength for this inventive example, as measured at a near-normal incident angle of 8°. This example exhibits low maximum reflectance from 1000 to 1700 nm of less than about 10%.

Referring to FIG. 17B, a plot is provided of single-sided, reflected color for this inventive example, as measured at incident angles from 0° to 90° with various optical film structure thickness scaling factors. As is evident from FIG. 17B, the color shift exhibited by this inventive example is fairly consistent and less than 4 for the full range of optical film structure thickness scaling factors from about 80 to 100% depicted in this figure.

TABLE 14
Ex. 11 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 2020 | 1.829 |
| 13 | SiNy | 22.1 | 2.042 |
| 14 | SiOxNy | 22.0 | 1.744 |
| 15 | SiNy | 84.4 | 2.042 |
| 16 | SiOxNy | 21.5 | 1.744 |
| 17 | SiNy | 33.9 | 2.042 |
| 18 | SiO2 | 104.0 | 1.476 |
| | Medium | Air | 1 |

Total thickness (nm): 2726.1
AR layers (outer structure) thickness (nm): 287.8
Low-RI in AR thickness (nm): 104.0

### Example 12

A transparent article including a strengthened glass-ceramic substrate was prepared for this example with the structure delineated below in Table 15. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

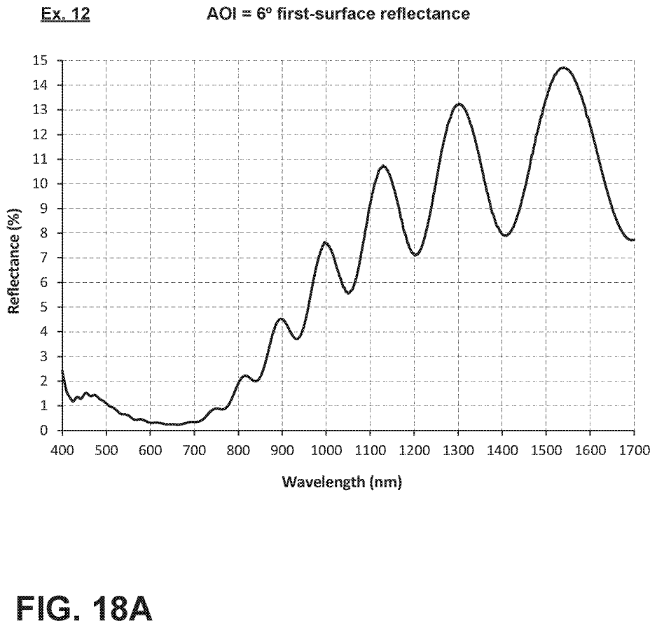

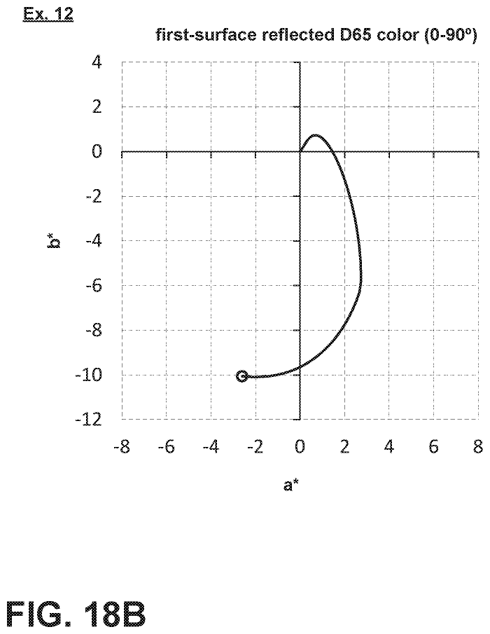

Referring to FIG. 18A, a plot is provided of first-surface reflectance vs. wavelength for this inventive example, as measured at a near-normal incident angle of 6°. Notably, this example exhibits low reflectance in the 1000 to 1700 nm wavelength band of less than about 15%.

Referring to FIG. 18B, a plot is provided of single-sided, reflected color for this inventive example, as measured at incident angles from 0° to 90° with no optical film structure thickness scaling factors (i.e., at a thickness scaling factor of 100%).

TABLE 15
Ex. 12 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25.0 | 1.476 |
| 2 | SiOxNy | 14.0 | 1.829 |
| 3 | SiO2 | 51.2 | 1.476 |
| 4 | SiOxNy | 30.7 | 1.829 |
| 5 | SiO2 | 30.1 | 1.476 |
| 6 | SiOxNy | 49.2 | 1.829 |
| 7 | SiO2 | 8.9 | 1.476 |
| 8 | SiOxNy | 2002 | 1.829 |
| 9 | SiO2 | 15.2 | 1.476 |
| 10 | SiNy | 35.2 | 2.058 |
| 11 | SiO2 | 23.1 | 1.476 |
| 12 | SiNy | 143.0 | 2.058 |
| 13 | SiO2 | 96.7 | 1.476 |
| | Medium | Air | 1 |

Total thickness (nm): 2523.8
AR layers (outer structure) thickness (nm): 313.2
Low-RI in AR thickness (nm): 135.1

### Example 13

A transparent article including a strengthened glass-ceramic substrate was prepared for this example with the structure delineated below in Table 16. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

Referring again to the transparent article of this example, the layers (e.g., layers 9-14 in Table 16) of the optical film structure above the scratch resistant layer (e.g., layer 8 in Table 16) are configured to achieve high shallow hardness while not negatively affecting the optical properties of the article, including reflectance in the visible, IR, and near-IR spectra. As is evident from the optical film structure design of Table 16, medium index layers (SiOₓN_{y} layers 9, 11, and 13) are disposed adjacent to high index layers (SiN_{y} layers 10 and 12), which drive shallow high hardness levels in the article. Similarly, as is evident in Table 13, the total thickness of the low refractive index layers (e.g., SiO₂ layer 14) in the outer structure of the optical film structure above the scratch-resistant layer is minimized to a level that is less than 75 nm, which also helps drive shallow high hardness levels in the article.

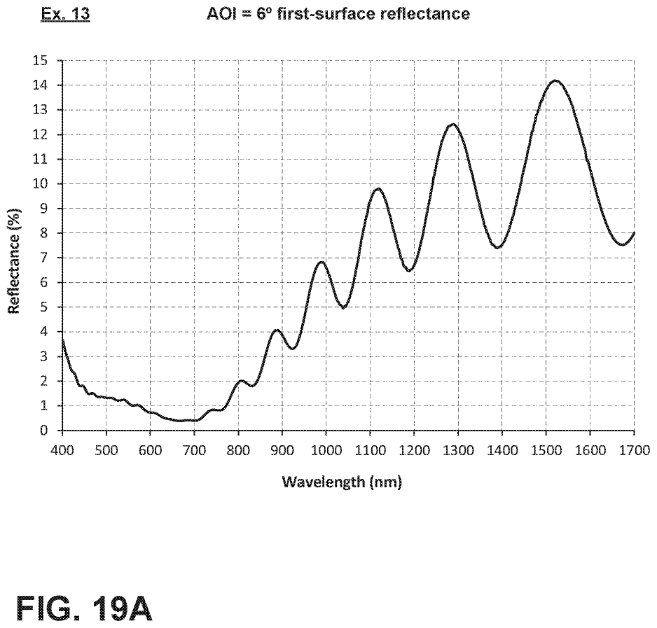

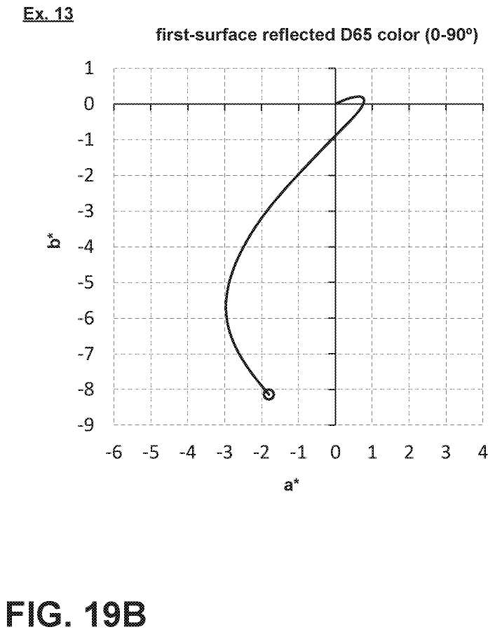

Referring to FIG. 19A, a plot is provided of first-surface reflectance vs. wavelength for this inventive example, as measured at a near-normal incident angle of 6°. Notably, this example exhibits a maximum reflectance in the 1000 to 1700 nm wavelength band of less than about 15%.

Referring to FIG. 19B, a plot is provided of single-sided, reflected color for this inventive example, as measured at incident angles from 0° to 90° with no optical film structure thickness scaling factors (i.e., at a thickness scaling factor of 100%).

TABLE 16
Ex. 13 transparent article design with strengthened glass-ceramic substrate

| Layer | Material | thickness (nm) | Index (550 nm) |
|---|---|---|---|
| | Glass-Ceramic | Substrate | 1.533 |
| 1 | SiO2 | 25.0 | 1.476 |
| 2 | SiOxNy | 14.0 | 1.829 |
| 3 | SiO2 | 51.2 | 1.476 |
| 4 | SiOxNy | 30.7 | 1.829 |
| 5 | SiO2 | 30.1 | 1.476 |
| 6 | SiOxNy | 49.2 | 1.829 |
| 7 | SiO2 | 8.9 | 1.476 |
| 8 | SiOxNy | 2000 | 1.829 |
| 9 | SiOxNy | 14.6 | 1.744 |
| 10 | SiNy | 15.1 | 2.058 |
| 11 | SiOxNy | 25.9 | 1.744 |
| 12 | SiNy | 125.7 | 2.058 |
| 13 | SiOxNy | 42.6 | 1.589 |
| 14 | SiO2 | 60.0 | 1.476 |
| | Medium | Air | 1 |

Total thickness (nm): 2492.9
AR layers (outer structure) thickness (nm): 283.9
Low-RI in AR thickness (nm): 60.0

### Example 14

A transparent article including a strengthened glass substrate was prepared for this example with the structure delineated below in Table 17. In this example, the substrate used was Gorilla® Glass 3 (commercially available from Corning, Inc.). Examples of Gorilla® Glass 3 compositions are described in U.S. Pat. Nos. 7,666,511, 4,483,700, and 5,674,790, the salient contents of which are hereby incorporated by reference in this disclosure. The layers of the optical film structure were deposited according to vapor deposition conditions set forth in U.S. Patent Application Publication No. 2020/0158916, the salient portions of which are incorporated herein by reference. Further, the layers of the optical film structure were deposited according to vapor deposition conditions set forth in U.S. Patent Application Publication No. 2020/0158916, the salient portions of which are incorporated herein by reference.

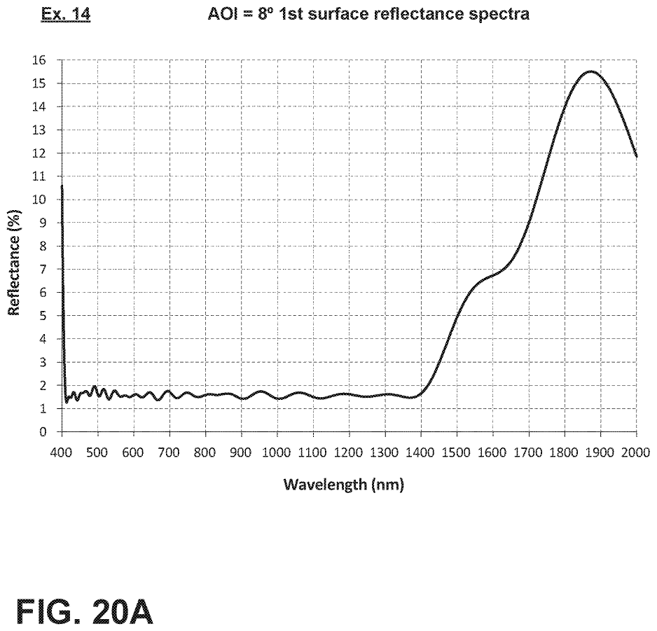

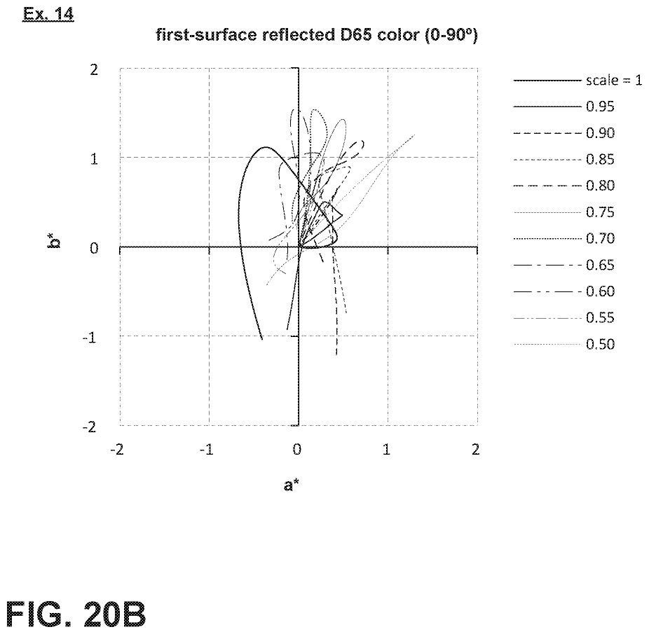

Referring to FIG. 20A, a plot is provided of first-surface reflectance vs. wavelength for this inventive example, as measured at a near-normal incident angle of 8°. Notably, this example exhibits a maximum reflectance in the 1000 to 1700 nm wavelength band of less than about 10%.

Referring to FIG. 20B, a plot is provided of single-sided, reflected color for this inventive example, as measured at incident angles from 0° to 90° with various optical film structure thickness scaling factors. As is evident from FIG. 20B, the color shift exhibited by this inventive example is fairly consistent and less than 4 for the full range of optical film structure thickness scaling factors from about 50 to 100% depicted in this figure.

TABLE 17
Ex. 14 transparent article design with strengthened glass substrate

| Layer | Material | thickness (nm) | Index (550 nm) |
|---|---|---|---|
| | Gorilla ® Glass 3 | Substrate | 1.51 |
| 1 | SiO2 | 25.0 | 1.465 |
| 2 | SiOxNy | 10.0 | 1.943 |
| 3 | SiO2 | 69.2 | 1.465 |
| 4 | SiOxNy | 21.4 | 1.943 |
| 5 | SiO2 | 57.9 | 1.465 |
| 6 | SiOxNy | 35.5 | 1.943 |
| 7 | SiO2 | 38.3 | 1.465 |
| 8 | SiOxNy | 51 | 1.943 |
| 9 | SiO2 | 19.6 | 1.465 |
| 10 | SiOxNy | 62.6 | 1.943 |
| 11 | SiO2 | 6.4 | 1.465 |
| 12 | SiOxNy | 1000.0 | 1.943 |
| 13 | SiOxNy | 17.1 | 1.744 |
| 14 | SiNy | 27.9 | 2.043 |
| 15 | SiOxNy | 41.6 | 1.788 |
| 16 | SiNy | 13.0 | 2.043 |
| 17 | SiOxNy | 34.0 | 1.788 |
| 18 | SiNy | 8.8 | 2.043 |
| 19 | SiOxNy | 88.2 | 1.788 |
| 20 | SiNy | 8.9 | 2.043 |
| 21 | SiOxNy | 78.7 | 1.788 |
| 22 | SiNy | 24.1 | 2.043 |
| 23 | SiOxNy | 35.4 | 1.788 |
| 24 | SiNy | 24.6 | 2.043 |
| 25 | SiOxNy | 14.7 | 1.788 |
| 26 | SiNy | 51.3 | 2.043 |
| 27 | SiOxNy | 20.7 | 1.788 |
| 28 | SiNy | 52.0 | 2.043 |
| 29 | SiOxNy | 9.6 | 1.788 |
| 30 | SiNy | 10.4 | 2.043 |
| 31 | SiOxNy | 36.3 | 1.788 |
| 32 | SiNy | 27.8 | 2.043 |
| 33 | SiOxNy | 75.2 | 1.788 |
| 34 | SiNy | 12.2 | 2.043 |
| 35 | SiOxNy | 13.0 | 1.788 |
| 36 | SiNy | 10.9 | 2.043 |
| 37 | SiOxNy | 38.5 | 1.788 |
| 38 | SiNy | 13.5 | 2.043 |
| 39 | SiOxNy | 11.9 | 1.788 |
| 40 | SiNy | 49.9 | 2.043 |
| 41 | SiOxNy | 11.4 | 1.788 |
| 42 | SiNy | 78.9 | 2.043 |
| 43 | SiOxNy | 8.6 | 1.788 |
| 44 | SiNy | 9.4 | 2.043 |
| 45 | SiOxNy | 57.5 | 1.788 |
| 46 | SiNy | 13.6 | 2.043 |
| 47 | SiO2 | 118.1 | 1.465 |
| | Medium | Air | 1 |

Total thickness (nm): 2544.0
AR layers (outer structure) thickness (nm): 1147.6
Low-RI in AR thickness (nm): 118.1

### Summary of Comparative Examples 1-3 and Examples 1-14

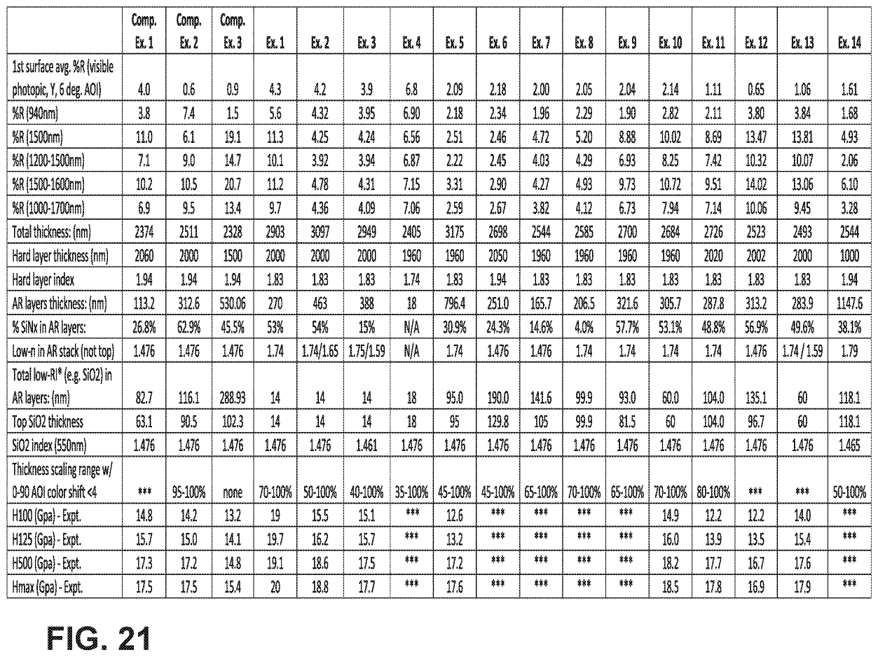

Referring now to FIG. 21, a table is provided that summarizes the optical and mechanical properties of the comparative and inventive examples of the disclosure (Comp. Exs. 1-3 and Exs. 1-14). In Table 21, various reflectance properties are provided, e.g., first-surface average reflectance (“1^{st} surface avg. % R (visible photopic, Y, 6 deg AOI)”, first-surface average reflectance in the near-IR spectrum from 1000 to 1700 nm (“% R (1000-1700 nm)”), and so on. The refractive index of the scratch-resistant layer of each of the designs is also provided, designated “Hard layer index”. Further, various dimensional attributes are provided for the outer structure of the optical film structure over the scratch-resistant layer, e.g., the total thickness (“AR layers thickness: (nm)”) of the outer structure, percentage of silicon of nitride (“% SiNₓ in AR layers:”) in the outer structure, the refractive index of the low RI layer(s) (“Low-n in AR stack (not top)”) in the outer structure, the total thickness of the low RI layers (“Total low-RI* (e.g. SiO₂) in AR layers: (nm)”) in the outer structure, and the thickness of the capping layer (“Top SiO₂ thickness”). With regard to color uniformity, the range of scaling factors associated with a color shift of less than 4 is also provided in the table (“Thickness scaling range w/0-90 AOI color shift <4”). Finally, various Berkovich hardness values are provided for particular indentation depths of 100 nm (“H100 (GPa)−Expt.”), 125 nm (“H125 (GPa)−Expt.”), and 500 nm (“H500 (GPa)−Expt.”), along with a maximum hardness value through the full indentation depth range (“Hmax(GPa)−Expt.”).

As is evident from FIG. 21, inventive examples of the disclosure (e.g., Exs. 1-3 and 10) exhibit high shallow hardness of about 15 GPa or greater at indentation depths from 100 to 125 nm and the comparative examples do not exhibit these levels of hardness at these shallow indentation depths. What is also evident from FIG. 21 is that the inventive examples (e.g., Exs. 1-3 and 10) also exhibit low reflectance levels in the visible (e.g., photopic reflectance), IR (e.g., at 940 nm) and near-IR (e.g., from 1000 to 1700 nm) spectra as compared to the comparative examples.

As is also evident from FIG. 21 and the foregoing passages, each of the transparent articles employs a glass-ceramic substrate. It is believed, however, that the mechanical and optical properties of the inventive examples, including high shallow hardness and low reflectance in the visible, IR and near-IR spectra, would also be exhibited by transparent articles with optical films structures consistent with the principles of the disclosure and as employing other types of substrates, including ceramic substrates, glass substrates, sapphire substrates, strengthened glass substrates, and strengthened glass-ceramic substrates. For example, shallow high hardness levels have been observed on transparent articles employing glass substrates that are comparable to the hardness levels of some of the foregoing inventive examples, including Exs. 1-3 and 10. Further, from an optics perspective, the inner structure (e.g., inner structure 130b) of the optical film structure (e.g., optical film structure 120) of these transparent articles can be configured with layer materials and thicknesses according to an impedance-matching criterion to accommodate the difference in refractive index of glass-ceramic substrates from the refractive indices of other, specified substrate types, e.g., ceramic substrates, glass substrates, sapphire substrates, strengthened glass substrates, and strengthened glass-ceramic substrates, to ensure comparable optical performance, including low reflectance in the visible, IR and near-IR spectra.

### Example 15

In this example, four transparent articles with optical film structures configured according to the glass-ceramic substrate and optical film structure of Table 18 (see below) were the subject of stress modeling. In particular, these articles were modeled to assess average ROR failure strength in view of the residual compressive stress and elastic modulus levels of their optical film structures. Further, these four articles employed the optical film structure of Table 18, as further configured with SiOₓN_{y} high RI layers such that the optical film structure exhibits elastic modulus levels of 140 GPa (Ex. 15C1), 150 GPa (Ex. 15C2), 160 GPa (Ex. 15C3) and 170 GPa (Ex. 15C4), respectively.

The following assumptions were made in conducting the modeling in this example. For the transparent articles of the disclosure with stiff and hard optical film structures and glass-ceramic substrates, the required applied strain to propagate pre-existing flaws in optical film structures is much lower than the required strain to propagate pre-existing flaws in the substrate itself, primarily because the brittle optical film structure is stiffer than the glass-ceramic substrate. Accordingly, the optical film structure was assumed to fail first, with a crack that then penetrated the substrate that lead to an eventual system catastrophic failure once the crack driving force exceeds the fracture resistance of the glass-ceramic substrate. Fracture mechanics-based numerical modeling (via finite element analysis) was then carried out in such a way that a series of cracks were inserted in the sample, and a strain level was determined when the crack tip stress intensity factor (K_{I}) equals the fracture toughness of the glass-ceramic substrate (K_{IC}) under an externally applied flexural load. The average retained strength was then calculated based on an assumed flaw distribution in the substrate of cracks that ranged from 0.1 to 2.5 μm in size.

TABLE 18
Ex. 15 transparent article designs with strengthened glass-ceramic
substrate

| | | | Thickness | Exemplary |
|---|---|---|---|---|
| | | Refractive | (nm, | elements of |
| | | index (@ | unless | transparent |
| Layer | Material | 550 nm) | noted) | article 100 |
| Medium | Air | 1.0 1 | N/A | N/A |
| 13 | SiO2 | 1.478 | 88.5 | 131 |
| 12 | SiONNy | 1.7-1.9 | 143.6 | 130B |
| 11 | SiO2 | 1.478 | 16.8 | 130A |
| 10 | SiOxNy | 1.7-1.9 | 40.9 | 130B |
| 9 | SiO2 | 1.478 | 10.6 | 130A |
| 8 | SiONNy | 1.7-1.9 | 2000 | 150 and/or |
| | | | | 130B |
| 7 | SiO2 | 1.478 | 8.7 | 130A |
| 6 | SiOxNy | 1.7-1.9 | 45.8 | 130B/130C |
| 5 | SiO2 | 1.478 | 29.7 | 130A |
| 4 | SiONNy | 1.7-1.9 | 28.1 | 130B/130C |
| 3 | SiO2 | 1.478 | 51.4 | 130A |
| 2 | SiOgNy | 1.7-1.9 | 12.2 | 130B/130C |
| 1 | SiO2 | 1.478 | 25 | 130A |
| Substrate | Ion-exchanged | 1.531 | 600 μm | 110 |
| | transparent glass- | | | |
| | ceramic | | | |

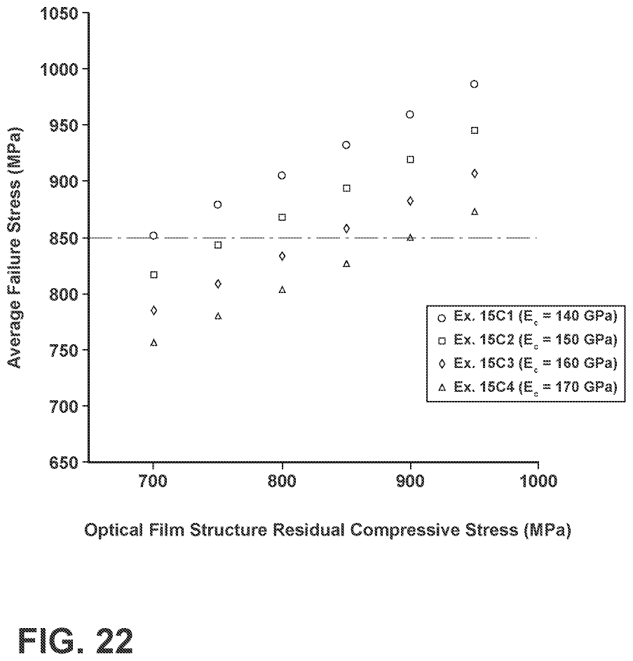

Referring now to FIG. 22, a chart is provided of average article failure stress (MPa), as measured in an ROR test, vs. optical film structure residual stress (MPa), as modeled for the transparent articles with optical film structures of this example having different elastic modulus values (Exs. 15C1-15C4). As is evident from the chart, maintaining an optical film structure residual stress of at least 700 MPa and controlling the optical film structure elastic modulus to 170 GPa or less can ensure that the optical film structure will exhibit a failure stress of at least 750 MPa. Further, raising the residual compressive stress in the optical film structure tends to improve the average failure stress to levels from 750 MPa to well above 850 MPa, provided that the elastic modulus of the optical film structure is maintained from about 140 GPa to about 170 GPa.

### Example 16

A transparent article including a strengthened glass-ceramic substrate was prepared for this example with the structure delineated below in Table 20. The glass-ceramic substrate is an ion-exchanged, LAS glass-ceramic substrate having a thickness of 600 μm and a refractive index of 1.533. Further, the glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

Referring again to the transparent article of this example (designated Ex. 16), the layers (e.g., layers 17-23 in Table 20) of the optical film structure above the scratch-resistant layer (e.g., layer 16 in Table 20) are configured to achieve high shallow hardness while not negatively affecting the optical properties of the article, including reflectance in the visible, IR, and near-IR spectra. As is evident from the optical film structure design of Table 20, medium index layers (SiOₓN_{y} layers 18, 20 and 22) are disposed adjacent to high index layers (SiN_{y} layers 17, 19 and 21), which drive shallow high hardness levels in the article. Similarly, as is evident in Table 20, the total thickness of the low refractive index layers (e.g., SiO₂ layer 23) in the outer structure of the optical film structure above the scratch-resistant layer is minimized to a level that is less than 25 nm, which also helps drive shallow high hardness levels in the article.

Some mechanical metrics for Ex. 16 include a measured nanoindentation hardness at 100 nm depth=19.0 GPa, hardness at 125 nm depth=19.4 GPa, hardness at 500 nm depth=17.0 GPa, and a maximum modulus of 190 GPa. Modulus at a depth equal to 15% of the optical film structure thickness (a depth of ~440 nm for Ex. 16) was equal to 130 GPa.

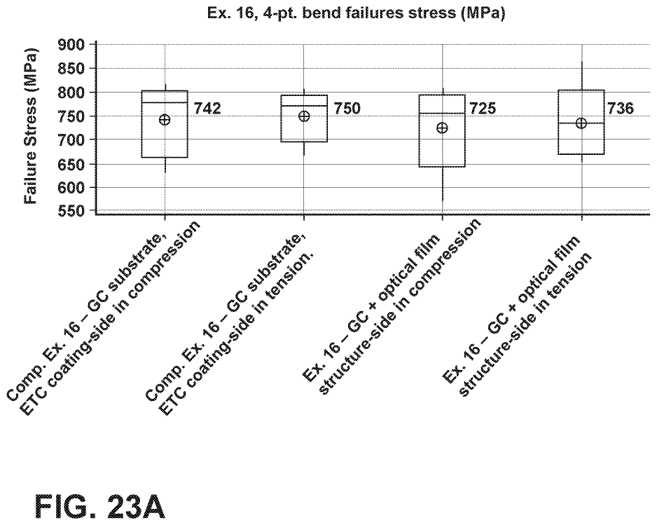

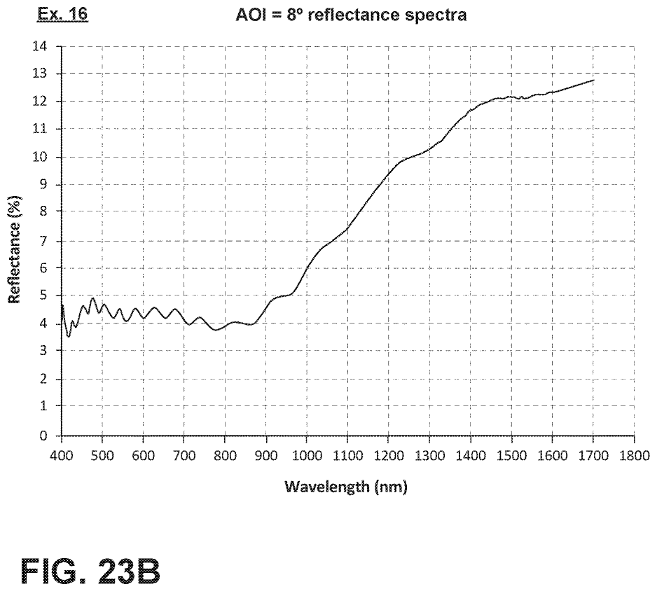

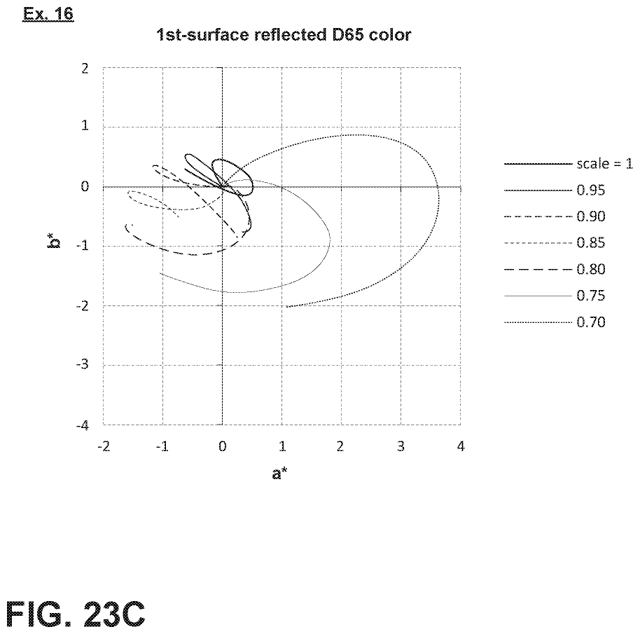

When fabricated with residual compressive stress in the optical film structure of 950-1000 MPa, the ring-on-ring strength average for Ex. 16 was tested to be 960 MPa. In addition, the 4-pt Bend Test Strength of this example was measured, and the average 4-pt Bend Test strength was measured to be greater than 700 MPa when the optical film structure was placed on the tensile surface or the compressive surface during this test. This 4-pt Bend Test data for Ex. 16 is shown in FIG. 23A comparing Ex. 16 with the optical film structure in compression and in tension (two right hand bars) to a control sample having only an easy-to-clean coating (designated Comp. Ex. 16), which has no impact on the mechanics of this test (two left bars represent control samples with ETC side in compression and in tension). There is no statistical difference between the controls and the Ex. 16 samples with an optical film structure, indicating full strength retention with the Ex. 16 optical film structure, due to its designed modulus and compressive stress in the film structure, as well as the combination with the optimized properties of the glass-ceramic substrate. This contrasts with a typical average 4-pt Bend Test strength of less than 400 MPa for a Comp. Ex. 3 optical film structure on a chemically strengthened glass substrate when the surface of the optical film structure is placed in tension (not shown in Figures).

TABLE 20
Ex. 16 transparent article design with strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25.0 | 1.476 |
| 2 | SiOxNy | 16.2 | 1.744 |
| 3 | SiO2 | 67.9 | 1.476 |
| 4 | SiOxNy | 25.3 | 1.744 |
| 5 | SiO2 | 70.9 | 1.476 |
| 6 | SiOxNy | 33.4 | 1.744 |
| 7 | SiO2 | 61.7 | 1.476 |
| 8 | SiOxNy | 44.1 | 1.744 |
| 9 | SiO2 | 47.4 | 1.476 |
| 10 | SiOxNy | 56.7 | 1.744 |
| 11 | SiO2 | 32.0 | 1.476 |
| 12 | SiOxNy | 68.9 | 1.744 |
| 13 | SiO2 | 18.3 | 1.476 |
| 14 | SiOxNy | 76.6 | 1.744 |
| 15 | SiO2 | 8.0 | 1.476 |
| 16 | SiOxNy | 2000.0 | 1.744 |
| 17 | SINx | 15.3 | 2.058 |
| 18 | SiOxNy | 37.7 | 1.744 |
| 19 | SINx | 57.3 | 2.058 |
| 20 | SiOxNy | 8.0 | 1.744 |
| 21 | SINx | 66.2 | 2.058 |
| 22 | SiOxNy | 76.2 | 1.744 |
| 23 | SiO2 | 14.0 | 1.476 |
| | Medium | Air | 1 |

Total thickness: 2926.8
AR layers (outer structure) thickness (nm): 274.6
Low-RI in AR thickness (nm): 14

Key optical metrics for Ex. 16 include 1^{st} surface photopic average reflectance=4.38% at 0-10 degrees angle of incidence, % R (940 nm)=4.98%, and % Ravg (1000-1700 nm)=10.4%.

Referring to FIG. 23B, a plot is provided of first-surface reflectance vs. wavelength for this inventive example, as modeled at a near-normal incident angle of 8°. Notably, Ex. 16 exhibits low maximum and minimum reflectance oscillations in the 1000 to 1700 nm wavelength band of less than 7%. It is also evident from FIG. 23B that this example exhibits a maximum reflectance of less than 13% in the near-infrared spectrum from 1000 to 1700 nm.

Referring to FIG. 23C, a plot is provided of single-sided, reflected color for this inventive example, as measured at incident angles from 0° to 90° with various optical film structure thickness scaling factors. As is evident from FIG. 23C, the color shift exhibited by this inventive example is fairly consistent and less than 4 for a wide range of optical film structure thickness scaling factors from about 70 to 100%.

### Berkovich Hardness Test Modeling Example

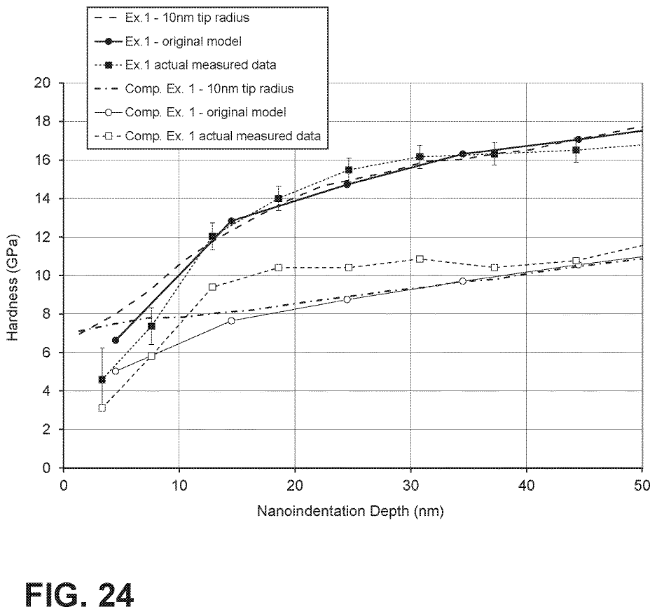

In this example, modeled hardness values of Ex. 1 and Comp. Ex. 1 are compared as a function of indentation depth to evaluate the hardness response of articles of this disclosure in the Berkovich Hardness Test. Typically, concerns exist about experimental errors related to diamond nanoindenter tip sharpness variations, which can add uncertainty to measured hardness values at indentation depths below about 100 nm. In this example, detailed modeling analyses were conducted to evaluate the effect of indenter tip radius and finite element mesh size parameters. These as-modeled results were then compared to experimental, measured data (see FIG. 24, described below). The model was validated by a comparison to bulk high purity fused silica, which has a known hardness value at all depths. This analysis, as well as the agreement between modeling and the experiments shown below (see FIG. 24), gives us a rigorous basis on which to establish the hardness values at indentation depths of 20 nm and 40 nm as a point of differentiation for the articles of the disclosure that exhibit high shallow hardness with relatively thin optical film structures (e.g., Exs. 17-27 above). Indenter tip radius can still vary experimentally, but these new analyses give us confidence that through modeling we can define article and optical film structure hardness at depths as shallow as 20 nm, and that these hardness values can also be measured experimentally under the right test conditions with high quality diamond indenter tips.

Referring now to FIG. 24, a plot is provided of hardness (GPa) vs. indentation depth (from 0 to 50 nm), as measured in a Berkovich Hardness Test for the optical film structures of a transparent article of the disclosure (Ex. 1) and a comparative article (Comp. Ex. 1). Further, as shown in FIG. 24, as-modeled, finite element (FEA) hardness and experimental hardness is evaluated for these articles (Ex. 1 and Comp. Ex. 1), including variation of indenter tip radius in the FEA model. FEA modeling of hardness was done with a commonly used commercial finite element software, Abaqus v2019. An axisymmetric model was used to reduce the computational time and a conical indenter tip with a semi-angle of 70.3° was assumed, which generates the same contact area-to-depth ratio as the Berkovich tip. The model includes characteristics of individual layers in the optical film structure and the substrate. The material was assumed to behave in an elastic-perfectly plastic manner, assuming a von Mises yield criterion. Material properties chosen for each individual layer were calibrated to known hardness and modulus curves measured for single layer optical film structures. The outputs of the FEA modeling are load-displacement curves which were then utilized to calculate hardness vs. depth curves, as shown in FIG. 24. To extract hardness as a function of nanoindentation depth, continuous stiffness measurement (CSM) nanoindentation must be simulated. To this end, the nanoindenter tip was given a small amplitude of vibration during the loading stage. For our simulation, displacement history of the tip was prescribed by a user-defined “Amplitude” curve in ABAQUS to impose a very small (~1 nm or less) harmonic unloading. The maximum time increment was limited in such a way that history output can have a high sampling rate to capture all these 1 nm “unloading” portions during the overall loading stage. The hardness responses were then calculated using the Oliver-Pharr method, as understood by those skilled in the field of this disclosure.

Referring again to FIG. 24, the original model was built to get the hardness response over a wider range of indentation (typically in the range of 500 nm to 1000 nm), and while great correlation with experiments was found over these depth ranges, an improved model was needed to capture hardness at shallow depths. Following a rigorous investigation of FEA mesh quality, the model was improved such that the FEA mesh elements near the surface are only a few nanometers in size, small enough to capture stress fields under the indenter very early in the indentation process. Another change made was to model the indentation over a depth range of only 150 nm instead of a range from 500 to 1000 nm while keeping the same number of sampling points to extract hardness values as a function of depth, such that the sampling rate was now higher. This enabled capturing the hardness response at shallow depths such as 20 nm and 40 nm more accurately, thus giving further confidence to the experimentally measured data for these examples, and others in this disclosure.

### Comparative Example 4

A comparative transparent article including a strengthened glass substrate was prepared for this example with the structure delineated below in Table 21. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. Further, the layers of the optical film structure were deposited according to vapor deposition conditions set forth in U.S. Patent Application Publication No. 2020/0158916, the salient portions of which are incorporated herein by reference.

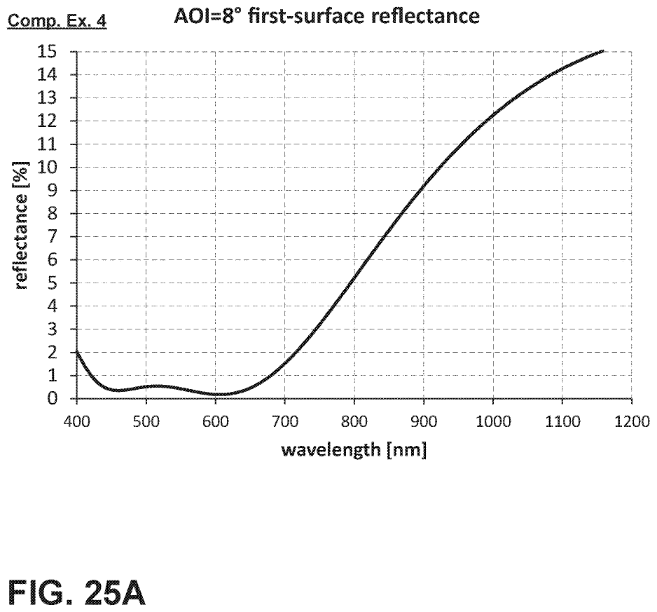

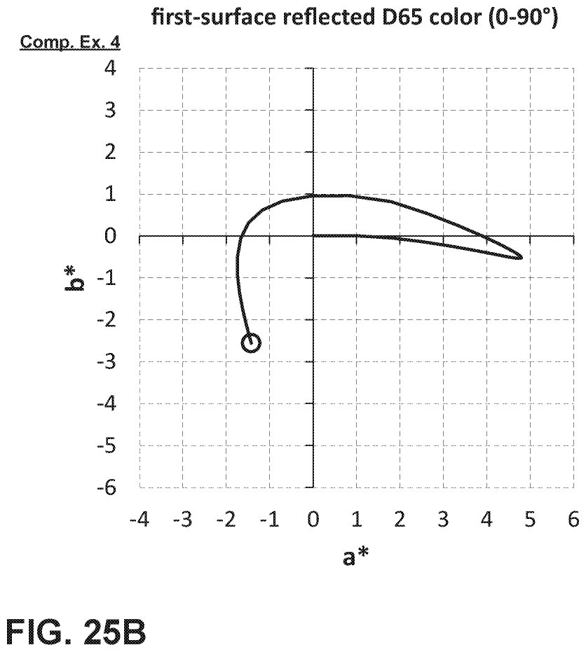

Referring to FIG. 25A, a plot is provided of first-surface reflectance vs. wavelength for this comparative example, as measured at a near-normal incident angle of 8°. Notably, this comparative example exhibits increased reflectance of 3.5% or greater at wavelengths of 750 nm and greater.

Referring to FIG. 25B, a plot is provided of single-sided, reflected color for this comparative example, as measured at incident angles from 0° to 90°.

TABLE 21
Comp. Ex. 4 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.478 |
| 2 | SiNx | 16.5 | 2.067 |
| 3 | SiO2 | 24.7 | 1.478 |
| 4 | SiNx | 104.6 | 2.067 |
| 5 | SiO2 | 82 | 1.478 |
| | Medium | Air | 1 |

Total thickness: 252.8
AR layers (outer structure) thickness (nm): 82
Low-RI in AR thickness (nm): 82

### Examples 17-20

In these examples, transparent articles including a strengthened glass substrate were prepared with the optical film structures delineated below in Tables 22-25 (e.g., as exemplified by the transparent articles of FIG. 1E, described above). In this example, the substrate used was Gorilla® Glass 3 (commercially available from Corning, Inc.). Examples of Gorilla® Glass 3 compositions are described in U.S. Pat. Nos. 7,666,511, 4,483,700, and 5,674,790, the salient contents of which are hereby incorporated by reference in this disclosure. The layers of the optical film structure were deposited according to vapor deposition conditions set forth in U.S. Patent Application Publication No. 2020/0158916, the salient portions of which are incorporated herein by reference.

Notably, each of these examples (Exs. 17-20) employs a relatively thick scratch resistant layer comprising high RI material (SiNₓ) having a thickness >120 nm, >150 nm, or >200 nm. Further, each of the optical film structures of these examples employs layers having four distinct refractive indices, SiNₓ (n=2.057), SiOₓN_{y} (n=1.744), SiOₓN_{y} (n=1.589), and SiO₂ (n=1.476), which allows for minimizing the amount of low RI material (SiO₂) and minimizing the thickness of the outermost capping layer comprising SiO₂. In combination, the foregoing optical film structure designs and design strategies advantageously boost hardness, while maintaining low average photopic reflectance and a minimized overall thickness of the optical film structure.

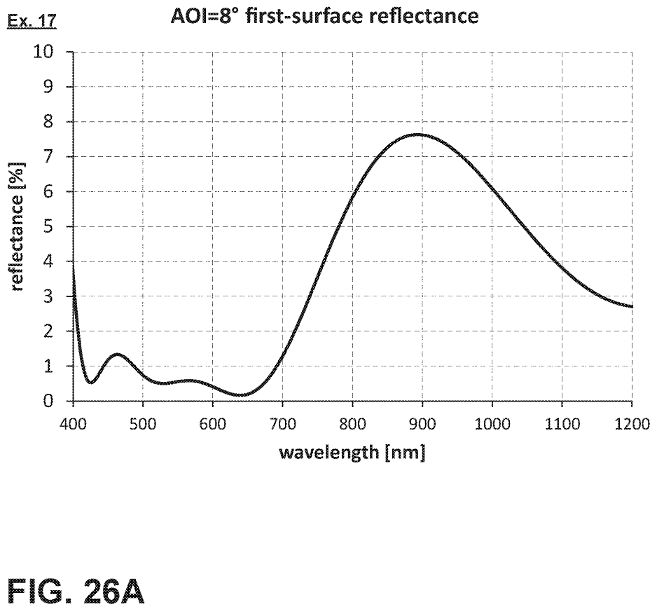

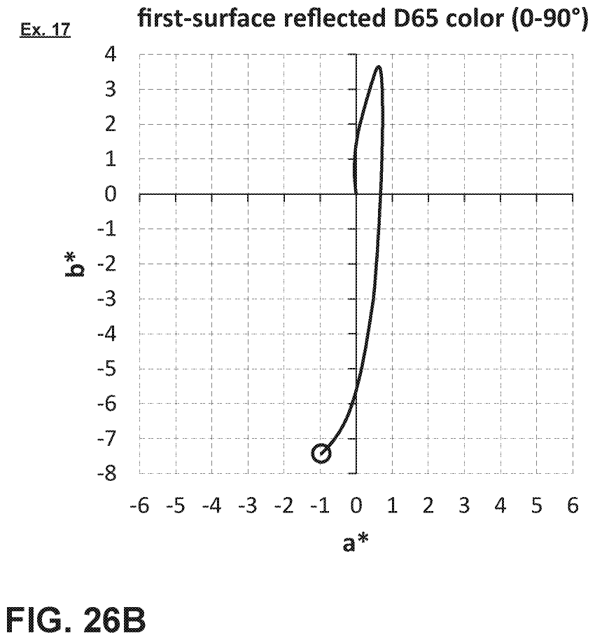

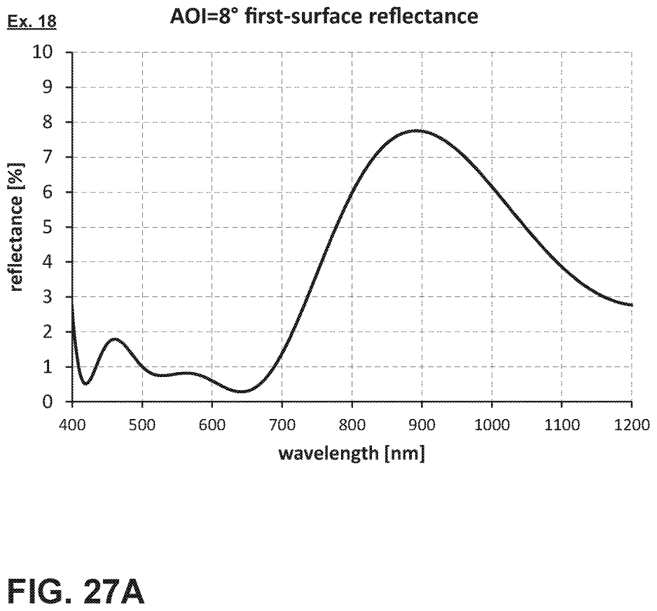

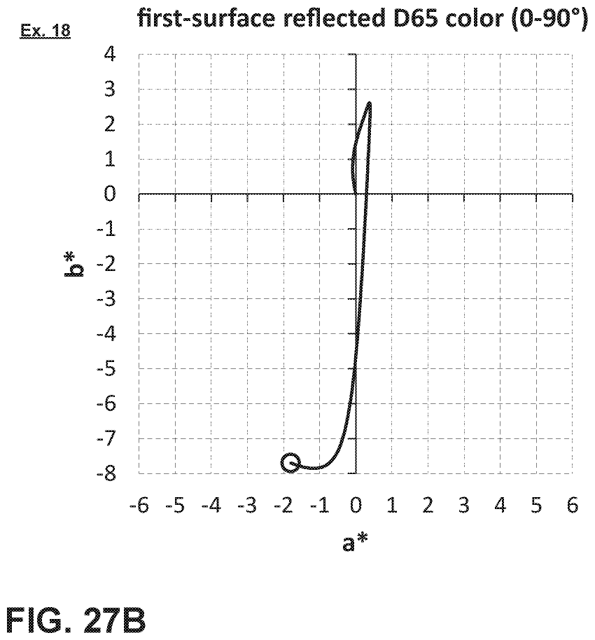

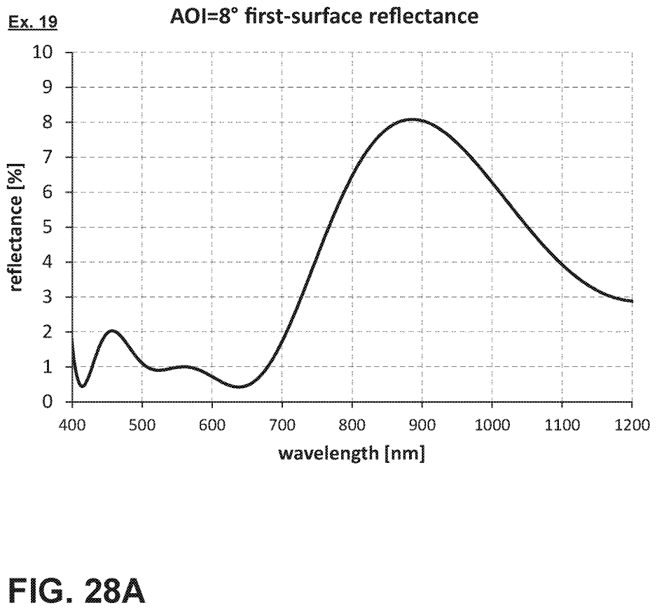

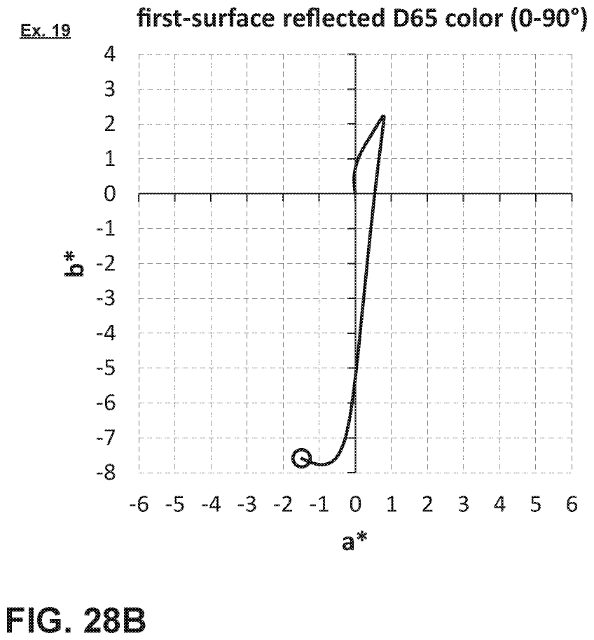

Referring now to FIGS. 26A, 27A, 28A, and 29A, plots are provided of first-surface reflectance vs. wavelength, as measured at a near-normal incident angle of 8°, for the articles of this example (Exs. 17-20), respectively. As is evident from these figures, each of these examples exhibits an average photopic first-surface reflectance of less than or equal to 1.5%. Also, as evident from these figures, each of these examples exhibits an average first-surface reflectance from 920 to 960 nm of less than 8%. Also, referring to FIGS. 26B, 27B, 28B, and 29B, plots are provided of single-sided, reflected color, as measured at incident angles from 0° to 90°, for the transparent articles of this example (Exs. 17-20).

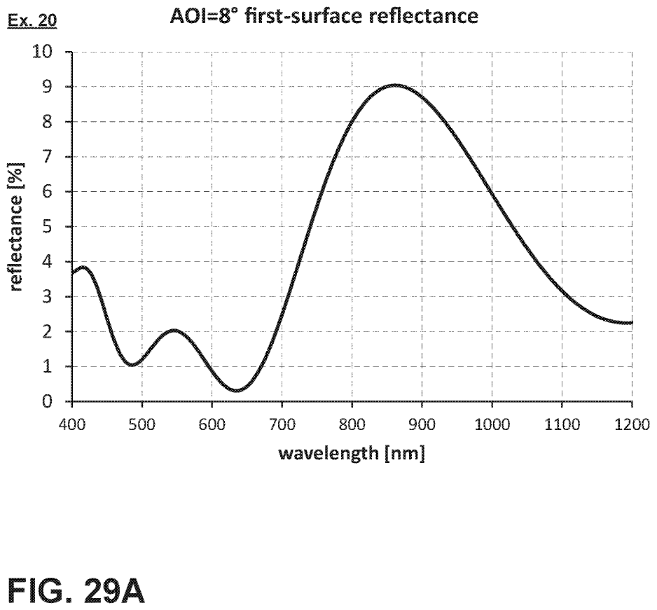

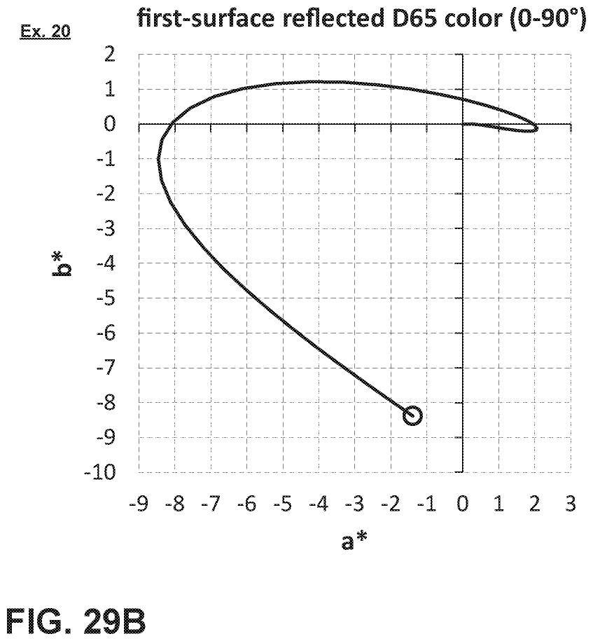

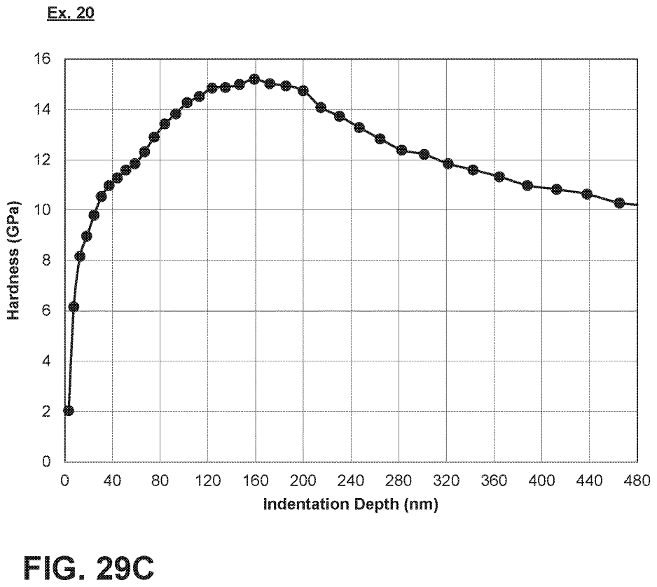

In addition, referring now to FIG. 29C, a plot is provided of hardness (GPa) vs. indentation depth, as measured in a Berkovich Hardness Test of the optical film structure of one of the transparent articles of this example (Ex. 20). As is evident from this figure, the maximum hardness of this example is 14.5 GPa and the hardness certain indentation depths is as follows: 9.7 GPa (20 nm), 11.0 GPa (40 nm), 13.9 GPa (100 nm), and 14.2 nm (125 nm).

TABLE 22
Ex. 17 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 81.1 | 1.744 |
| 3 | SiNx | 65.7 | 2.057 |
| 4 | SiOxNy | 8.0 | 1.744 |
| 5 | SiNx | 158.9 | 2.057 |
| 6 | SiOxNy | 31.84 | 1.589 |
| 7 | SiO2 | 65 | 1.476 |
| | Medium | Air | 1 |

Total thickness: 435.5
AR layers (outer structure) thickness (nm): 96.84
Low-RI in AR thickness (nm): 65

TABLE 23
Ex. 18 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 81.7 | 1.744 |
| 3 | SiNx | 65.1 | 2.057 |
| 4 | SiOxNy | 8.0 | 1.744 |
| 5 | SiNx | 157.4 | 2.057 |
| 6 | SiOxNy | 46.2 | 1.589 |
| 7 | SiO2 | 50 | 1.476 |
| | Medium | Air | 1 |

Total thickness: 433.4
AR layers thickness (nm): 96.2
Low-RI in AR thickness (nm): 50

TABLE 24
Ex. 19 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 81.6 | 1.744 |
| 3 | SiNx | 65.2 | 2.057 |
| 4 | SiOxNy | 8.0 | 1.744 |
| 5 | SiNx | 156.2 | 2.057 |
| 6 | SiOxNy | 53.2 | 1.589 |
| 7 | SiO2 | 40 | 1.476 |
| | Medium | Air | 1 |

Total thickness: 429.2
AR layers (outer structure) thickness (nm): 93.2
Low-RI in AR thickness (nm): 40

TABLE 25
Ex. 20 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 57.4 | 1.744 |
| 3 | SiNx | 8.0 | 2.057 |
| 4 | SiOxNy | 8.0 | 1.744 |
| 5 | SiNx | 222.9 | 2.057 |
| 6 | SiOxNy | 74.5 | 1.589 |
| 7 | SiO2 | 15 | 1.476 |
| | Medium | Air | 1 |

Total thickness: 410.8
AR layers (outer structure) thickness (nm): 99.5
Low-RI in AR thickness (nm): 15

### Examples 21 & 22

In these examples, transparent articles including a strengthened glass substrate were prepared with the optical film structures delineated below in Tables 26 and 27 (e.g., as exemplified by the transparent articles of FIG. 1F, described above). In this example, the substrate used was Gorilla® Glass 3 (commercially available from Corning, Inc.). Examples of Gorilla® Glass 3 compositions are described in U.S. Pat. Nos. 7,666,511, 4,483,700, and 5,674,790, the salient contents of which are hereby incorporated by reference in this disclosure. The layers of the optical film structure were deposited according to vapor deposition conditions set forth in U.S. Patent Application Publication No. 2020/0158916, the salient portions of which are incorporated herein by reference.

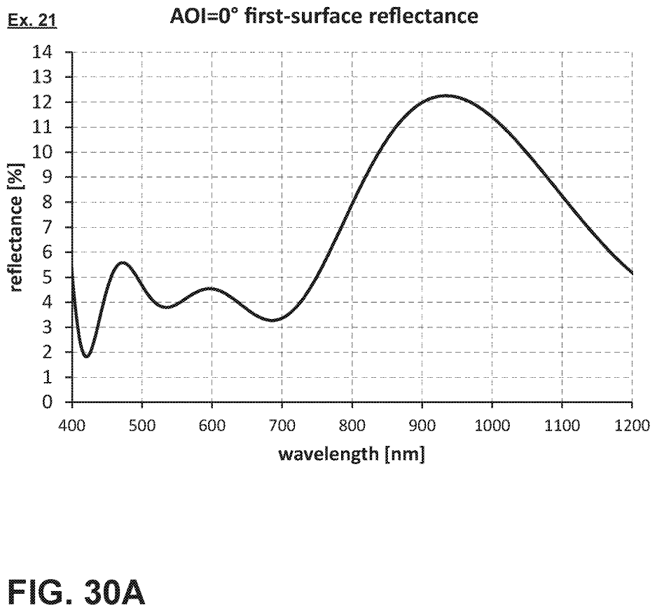

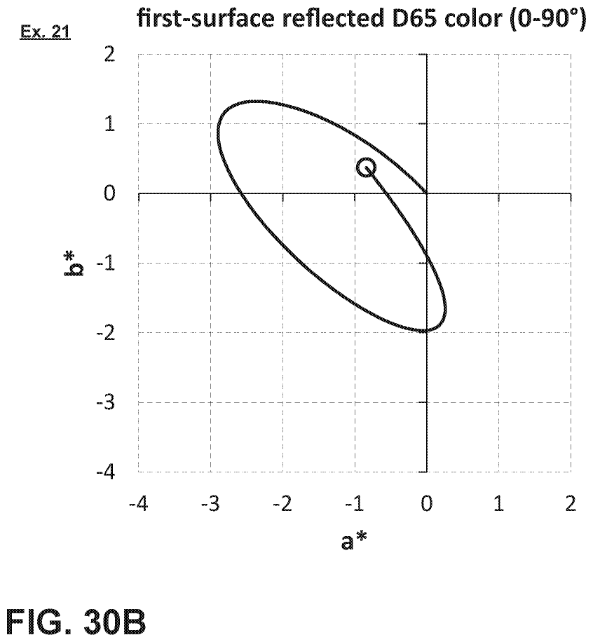

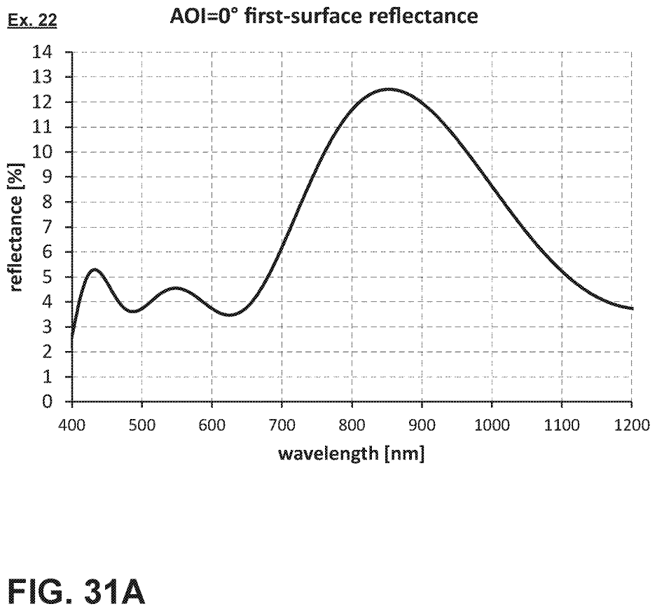

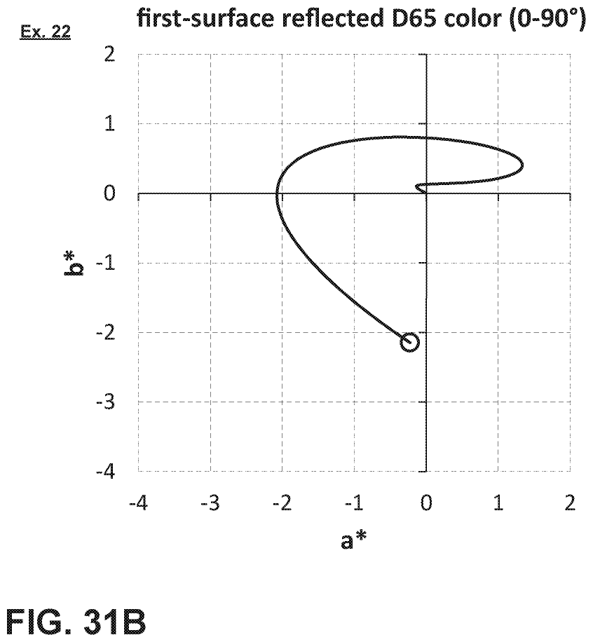

Notably, each of these examples (Exs. 21 and 22) employs a relatively thick scratch resistant layer comprising high RI material (SiNₓ) having a thickness >200 nm, or >200 nm. Further, each of the optical film structures of these examples employs layers having three distinct refractive indices, SiNₓ (n=2.057), SiOₓN_{y} (n=1.744), and SiO₂ (n=1.476), which allows for minimizing the amount of low RI material (SiO₂) and minimizing the thickness of the outermost capping layer comprising SiO₂. In combination, the foregoing optical film structure designs and design strategies advantageously boost hardness, while maintaining low average photopic reflectance and a minimized overall thickness of the optical film structure. Referring now to FIGS. 30A and 31A, plots are provided of first-surface

reflectance vs. wavelength, as measured at a near-normal incident angle of 8°, for the articles of this example (Exs. 21 and 22), respectively. As is evident from these figures, each of these examples exhibits an average photopic first-surface reflectance of less than or equal to 4.5%. Also, as evident from these figures, each of these examples exhibits an average first-surface reflectance from 920 to 960 nm of less than 12.5%. Also, referring now to FIGS. 30B, and 31B, plots are provided of single-sided, reflected color, as measured at incident angles from 0° to 90°, for the transparent articles of this example (Exs. 21 and 22).

TABLE 26
Ex. 21 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 81.8 | 1.744 |
| 3 | SiNx | 252.1 | 2.057 |
| 4 | SiOxNy | 69.6 | 1.744 |
| 5 | SiO2 | 4 | 1.476 |
| | Medium | Air | 1 |

Total thickness: 432.5
AR layers (outer structure) thickness (nm): 73.6
Low-RI in AR thickness (nm): 4

TABLE 27
Ex. 22 transparent article design with strengthened glass substrate

| | | thickness | Index |
|---|---|---|---|
| Layer | Material | (nm) | (550 nm) |
| | Glass | Substrate | 1.51 |
| 1 | SiO2 | 25 | 1.476 |
| 2 | SiOxNy | 75.5 | 1.744 |
| 3 | SiNx | 231.8 | 2.057 |
| 4 | SiOxNy | 54.7 | 1.744 |
| 5 | SiO2 | 14 | 1.476 |
| | Medium | Air | 1 |

Total thickness: 401.0
AR layers (outer structure) thickness (nm): 68.7
Low-RI in AR thickness (nm): 14

### Examples 23-27

In these examples, transparent articles including a strengthened glass-ceramic substrate were prepared with the optical film structures delineated below in Tables 28-32 (Exs. 23-27) (e.g., as exemplified by the transparent articles of FIG. 1G, described above). The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

Notably, each of these examples (Exs. 23-27) employs a relatively thick scratch resistant layer comprising medium RI material (SiOₓN_{y}) having a thickness >1500 nm. In addition, each of the optical film structures of these examples employs (a) a relatively thick high RI layer (SiNₓ) in the outer structure (e.g., Layer Nos. 12, 12, 14, 21, and 19 for Exs. 23-27, respectively) having a thickness of >60 nm, or >120 nm, near its outer surface, along with (b) a relatively thick scratch resistant layer comprising medium RI material (SiOₓN_{y}) (e.g., Layer Nos. 8, 8, 8, 16, and 16 for Exs. 23-27, respectively) that can be varied in thickness from 0.2 to 5 μm, which collectively aid in boosting hardness of the article while maintaining low average photopic reflectance. For example, an optical film structure design similar to the design in Table 28 below (Ex. 23) with the scratch resistant layer having a thickness of 500 nm (Layer 8) would exhibit similar optical properties, but in a much thinner overall package with the optical film structure having a thickness of about 1209 nm. As another example, an optical film structure design similar to the design in Table 31 (Ex. 26) with the scratch resistant layer having a thickness of 500 nm (Layer 16) would exhibit similar optical properties, but in a much thinner overall package with the optical film structure having a thickness of about 1423 nm.

In addition, the use of medium RI material in the scratch resistant layer (i.e., the thickest layer in the optical film structure) of these examples (Exs. 23-27) can advantageously serve to improve retained flexural strength of the transparent article while also reducing optical absorption, thus enabling the use of an even thicker scratch resistant layer without an unacceptable reduction in optical transmission due to absorption. Further, each of the optical film structures of these examples employs layers having four distinct refractive indices, SiNₓ (n=2.057), SiOₓN_{y} (n=1.744), SiOₓN_{y} (n=1.589, 1.733, or 1.707), and SiO₂ (n=1.476), which allows for minimizing the amount of low RI material (SiO₂) and minimizing the thickness of the outermost capping layer comprising SiO₂. In combination, the foregoing optical film structure designs and design strategies advantageously boost hardness, while maintaining low average photopic reflectance and a minimized overall thickness of the optical film structure.

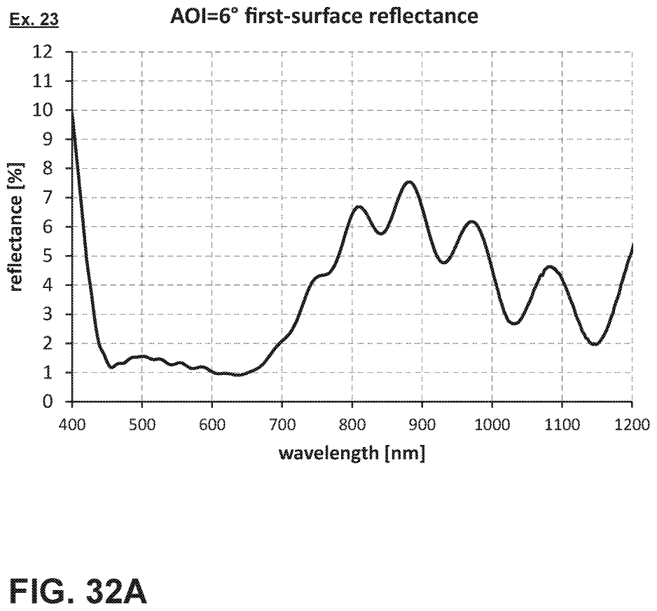

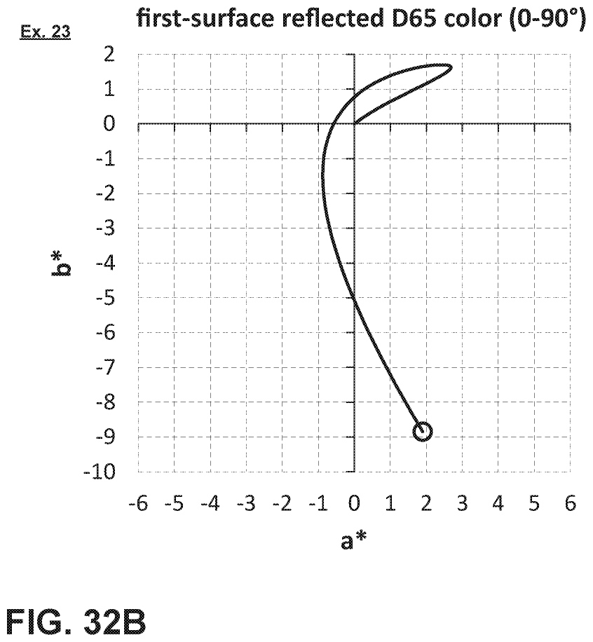

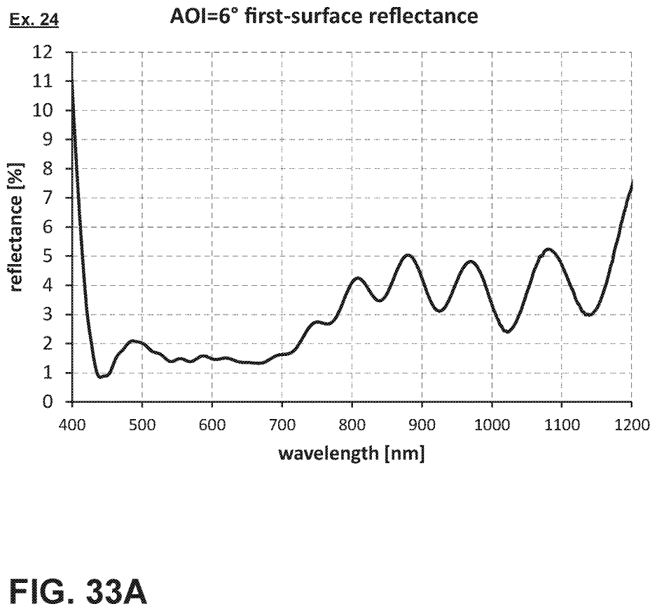

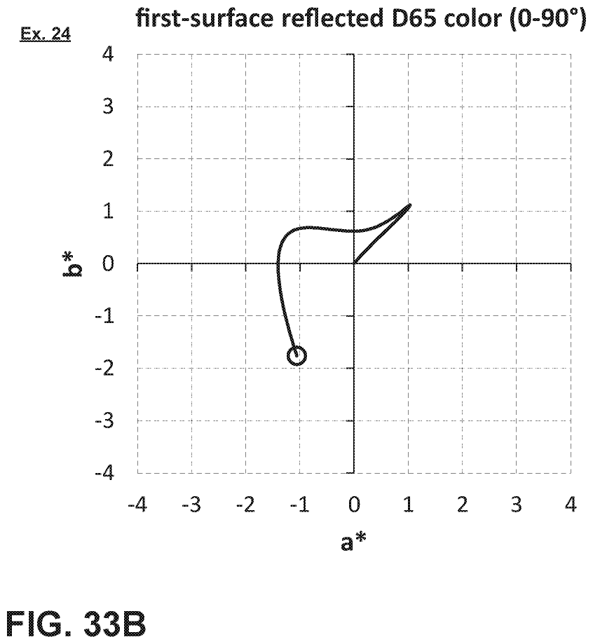

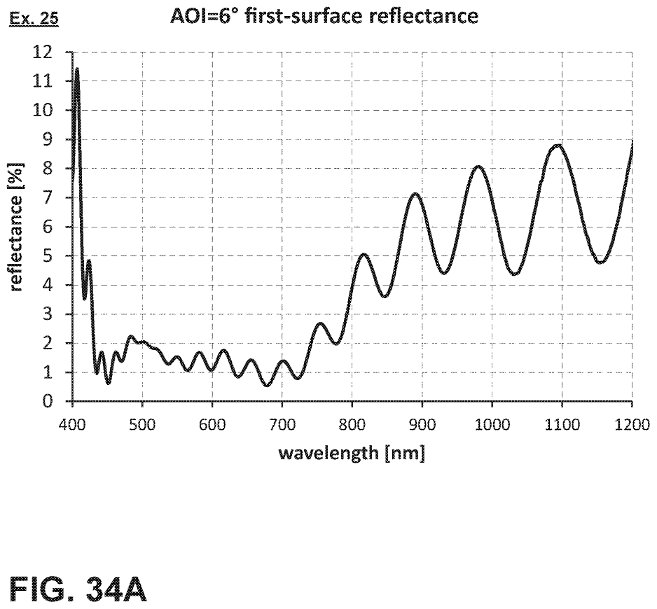

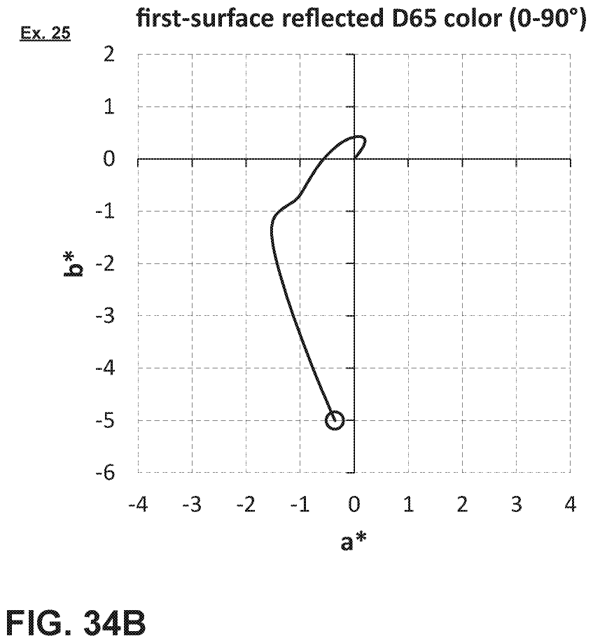

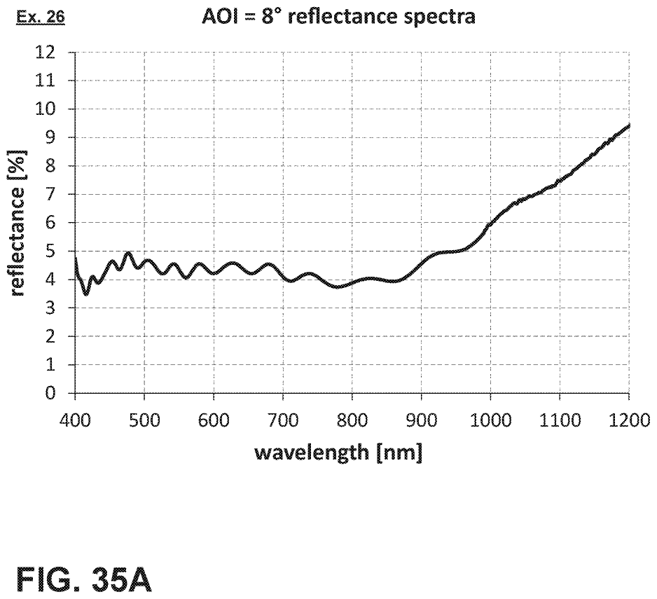

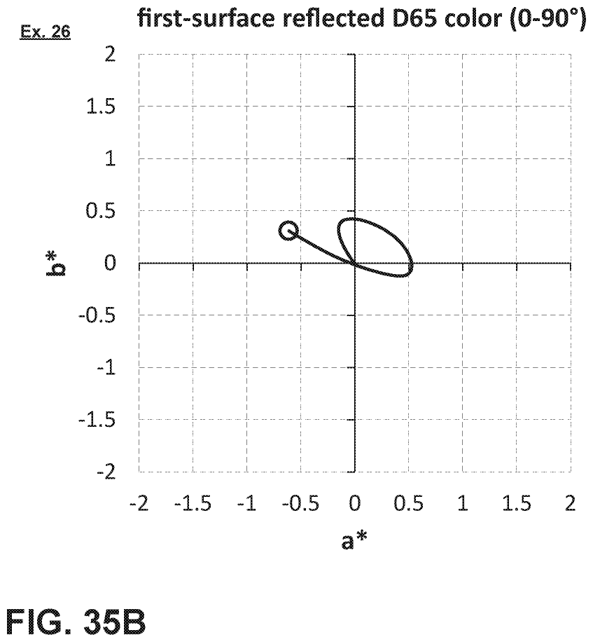

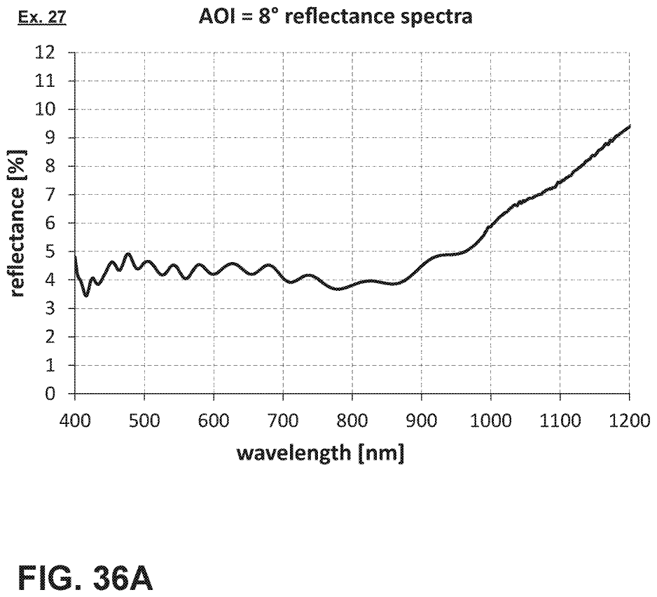

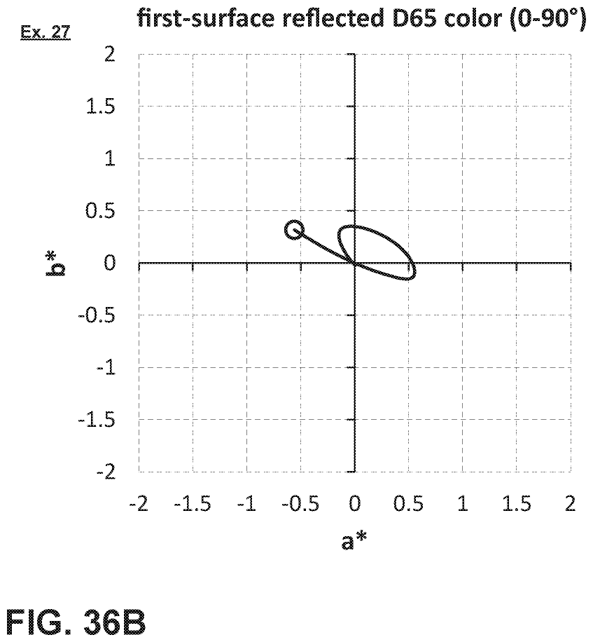

Referring now to FIGS. 32A-36A, plots are provided of first-surface reflectance vs. wavelength, as measured at a near-normal incident angle of 8°, for the articles of this example (Exs. 23-27), respectively. As is evident from these figures, each of these examples exhibits an average photopic first-surface reflectance of less than or equal to 4.5% (Exs. 23-27) or less than 1.6% (Exs. 23-25). Also, as evident from these figures, each of these examples exhibits an average first-surface reflectance from 920 to 960 nm of less than 5.5%. Also, referring to FIGS. 32B-36B, plots are provided of single-sided, reflected color, as measured at incident angles from 0° to 90°, for the transparent articles of this example (Exs. 23-27).

TABLE 28
Ex. 23 transparent article design with strengthened glass-ceramic substrate

| | | thickness | Index |
|---|---|---|---|
| Layer | Material | (nm) | (550 nm) |
| | Glass-ceramic | Substrate | 1.533 |
| 1 | SiO2 | 25 | 1.476 |
| 2 | SiOxNy | 14.0 | 1.829 |
| 3 | SiO2 | 51.2 | 1.476 |
| 4 | SiOxNy | 30.7 | 1.829 |
| 5 | SiO2 | 30.1 | 1.476 |
| 6 | SiOxNy | 49.2 | 1.829 |
| 7 | SiO2 | 8.9 | 1.476 |
| 8 | SiOxNy | 2000 | 1.829 |
| 9 | SiOxNy | 163.2 | 1.744 |
| 10 | SiNx | 33.5 | 2.058 |
| 11 | SiOxNy | 14.9 | 1.744 |
| 12 | SiNx | 198.0 | 2.058 |
| 13 | SiOxNy | 76.5 | 1.589 |
| 14 | SiO2 | 14 | 1.476 |
| | Medium | Air | 1 |

Total thickness: 2709.0
AR layers thickness (nm): 500.0
Low-RI in AR thickness (nm): 14

TABLE 29
Ex. 24 transparent article design with strengthened glass-ceramic substrate

| | | thickness | Index |
|---|---|---|---|
| Layer | Material | (nm) | (550 nm) |
| | Glass-ceramic | Substrate | 1.533 |
| 1 | SiO2 | 25 | 1.476 |
| 2 | SiOxNy | 14.0 | 1.829 |
| 3 | SiO2 | 51.2 | 1.476 |
| 4 | SiOxNy | 30.7 | 1.829 |
| 5 | SiO2 | 30.1 | 1.476 |
| 6 | SiOxNy | 49.2 | 1.829 |
| 7 | SiO2 | 8.9 | 1.476 |
| 8 | SiOxNy | 2000 | 1.829 |
| 9 | SiOxNy | 186.9 | 1.744 |
| 10 | SiNx | 28.3 | 2.058 |
| 11 | SiOxNy | 30.6 | 1.744 |
| 12 | SiNx | 164.2 | 2.058 |
| 13 | SiOxNy | 79.0 | 1.589 |
| 14 | SiO2 | 14 | 1.476 |
| | Medium | Air | 1 |

Total thickness: 2711.9
AR layers thickness (nm): 502.9
Low-RI in AR thickness (nm): 14

TABLE 30
Ex. 25 transparent article design with strengthened glass-ceramic substrate

| | | thickness | Index |
|---|---|---|---|
| Layer | Material | (nm) | (550 nm) |
| | Glass-ceramic | Substrate | 1.533 |
| 1 | SiO2 | 25 | 1.476 |
| 2 | SiOxNy | 9.2 | 1.829 |
| 3 | SiO2 | 54.9 | 1.476 |
| 4 | SiOxNy | 30.1 | 1.829 |
| 5 | SiO2 | 32.9 | 1.476 |
| 6 | SiOxNy | 61.7 | 1.829 |
| 7 | SiO2 | 8.7 | 1.476 |
| 8 | SiOxNy | 2000 | 1.829 |
| 9 | SiOxNy | 203.9 | 1.744 |
| 10 | SiNx | 14.5 | 2.058 |
| 11 | SiOxNy | 63.2 | 1.744 |
| 12 | SiNx | 30.9 | 2.058 |
| 13 | SiOxNy | 17.5 | 1.744 |
| 14 | SiNx | 102.0 | 2.058 |
| 15 | SiOxNy | 77.2 | 1.589 |
| 16 | SiO2 | 14 | 1.476 |
| | Medium | Air | 1 |

Total thickness: 2745.5
AR layers thickness (nm): 523.1
Low-RI in AR thickness (nm): 14

TABLE 31
Ex. 26 transparent article design with strengthened glass-ceramic substrate

| | | thickness | Index |
|---|---|---|---|
| Layer | Material | (nm) | (550 nm) |
| | Glass-ceramic | Substrate | 1.533 |
| 1 | SiO2 | 25 | 1.476 |
| 2 | SiOxNy | 16.2 | 1.744 |
| 3 | SiO2 | 67.9 | 1.476 |
| 4 | SiOxNy | 25.3 | 1.744 |
| 5 | SiO2 | 70.9 | 1.476 |
| 6 | SiOxNy | 33.4 | 1.744 |
| 7 | SiO2 | 61.7 | 1.476 |
| 8 | SiOxNy | 44 | 1.744 |
| 9 | SiO2 | 47.4 | 1.476 |
| 10 | SiOxNy | 56.7 | 1.744 |
| 11 | SiO2 | 32.0 | 1.476 |
| 12 | SiOxNy | 68.9 | 1.744 |
| 13 | SiO2 | 18.3 | 1.476 |
| 14 | SiOxNy | 76.6 | 1.744 |
| 15 | SiO2 | 8.0 | 1.476 |
| 16 | SiOxNy | 2000 | 1.744 |
| 17 | SiNx | 15.5 | 2.058 |
| 18 | SiOxNy | 37.4 | 1.744 |
| 19 | SiNx | 59.3 | 2.058 |
| 20 | SiOxNy | 8.0 | 1.744 |
| 21 | SiNx | 65.0 | 2.058 |
| 22 | SiOxNy | 81.6 | 1.733 |
| 23 | SiO2 | 4 | 1.476 |
| | Medium | Air | 1 |

Total thickness: 2923.0
AR layers thickness (nm): 270.8
Low-RI in AR thickness (nm): 4

TABLE 32
Ex. 27 transparent article design with strengthened glass-ceramic substrate

| | | thickness | Index |
|---|---|---|---|
| Layer | Material | (nm) | (550 nm) |
| | Glass-ceramic | Substrate | 1.533 |
| 1 | SiO2 | 25 | 1.476 |
| 2 | SiOxNy | 16.2 | 1.744 |
| 3 | SiO2 | 67.9 | 1.476 |
| 4 | SiOxNy | 25.3 | 1.744 |
| 5 | SiO2 | 70.9 | 1.476 |
| 6 | SiOxNy | 33.4 | 1.744 |
| 7 | SiO2 | 61.7 | 1.476 |
| 8 | SiOxNy | 44 | 1.744 |
| 9 | SiO2 | 47.4 | 1.476 |
| 10 | SiOxNy | 56.7 | 1.744 |
| 11 | SiO2 | 32.0 | 1.476 |
| 12 | SiOxNy | 68.9 | 1.744 |
| 13 | SiO2 | 18.3 | 1.476 |
| 14 | SiOxNy | 76.6 | 1.744 |
| 15 | SiO2 | 8.0 | 1.476 |
| 16 | SiOxNy | 2000 | 1.744 |
| 17 | SiNx | 16.0 | 2.058 |
| 18 | SiOxNy | 36.6 | 1.744 |
| 19 | SiNx | 63.8 | 2.058 |
| 20 | SiOxNy | 8.0 | 1.744 |
| 21 | SiNx | 62.4 | 2.058 |
| 22 | SiOxNy | 68.0 | 1.707 |
| 23 | SiNx | 8 | 2.058 |
| 24 | SiO2 | 4 | 1.476 |
| | Medium | Air | 1 |

Total thickness: 2918.9
AR layers thickness (nm): 266.6
Low-RI in AR thickness (nm): 4

Mechanical and Optical Property Summary of Comp. Exs. 1, 4 & Exs. 1, 17-27

In the foregoing examples, transparent articles and optical structure designs are detailed that exhibit high shallow hardness while retaining desirable optical properties (e.g., low average photopic reflectance) (i.e., Exs. 17-27). As noted earlier, strategies for boosting the near-surface hardness while controlling the optical properties of these transparent articles include reducing the amount of low index material with n<1.55 (e.g., SiO₂) in the multilayer thin film stack (e.g., optical film structure), minimizing the thickness of the outermost low-index layer (e.g., capping layer), and using one or more medium index materials (e.g., SiOₓN_{y}) together with high index materials (e.g., SiNₓ) in the layer stack.

As detailed below in Table 33, key optical and mechanical property metrics of these transparent articles and optical film structure designs (i.e., Exs. 1, 17-27) are captured. For comparison, optical and mechanical property data from two comparative articles (Comp. Ex. 1 and Comp. Ex. 4) is also provided in Table 33 All of the data provided in Table 33 is from modeling, but as noted earlier (see FIG. 24 and corresponding description), the models employed in this disclosure have been validated with experimental data.

TABLE 33
Mechanical and Optical Properties of Exs. 1 & 17-27, and Comp. Exs. 1 and 4

| | Total optical | | avg. 1st | Model Hardness (in GPa) | | | | |
|---|---|---|---|---|---|---|---|---|
| | film structure | 1st surface | surface | H | H | H | H | |
| | thickness | photopic | % R (920- | (20 nm | (40 nm | (100 nm | (125 nm | |
| Design | (nm) | % R (Y(0)) | 960 nm) | depth) | depth) | depth) | depth) | Hmax |
| Comp. | 2374 | 4.0 | 3.8 | 7.8 | 10.0 | 14.0 | 15.0 | 18.8 |
| Ex. 1 | | | | | | | | |
| Comp. | 253 | 0.4 | 13.7 | 8.3 | 9.2 | 10.8 | 10.6 | 11.1 |
| Ex. 4 | | | | | | | | |
| Ex. 17 | 436 | 0.57 | 7.3 | 8.2 | 9.6 | 12.7 | 13.2 | 13.8 |
| Ex. 18 | 433 | 0.81 | 7.4 | 8.5 | 10.0 | 13.0 | 13.7 | 14.0 |
| Ex. 19 | 429 | 0.96 | 7.6 | 8.7 | 10.3 | 13.3 | 14.1 | 14.1 |
| Ex. 20 | 411 | 1.50 | 7.8 | 9.7 | 11.0 | 13.9 | 14.2 | 14.5 |
| Ex. 21 | 432 | 4.3 | 12.2 | 14.1 | 15.3 | 16.5 | 15.7 | 16.7 |
| Ex. 22 | 401 | 4.1 | 10.8 | 12.9 | 14.9 | 15.9 | 15.0 | 16.6 |
| Ex. 23 | 2709 | 1.29 | 5.2 | 11.9 | 12.7 | 16.0 | 16.6 | 16.9 |
| Ex. 24 | 2711 | 1.56 | 3.7 | 11.9 | 13.6 | 17.9 | 18.6 | 18.8 |
| Ex. 25 | 2746 | 1.52 | 5.1 | 11.9 | 13.7 | 17.5 | 18.0 | 18.2 |
| Ex. 1 | 2927 | 4.4 | 5.0 | 14.6 | 16.9 | 19.1 | 18.8 | 19.2 |
| Ex. 26 | 2923 | 4.4 | 5.0 | 16.4 | 18.0 | 19.4 | 19.0 | 19.6 |
| Ex. 27 | 2919 | 4.4 | 4.9 | 20.9 | 19.8 | 18.4 | 18.1 | 20.7 |

Finally, we introduce the concept of a figure of merit that combines the shallow hardness (e.g., hardness at 125 nm depth, or another depth value specified here) together with the change in average visible reflectance of the transparent article with a specified amount of material removal. The change in reflectance with material removal may correlate to the visibility of shallow surface scratch or wear marks, so a lower change in reflectance with material removal is preferred. Given the optical film structure designs and data in this disclosure, the reflectance change with a shallow depth of material removal can be modeled using known transfer matrix simulation methods. For example, Comp. Ex. 1 has a hardness at 125 nm depth of ~15.7 GPa, and a change in average % reflectance (400-700 nm wavelength average) of 48% with only 18 nm of material removed from the top of the optical film structure. This gives an example figure of merit (FOm) of H(125)/delta % R (18 nm)=15.7/0.48=32.7. In contrast, Ex. 1 has an example FOM of H(125)/delta % R (18 nm)=19.7/0.059=333. Thus, using this suggested FOM, it is desirable, and the transparent articles of the disclosure can exhibit, an FOM of H(125)/delta % R (18 nm)=greater than 50, greater than 100, greater than 200, or even greater than 300.

### Example 28 (Exs. 28A-28E)

In this example, a transparent article (nominally Ex. 16, as detailed above) including a strengthened glass-ceramic substrate (thickness of ~0.6 mm) is evaluated to assess the surprising effect of reducing the thickness of the scratch resistant layer 150 to reduce warpage, while maintaining retained strength and hardness in the article. More specifically, a transparent article having the designs as detailed below in Table 34 is evaluated, with varying scratch resistant layer thicknesses (i.e., Exs. 28A-28E having scratch resistant layer thicknesses of 0.1, 0.5, 1, 1.5 and 2 μm, respectively).

The standard transparent article design of Table 34 (Ex. 28A) is used in this example to demonstrate the advantages of tuning the scratch resistant layer thickness. As is evident from Table 34, the optical film structure includes an outer structure (i.e., anti-reflective (AR) stack), a scratch resistant layer (2 μm) and an inner structure (i.e., impedance matching (IM) stack) with a total thickness of the optical film structure reaching as high as 2.9 μm. From measurements of average optical film structure stress, the optical film structure design, and measurements of stress in single layer structures, the residual stress in the scratch resistant layer is estimated to be about −1121 MPa.

TABLE 34
Exs. 28A-E transparent article design with strengthened glass-ceramic
substrate

| | | | Index |
|---|---|---|---|
| Layer | Material | Thickness (nm) | (550 nm) |
| | Glass-Ceramic | Substrate | 1.533 |
| 1 | SiO2 | 25.0 | 1.476 |
| 2 | SiOxNy | 16.2 | 1.744 |
| 3 | SiO2 | 67.9 | 1.476 |
| 4 | SiOxNy | 25.3 | 1.744 |
| 5 | SiO2 | 70.9 | 1.476 |
| 6 | SiOxNy | 33.4 | 1.744 |
| 7 | SiO2 | 61.7 | 1.476 |
| 8 | SiOxNy | 44.1 | 1.744 |
| 9 | SiO2 | 47.4 | 1.476 |
| 10 | SiOxNy | 56.7 | 1.744 |
| 11 | SiO2 | 32.0 | 1.476 |
| 12 | SiOxNy | 68.9 | 1.744 |
| 13 | SiO2 | 18.3 | 1.476 |
| 14 | SiOxNy | 76.6 | 1.744 |
| 15 | SiO2 | 8.0 | 1.476 |
| 16 | SiOxNy | 100 (Ex. 28A) | 1.744 |
| | | 500 (Ex. 28B) | |
| | | 1000 (Ex. 28C) | |
| | | 1500 (Ex. 28D) | |
| | | 2000 (Ex. 28E) | |
| 17 | SiNx | 15.3 | 2.058 |
| 18 | SiOxNy | 37.7 | 1.744 |
| 19 | SiNx | 57.3 | 2.058 |
| 20 | SiOxNy | 8.0 | 1.744 |
| 21 | SiNx | 66.2 | 2.058 |
| 22 | SiOxNy | 76.2 | 1.744 |
| 23 | SiO2 | 14.0 | 1.476 |
| | Medium | Air | 1 |

Total thickness: 1026.8 to 2926.8
AR layers (outer structure) thickness (nm): 274.6
Low-RI in AR thickness (nm): 14

Hardness Response vs. Scratch Resistant Layer Thickness (Exs. 28A-28E)

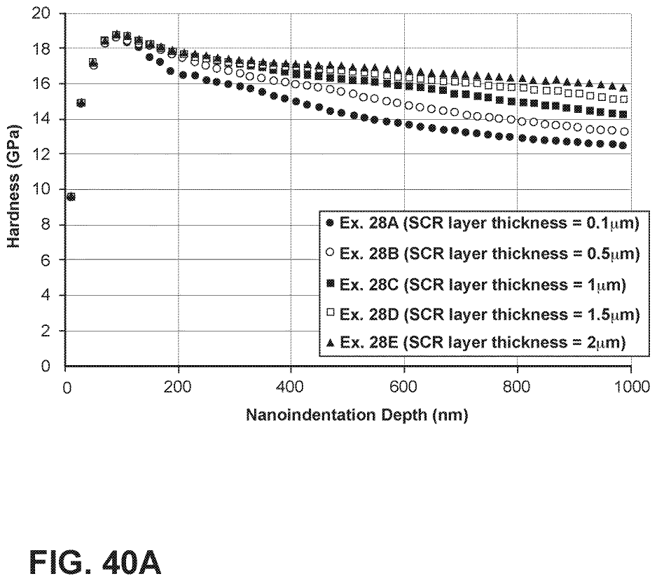

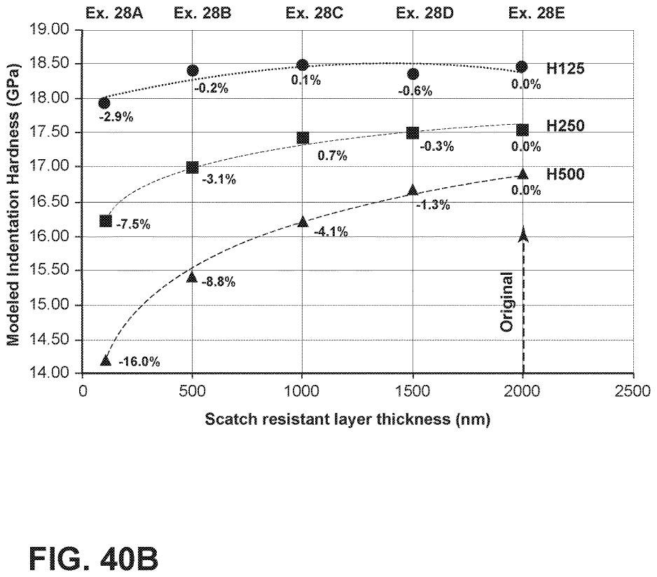

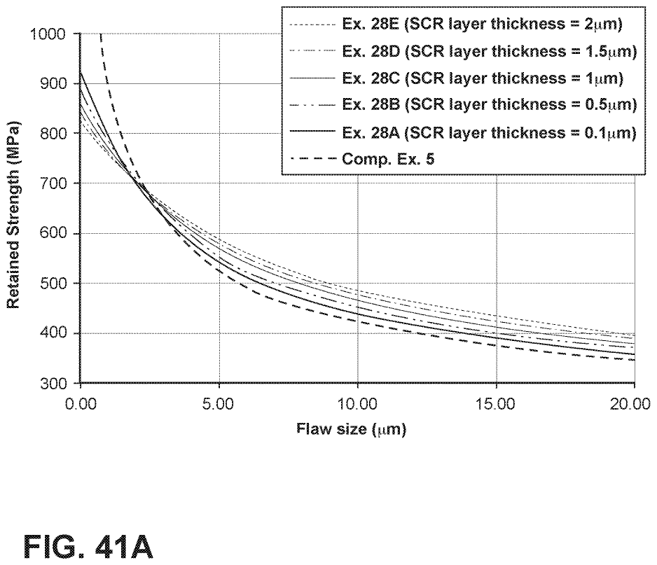

Referring now to FIG. 40A, a schematic plot is provided of hardness (GPa) vs. indentation depth, as modeled to be indicative of the results from a Berkovich Hardness Test of the optical film structure of transparent articles of this example having varying levels of scratch resistant layer thickness (Exs. 28A-28E). In this example, the samples (Exs. 28A-28E) are modeled with the assumption that the process conditions used to sputter the scratch resistant layer and other layers remain the same. As shown in FIG. 40A, the effect of a thinner scratch resistant layer on the nanoindentation hardness (as in the Berkovich Hardness Test) is evaluated using FEA simulations, e.g., as described in Price, J. J. et al., “Nanoindentation Hardness and Practical Scratch Resistance in Mechanically Tunable Anti-Reflection Coatings”, Coatings, 2021, 11(2), the salient portions of which are hereby incorporated by reference. As shown in the figure, transparent articles employing scratch resistant layers with thickness of 0.1, 0.5, 1, 1.5 and 2 microns were evaluated, Exs. 28A-28E, respectively. As seen in FIG. 40A, the hardness response in the initial stages of nanoindentation is fairly invariant with the thickness of the scratch resistant layer, and the curves appear to diverge as the indentation depth increases. Moreover, even as the scratch resistant layer thickness decreases to as small as 0.1 μm (Ex. 28A), the hardness over the entire indentation depth range of 100 nm to 1000 nm remains above 12 GPa.

Referring now to FIG. 40B, a schematic plot is provided of hardness (GPa) vs. scratch resistant layer thickness, as modeled to be indicative of the results from a Berkovich Hardness Test of the optical film structure of the transparent articles of this example (Exs. 28A-28E). The hardness value at 125 nm (H125) is often considered to be of high importance as it may be representative of the resistance offered to scratches in customer specific scratch tests. Accordingly, the H125 values, in addition to H250 and H500 as a function of the scratch resistant layer thickness are shown in FIG. 40B. The data labels show the % drop in hardness as compared to the original design with the 2 μm scratch resistant layer (Ex. 28E). As seen in the figure, H125 remains fairly steady as the scratch resistant layer thickness decreases from 2 μm down to 500 nm (Ex. 28C) and the variation remains within 1%. The decrease in H125 is about 3% only when the thickness of the scratch resistant layer decreases to as low as 100 nm (Ex. 28A). Similarly, the decrease in H250 appears to be significant only when the scratch resistant layer thickness is less than 1000 nm thickness. H500 decreases significantly for any value of thickness <1500 nm (e.g., Exs. 28A-28C). By ‘significant’ here, the change is more than a few % compared to the original design (Ex. 28E).

Based on the results of the evaluation depicted in FIGS. 40A and 40B, if H125 is the most important hardness parameter, then a 500 nm scratch resistant layer should be sufficiently thick and a scratch resistant layer >500 nm offers diminishing returns. If scratch resistance at deeper depths is desired, e.g., at 250 nm, then a 1000 nm scratch resistant layer is likely sufficient. Further, if H500 is considered important, 1500 nm is sufficiently thick for the scratch resistant layer.

Retained Strength vs. Scratch Resistant Layer Thickness (Exs. 28A-28E and Comp. Ex. 5)

In this aspect, retained strength is evaluated as a function of scratch resistant layer thickness for the samples of this example (Exs. 28A-28E). Further, a control sample without an optical film structure was evaluated (Comp. Ex. 5), with all other elements the same as those in the samples of this example. As is evident from the results of this aspect, multiple factors affect retained strength: (a) a decrease in optical film structure thickness decreases the overall flaw population (optical film structure+substrate flaw size) and increases the strength; (b) a decrease in optical film structure thickness (especially decreasing the thickness of a high stress layer) may reduce the average optical film structure stress, decrease the ‘crack closure’ effect and eventually decrease strength; and (c) a decrease in thickness of a high modulus layer in the optical film structure (such as the scratch resistant layer) relative to other layers such as the low RI layers (e.g., SiO₂) decreases the average modulus of the optical film structure which in turn decreases the stress intensity factor and increases the strength.

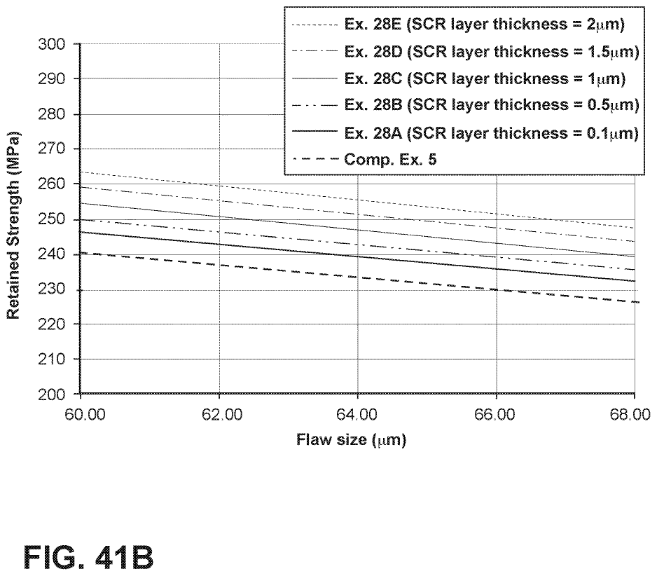

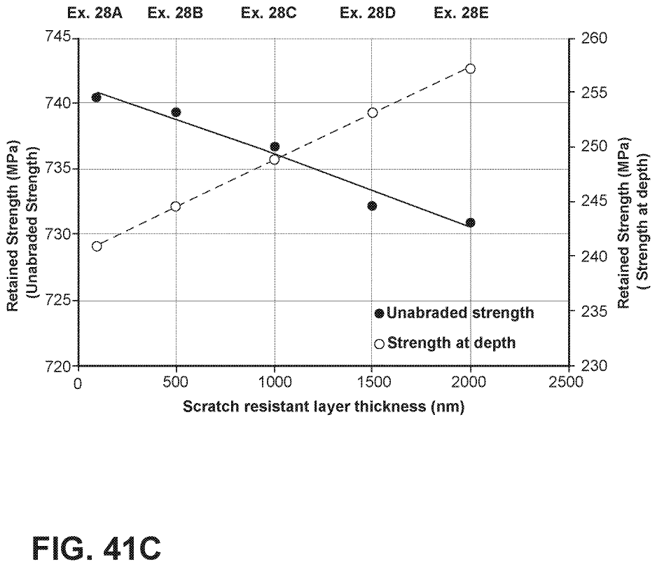

Referring now to FIGS. 41A and 41B, schematic plots are provided of retained strength (MPa) vs. two substrate flaw size ranges (ranging from 0 to 20 μm, and 60 to 68 μm, respectively), as modeled to be indicative of a ring-on-ring (ROR) test of the transparent articles of this example having varying levels of scratch resistant layer thickness (Exs. 28A-28E) and a control sample without an optical film structure (Comp. Ex. 5). In particular, the curves shift as the thickness of the scratch resistant layer is changed in mainly two ways. In particular, for a thinner scratch resistant layer, (a) the surface strength increases; and (b) the strength at depth increases.

For (a) in which the surface strength increases, assuming the average surface strength in the unabraded condition as measured in a ROR test is dictated by flaws in the range of 0.5 μm-2.5 μm, the average surface strength increases marginally from 731 MPa to 740 MPa. The strength for a 0.1 μm flaw is found to increase more significantly, from 786 MPa to 840 MP or ~7%. Most importantly, the unabraded retained strength is found not to be adversely affected. As for (b) in which the strength at depth increases, resistance provided for glass substrate failure under drop conditions is found to decrease with optical film structure thickness. The magnitude of decrease in strength after drop depends on the check depth. For example, the average check depth after drop on the strengthened glass-ceramic substrate is found to be 63 μm (0.6 mm glass attached to a 200 g polymer puck, flat face dropped on 3M 80 grit garnet sandpaper). Assuming that this check depth remains the same for a strengthened glass-ceramic substrate with an optical film structure as well, the strength after drop at 63 μm is found to decrease marginally, i.e., 257 MPa original to 245 MPa for a 500 nm thickness hard layer, i.e., 5% decrease. However, the optical film structure is expected to provide some damage resistance as well, which may mitigate this drop in strength.

Referring now to FIG. 41C, a schematic plot is provided of retained strength (MPa) vs. scratch resistant layer thickness, as modeled to be indicative of the surface retained strength and strength at a depth of 63 μm in an ROR test of the transparent articles of this example (Exs. 28A-28E). The data from FIG. 41C is also summarized below in Table 35. As is evident from FIG. 41C and Table 35, the average optical film structure stress decreases with decreasing scratch resistant layer thickness which means that crack closure may not be as effective; however, it appears that the simultaneous increase in average modulus and decrease in total flaw depth (optical film structure thickness+substrate flaw size) compensates for the drop in optical film structure stress.

TABLE 35
Summary of Retained Strength and other Properties of Exs. 28A-28E

| | | | | | | Strength |
|---|---|---|---|---|---|---|
| | | | | | | after |
| | SCR | Total | | | | drop - |
| | layer | Optical | | | Average | 63 μm |
| | thick- | Film | Average | Average | Surface | check |
| | ness | Thickness | Stress | Modulus | Strength | depth |
| Design | (nm) | (nm) | (MPa) | (GPa) | (MPa) | (MPa) |
| Ex. 28E | 2000 | 2926 | −1004 | 165 | 731 | 257 |
| Ex. 28D | 1500 | 2426 | −980 | 164 | 732 | 253 |
| Ex. 28C | 1000 | 1926 | −944 | 161 | 737 | 249 |
| Ex. 28B | 500 | 1426 | −882 | 157 | 739 | 245 |
| Ex. 28A | 100 | 1026 | −788 | 151 | 740 | 241 |

Warp vs. Scratch Resistant Layer Thickness (Exs. 28A-28E)

In this aspect, warp is evaluated as a function of scratch resistant layer thickness for the samples of this example (Exs. 28A-28E). As is evident from the results of this aspect, a decrease in scratch resistant layer thickness can significantly decrease warp of the substrate after deposition of the optical film structure, and reduce the time and cost required to process the substrate (asymmetric polishing) before the optical film structure is applied. Warp is mainly driven by compressive stress in the optical film structure and the thickness of the optical film structure, as summarized in Table 36 below. Decreasing the thickness of the scratch resistant layer has a dual effect on warp, as the average stress in the optical film structure is itself decreased as well as the optical film structure “force” (F=σh_{c}) which is the optical film structure stress multiplied by the optical film structure thickness. As is evident from Table 36, the maximum deflection in a D63 part (maximum diagonal length of 73 mm) decreases from ~1 mm (original) to ~435 μm if the scratch resistant layer thickness is decreased from 2000 nm (Ex. 28E) to 500 nm (Ex. 28B).

TABLE 36
Summary of Maximum Deflection and Residual Stress of Exs. 28A-28E

| | | Total | | | |
|---|---|---|---|---|---|
| | | Optical | | | Single side |
| | SCR layer | Film | Average | Max. deflection | polishing |
| | thickness | Thickness | Stress | due to coating | required |
| Design | (nm) | (nm) | (MPa) | (μm) | (μm) |
| Ex. 28E | 2000 | 2926 | −1004 | −1018 | 11.9 |
| Ex. 28D | 1500 | 2426 | −980 | −823 | 9.2 |
| Ex. 28C | 1000 | 1926 | −944 | −629 | 6.7 |
| Ex. 28B | 500 | 1426 | −882 | −435 | 4.1 |
| Ex. 28A | 100 | 1026 | −788 | −279 | 2.4 |

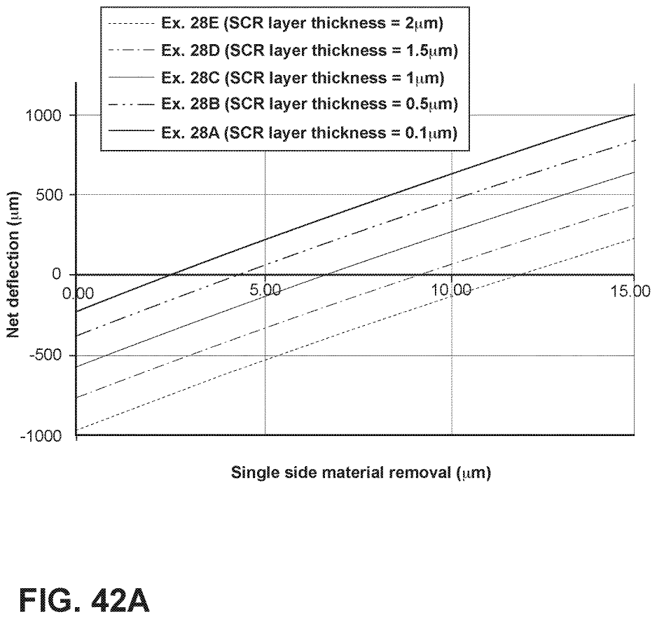

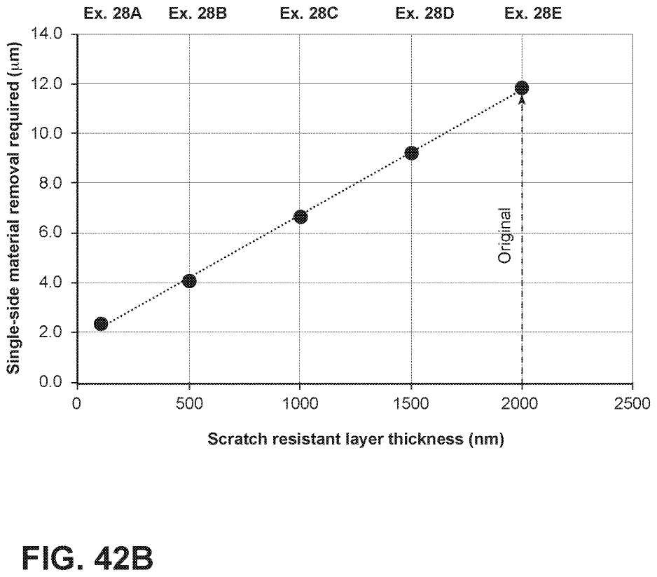

Referring now to FIG. 42A, a schematic plot is provided of net deflection (μm) vs. single side material removal (μm) of the transparent articles of this example (Exs. 28A-28E) having varying scratch resistant layer thickness levels. Further, FIG. 42B is a schematic plot of single side material removal required before deposition of the optical film structure to achieve zero warp as a function of scratch resistant layer thickness for the transparent articles of this example. In particular, FIG. 42A shows net deflection as a function of single side material removal, and FIG. 42B shows the single side material removal required before the optical film structure is applied to achieve a net zero warp for various thicknesses of the scratch resistant layer (all for a D63 part, Exs. 28A-28E). As seen in these figures, a single sided material removal of nearly 12 μm (on the A-side of the substrate) is required if a scratch resistant layer of 2 μm thickness (Ex. 28E) is used whereas a removal of only 4 μm is required for a 500 nm thickness scratch resistant layer (Ex. 28B), a decrease of 3×.

Aspect 1. According to a first aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, one or both of: (i) the outer structure comprises at least one medium RI layer in contact with one or both of: (a) the scratch-resistant layer and (b) one of the high RI layers; and (ii) a sum of the physical thicknesses of all of the low RI layers in the outer structure is less than about 200 nm. Further, the at least one medium RI layer comprises a refractive index from 1.55 to 1.80, each of the high RI layers comprises a refractive index of greater than 1.80, and each of the low RI layers comprises a refractive index of less than 1.55.

Aspect 2. According to a second aspect of the disclosure, the first aspect is provided, wherein the outer structure comprises at least one medium RI layer in contact with one or both of: (a) the scratch-resistant layer and (b) one of the high RI layers.

Aspect 3. According to a third aspect of the disclosure, the first aspect or the second aspect is provided, wherein a sum of the physical thicknesses of all of the low RI layers in the outer structure is less than about 75 nm.

Aspect 4. According to a fourth aspect of the disclosure, the third aspect is provided, wherein the transparent article exhibits an average first-surface photopic reflectance of less than 7% and a first-surface reflectance at a wavelength of 940 nm of less than 8%, each as measured at a near-normal angle of incidence.

Aspect 5. According to a fifth aspect of the disclosure, the first aspect is provided, wherein a sum of the physical thicknesses of all of the low RI layers in the outer structure is less than about 200 nm, and further wherein the transparent article exhibits an average first-surface photopic reflectance of less than 3% and a first-surface reflectance at a wavelength of 940 nm of less than 5%, each as measured at a near-normal angle of incidence.

Aspect 6. According to a sixth aspect of the disclosure, the first aspect is provided, wherein the outer structure comprises at least one medium RI layer in contact with one or both of: (a) the scratch-resistant layer and (b) one of the high RI layers, and further wherein the substrate comprises a glass-ceramic substrate having an elastic modulus of greater than 85 GPa and a fracture toughness of greater than 0.8 MPa·√m.

Aspect 7. According to a seventh aspect of the disclosure, the first aspect is provided, wherein the optical film structure has a physical thickness of from about 200 nm to 5000 nm, wherein the article exhibits a first-surface average photopic reflectance of less than 6%, and further wherein the article exhibits one or more of: (a) a hardness of greater than 11 GPa at an indentation depth of about 20 nm or 40 nm; (b) a hardness of greater than 15 GPa at an indentation depth of 100 nm; and (c) a hardness of greater than 16 GPa at an indentation depth of 125 nm, as measured by a Berkovich Hardness Test at the outer surface of the optical film structure.

Aspect 8. According to an eighth aspect of the disclosure, the first aspect is provided, wherein the optical film structure has a physical thickness of from about 200 nm to 800 nm, wherein the article exhibits a first-surface average photopic reflectance of less than 6%, and further wherein the article exhibits one or more of: (a) a hardness of greater than 9 GPa at an indentation depth of 20 nm; (b) a hardness of greater than 10 GPa at an indentation depth of 40 nm; (c) a hardness of greater than 12 GPa at an indentation depth of 100 nm; and (d) a hardness of greater than 12 GPa at an indentation depth of 125 nm, as measured by a Berkovich Hardness Test at the outer surface of the optical film structure.

Aspect 9. According to a ninth aspect of the disclosure, the first aspect is provided, wherein the scratch-resistant layer has a physical thickness from about 100 nm to less than 2000 nm, and further wherein the outer structure comprises at least one medium RI layer in contact with one or both of: (a) the scratch-resistant layer and (b) one of the high RI layers.

Aspect 10. According to a tenth aspect of the disclosure, any one of the first through ninth aspects is provided, further comprising a textured surface region defined by the first primary surface of the substrate, wherein the textured surface region comprises a plurality of structural features and an average texture height (Rtext) from 50 nm to 800 nm.

Aspect 11. According to an eleventh aspect of the disclosure, any one of the first through ninth aspects is provided, further comprising a diffractive surface region defined by the first primary surface of the substrate, wherein the diffractive surface region comprises a plurality of structural features with a plurality of different heights in a bimodal or multimodal distribution.

Aspect 12. According to a twelfth aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. Further, the medium RI layer comprises a refractive index from 1.55 to 1.80, each of the high RI layers comprises a refractive index of greater than 1.80, and each of the low RI layers comprises a refractive index of less than 1.55.

Aspect 13. According to a thirteenth aspect of the disclosure, the twelfth aspect is provided, wherein the article exhibits a hardness of greater than 15 GPa, as measured by a Berkovich Hardness Test at an indentation depth of about 125 nm from the outer surface of the optical film structure.

Aspect 14. According to a fourteenth aspect of the disclosure, the twelfth aspect is provided, wherein the article exhibits a hardness of greater than 16 GPa, as measured by a Berkovich Hardness Test at an indentation depth of about 125 nm from the outer surface of the optical film structure.

Aspect 15. According to a fifteenth aspect of the disclosure, any one of the twelfth through fourteenth aspects is provided, wherein the article exhibits an average first-surface photopic reflectance of less than 5%, a first-surface reflectance at a wavelength of 940 nm of less than 6%, and an average first-surface reflectance at wavelengths from 1000 nm to 1700 nm of less than 10%, each as measured at a near-normal angle of incidence.

Aspect 16. According to a sixteenth aspect of the disclosure, any one of the twelfth through fifteenth aspects is provided, wherein each high RI layer and the scratch-resistant layer comprises one or more of Si3N4, SiNy, and SiOxNy, and each low RI layer comprises one or more of SiO2, SiOx and SiOxNy.

Aspect 17. According to a seventeenth aspect of the disclosure, any one of the twelfth through sixteenth aspects is provided, wherein the scratch-resistant layer and each medium RI layer comprises SiOxNy.

Aspect 18. According to an eighteenth aspect of the disclosure, any one of the twelfth through seventeenth aspects is provided, wherein the optical film structure exhibits a residual compressive stress of greater than or equal to 700 MPa and an elastic modulus of greater than or equal to 140 GPa.

Aspect 19. According to a nineteenth aspect of the disclosure, any one of the twelfth through eighteenth aspects is provided, wherein the substrate is a glass-ceramic material that comprises an elastic modulus of greater than 85 GPa and a fracture toughness of greater than 0.8 MPa·√m.

Aspect 20. According to a twentieth aspect of the disclosure, any one of the twelfth through nineteenth aspects is provided, wherein the optical film structure exhibits a residual compressive stress of from 700 MPa to 1100 MPa and an elastic modulus of from 140 GPa to 200 GPa.

Aspect 21. According to a twenty-first aspect of the disclosure, any one of the twelfth through twentieth aspects is provided, wherein the optical film structure exhibits an elastic modulus of from 140 GPa to 180 GPa.

Aspect 22. According to a twenty-second aspect of the disclosure, any one of the twelfth through twenty-first aspects is provided, wherein the substrate has a residual surface compressive stress of from 200 MPa to 1200 MPa and a depth of compression (DOC) of from 5 μm to 150 μm.

Aspect 23. According to a twenty-third aspect of the disclosure, any one of the twelfth through twenty-second aspects is provided, wherein the substrate further exhibits a maximum central tension (CT) value from 80 MPa to 200 MPa, and further wherein the substrate has a thickness of about 1.5 mm or less.

Aspect 24. According to a twenty-fourth aspect of the disclosure, any one of the twelfth through twenty-third aspects is provided, wherein the substrate has a residual surface compressive stress of from 200 MPa to 400 MPa.

Aspect 25. According to a twenty-fifth aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, a sum of the physical thicknesses of all of the low RI layers in the outer structure is less than about 75 nm.

Aspect 26. According to a twenty-sixth aspect of the disclosure, the twenty-fifth aspect is provided, wherein the article exhibits a hardness of greater than 15 GPa, as measured by a Berkovich Hardness Test at an indentation depth of about 125 nm from the outer surface of the optical film structure.

Aspect 27. According to a twenty-seventh aspect of the disclosure, the twenty-fifth aspect is provided, wherein the article exhibits a hardness of greater than 17 GPa, as measured by a Berkovich Hardness Test at an indentation depth of about 125 nm from the outer surface of the optical film structure.

Aspect 28. According to a twenty-eighth aspect of the disclosure, any one of the twenty-fifth through twenty-seventh aspects is provided, wherein the article exhibits an average first-surface photopic reflectance of less than 5%, a first-surface reflectance at a wavelength of 940 nm of less than 6%, and an average first-surface reflectance at wavelengths from 1000 nm to 1700 nm of less than 10%, each as measured at a near-normal angle of incidence.

Aspect 29. According to a twenty-ninth aspect of the disclosure, any one of the twenty-fifth through twenty-eighth aspects is provided, wherein each high RI layer and the scratch-resistant layer comprises one or more of Si3N4, SiNy, and SiOxNy, and each low RI layer comprises one or more of SiO2, SiOx and SiOxNy.

Aspect 30. According to a thirtieth aspect of the disclosure, any one of the twenty-fifth through twenty-ninth aspects is provided, wherein the sum of the physical thicknesses of all of the low RI layers in the outer structure is less than about 65 nm.

Aspect 31. According to a thirty-first aspect of the disclosure, any one of the twenty-fifth through thirtieth aspects is provided, wherein the optical film structure exhibits a residual compressive stress of greater than or equal to 700 MPa and an elastic modulus of greater than or equal to 140 GPa.

Aspect 32. According to a thirty-second aspect of the disclosure, any one of the twenty-fifth through thirty-first aspects is provided, wherein the substrate is a glass-ceramic material that comprises an elastic modulus of greater than 85 GPa and a fracture toughness of greater than 0.8 MPa·√m.

Aspect 33. According to a thirty-third aspect of the disclosure, any one of the twenty-fifth through thirty-second aspects is provided, wherein the optical film structure exhibits a residual compressive stress of from 700 MPa to 1100 MPa and an elastic modulus of from 140 GPa to 200 GPa.

Aspect 34. According to a thirty-fourth aspect of the disclosure, any one of the twenty-fifth through thirty-third aspects is provided, wherein the optical film structure exhibits an elastic modulus of from 140 GPa to 180 GPa.

Aspect 35. According to a thirty-fifth aspect of the disclosure, any one of the twenty-fifth through thirty-fourth aspects is provided, wherein the substrate has a residual surface compressive stress of from 200 MPa to 1200 MPa and a depth of compression (DOC) of from 5 μm to 150 μm.

Aspect 36. According to a thirty-sixth aspect of the disclosure, any one of the twenty-fifth through thirty-fifth aspects is provided, wherein the substrate further exhibits a maximum central tension (CT) value from 80 MPa to 200 MPa, and further wherein the substrate has a thickness of about 1.5 mm or less.

Aspect 37. According to a thirty-seventh aspect of the disclosure, any one of the twenty-fifth through thirty-sixth aspects is provided, wherein the substrate has a residual surface compressive stress of from 200 MPa to 400 MPa.

Aspect 38. According to a thirty-eighth aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one of the high RI layers and the scratch-resistant layer. Further, the medium RI layer comprises a refractive index from 1.55 to 1.80, each of the high RI layers comprises a refractive index of greater than 1.80, and each of the low RI layers comprises a refractive index of less than 1.55. In addition, a sum of the physical thicknesses of all of the low RI layers in the outer structure is less than about 75 nm.

Aspect 39. According to a thirty-ninth aspect of the disclosure, the thirty-eighth aspect is provided, wherein the article exhibits a hardness of greater than 15 GPa, as measured by a Berkovich Hardness Test at an indentation depth of about 125 nm from the outer surface of the optical film structure.

Aspect 40. According to a fortieth aspect of the disclosure, the thirty-eighth aspect is provided, wherein the article exhibits a hardness of greater than 17 GPa, as measured by a Berkovich Hardness Test at an indentation depth of about 125 nm from the outer surface of the optical film structure.

Aspect 41. According to a forty-first aspect of the disclosure, any one of the thirty-eighth through fortieth aspects is provided, wherein the article exhibits an average first-surface photopic reflectance of less than 5%, a first-surface reflectance at a wavelength of 940 nm of less than 6%, and an average first-surface reflectance at wavelengths from 1000 nm to 1700 nm of less than 10%, each as measured at a near-normal angle of incidence.

Aspect 42. According to a forty-second aspect of the disclosure, any one of the thirty-eighth through forty-first aspects is provided, wherein the article exhibits an average first-surface photopic reflectance of about 4% or less, a first-surface reflectance at a wavelength of 940 nm of about 4.3% or less, and an average first-surface reflectance at wavelengths from 1000 nm to 1700 nm of less than 8%, each as measured at a near-normal angle of incidence.

Aspect 43. According to a forty-third aspect of the disclosure, any one of the thirty-eighth through forty-second aspects is provided, wherein each high RI layer and the scratch-resistant layer comprises one or more of Si3N4, SiNy, and SiOxNy, and each low RI layer comprises one or more of SiO2, SiOx and SiOxNy.

Aspect 44. According to a forty-fourth aspect of the disclosure, any one of the thirty-eighth through forty-third aspects is provided, wherein the scratch-resistant layer and each medium RI layer comprises SiOxNy, and further wherein the sum of the physical thicknesses of all of the low RI layers in the outer structure is less than about 65 nm.

Aspect 45. According to a forty-fifth aspect of the disclosure, any one of the thirty-eighth through forty-fourth aspects is provided, wherein the optical film structure exhibits a residual compressive stress of greater than or equal to 700 MPa and an elastic modulus of greater than or equal to 140 GPa.

Aspect 46. According to a forty-sixth aspect of the disclosure, any one of the thirty-eighth through forty-fifth aspects is provided, wherein the substrate is a glass-ceramic material that comprises an elastic modulus of greater than 85 GPa and a fracture toughness of greater than 0.8 MPa·√m.

Aspect 47. According to a forty-seventh aspect of the disclosure, any one of the thirty-eighth through forty-sixth aspects is provided, wherein the optical film structure exhibits a residual compressive stress of from 700 MPa to 1100 MPa and an elastic modulus of from 140 GPa to 200 GPa.

Aspect 48. According to a forty-eighth aspect of the disclosure, any one of the thirty-eighth through forty-seventh aspects is provided, wherein the optical film structure exhibits an elastic modulus of from 140 GPa to 180 GPa.

Aspect 49. According to a forty-ninth aspect of the disclosure, any one of the thirty-eighth through forty-eighth aspects is provided, wherein the substrate has a residual surface compressive stress of from 200 MPa to 1200 MPa and a depth of compression (DOC) of from 5 μm to 150 μm.

Aspect 50. According to a fiftieth aspect of the disclosure, any one of the thirty-eighth through forty-ninth aspects is provided, wherein the substrate further exhibits a maximum central tension (CT) value from 80 MPa to 200 MPa, and further wherein the substrate has a thickness of about 1.5 mm or less.

Aspect 51. According to a fifty-first aspect of the disclosure, any one of the thirty-eighth through fiftieth aspects is provided, wherein the substrate has a residual surface compressive stress of from 200 MPa to 400 MPa.

Aspect 52. According to a fifty-second aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, a sum of the physical thicknesses of all of the low RI layers in the outer structure is less than about 75 nm. In addition, the article exhibits an average first-surface photopic reflectance of less than 7% and a first-surface reflectance at a wavelength of 940 nm of less than 8%, each as measured at a near-normal angle of incidence.

Aspect 53. According to a fifty-third aspect of the disclosure, the fifty-second aspect is provided, wherein the sum of the physical thicknesses of all of the low RI layers in the outer structure is less than about 50 nm.

Aspect 54. According to a fifty-fourth aspect of the disclosure, the fifty-second aspect or the fifty-third aspect is provided, wherein the article exhibits a first-surface reflectance at wavelengths from 1000 nm to 1700 nm of about 7% or less, as measured at a near-normal angle of incidence.

Aspect 55. According to a fifty-fifth aspect of the disclosure, any one of the fifty-second through fifty-fourth aspects is provided, wherein the article exhibits a hardness of greater than 15 GPa, as measured by a Berkovich Hardness Test at an indentation depth of about 125 nm from the outer surface of the optical film structure.

Aspect 56. According to a fifty-sixth aspect of the disclosure, any one of the fifty-second through fifty-fifth aspects is provided, wherein each high RI layer and the scratch-resistant layer comprises SiOxNy, and each low RI layer comprises one or more of SiO2, SiOx and SiOxNy.

Aspect 57. According to a fifty-seventh aspect of the disclosure, any one of the fifty-second through fifty-sixth aspects is provided, wherein the optical film structure exhibits a residual compressive stress of greater than or equal to 700 MPa and an elastic modulus of greater than or equal to 140 GPa.

Aspect 58. According to a fifty-eighth aspect of the disclosure, any one of the fifty-second through fifty-seventh aspects is provided, wherein the substrate is a glass-ceramic material that comprises an elastic modulus of greater than 85 GPa and a fracture toughness of greater than 0.8 MPa·√m.

Aspect 59. According to a fifty-ninth aspect of the disclosure, any one of the fifty-second through fifty-eighth aspects is provided, wherein the optical film structure exhibits a residual compressive stress of from 700 MPa to 1100 MPa and an elastic modulus of from 140 GPa to 200 GPa.

Aspect 60. According to a sixtieth aspect of the disclosure, any one of the fifty-second through fifty-ninth aspects is provided, wherein the optical film structure exhibits an elastic modulus of from 140 GPa to 180 GPa.

Aspect 61. According to a sixty-first aspect of the disclosure, any one of the fifty-second through sixtieth aspects is provided, wherein the substrate has a residual surface compressive stress of from 200 MPa to 1200 MPa and a depth of compression (DOC) of from 5 μm to 150 μm.

Aspect 62. According to a sixty-second aspect of the disclosure, any one of the fifty-second through sixty-first aspects is provided, wherein the substrate further exhibits a maximum central tension (CT) value from 80 MPa to 200 MPa, and further wherein the substrate has a thickness of about 1.5 mm or less.

Aspect 63. According to a sixty-third aspect of the disclosure, any one of the fifty-second through sixty-second aspects is provided, wherein the substrate has a residual surface compressive stress of from 200 MPa to 400 MPa.

Aspect 64. According to a sixty-fourth aspect of the disclosure, any one of the fifty-second through sixty-third aspects is provided, wherein the inner structure comprises one of: (a) a plurality of alternating high refractive (RI) and low RI layers; (b) a refractive index gradient; and (c) a compositional gradient.

Aspect 65. According to a sixty-fifth aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. Further, a sum of the physical thicknesses of all of the low RI layers in the outer structure is less than about 200 nm. In addition, the article exhibits an average first-surface photopic reflectance of less than 3% and a first-surface reflectance at a wavelength of 940 nm of less than 5%, each as measured at a near-normal angle of incidence.

Aspect 66. According to a sixty-sixth aspect of the disclosure, the sixty-fifth aspect is provided, wherein the sum of the physical thicknesses of all of the low RI layers in the outer structure is less than about 150 nm.

Aspect 67. According to a sixty-seventh aspect of the disclosure, the sixty-fifth aspect is provided, wherein the sum of the physical thicknesses of all of the low RI layers in the outer structure is less than about 100 nm.

Aspect 68. According to a sixty-eighth aspect of the disclosure, any one of the sixty-fifth through sixty-seventh aspects is provided, wherein the article exhibits a first-surface average reflectance at wavelengths from 1000 nm to 1700 nm of about 8% or less, as measured at a near-normal angle of incidence.

Aspect 69. According to a sixty-ninth aspect of the disclosure, any one of the sixty-fifth through sixty-eighth aspects is provided, wherein the article exhibits a first-surface average reflectance at wavelengths from 1000 nm to 1700 nm of about 4% or less, as measured at a near-normal angle of incidence.

Aspect 70. According to a seventieth aspect of the disclosure, any one of the sixty-fifth through sixty-ninth aspects is provided, wherein the article exhibits an average first-surface photopic reflectance of less than 2.2%.

Aspect 71. According to a seventy-first aspect of the disclosure, any one of the sixty-fifth through seventieth aspects is provided, wherein the article exhibits a hardness of greater than 12 GPa, as measured by a Berkovich Hardness Test at an indentation depth of about 125 nm from the outer surface of the optical film structure.

Aspect 72. According to a seventy-second aspect of the disclosure, any one of the sixty-fifth through seventy-first aspects is provided, wherein the outer structure comprises at least one medium RI layer in contact with one of the high RI layers and the scratch-resistant layer, wherein the medium RI layer comprises a refractive index from 1.55 to 1.80, each of the high RI layers comprises a refractive index of greater than 1.80, and each of the low RI layers comprises a refractive index of less than 1.55, and further wherein the scratch-resistant layer and each medium RI layer comprises SiOxNy.

Aspect 73. According to a seventy-third aspect of the disclosure, any one of the sixty-fifth through seventy-second aspects is provided, wherein the optical film structure exhibits a residual compressive stress of greater than or equal to 700 MPa and an elastic modulus of greater than or equal to 140 GPa.

Aspect 74. According to a seventy-fourth aspect of the disclosure, any one of the sixty-fifth through seventy-third aspects is provided, wherein the substrate is a glass-ceramic material that comprises an elastic modulus of greater than 85 GPa and a fracture toughness of greater than 0.8 MPa·√m.

Aspect 75. According to a seventy-fifth aspect of the disclosure, any one of the sixty-fifth through seventy-fourth aspects is provided, wherein the optical film structure exhibits a residual compressive stress of from 700 MPa to 1100 MPa and an elastic modulus of from 140 GPa to 200 GPa.

Aspect 76. According to a seventy-sixth aspect of the disclosure, any one of the sixty-fifth through seventy-fifth aspects is provided, wherein the optical film structure exhibits an elastic modulus of from 140 GPa to 180 GPa.

Aspect 77. According to a seventy-seventh aspect of the disclosure, any one of the sixty-fifth through seventy-sixth aspects is provided, wherein the substrate has a residual surface compressive stress of from 200 MPa to 1200 MPa and a depth of compression (DOC) of from 5 μm to 150 μm.

Aspect 78. According to a seventy-eighth aspect of the disclosure, any one of the sixty-fifth through seventy-seventh aspects is provided, wherein the substrate further exhibits a maximum central tension (CT) value from 80 MPa to 200 MPa, and further wherein the substrate has a thickness of about 1.5 mm or less.

Aspect 79. According to a seventy-ninth aspect of the disclosure, any one of the sixty-fifth through seventy-eighth aspects is provided, wherein the substrate has a residual surface compressive stress of from 200 MPa to 400 MPa.

Aspect 80. According to an eightieth aspect of the disclosure, any one of the sixty-fifth through seventy-ninth aspects is provided, wherein the inner structure comprises one of: (a) a plurality of alternating high refractive (RI) and low RI layers; (b) a refractive index gradient; and (c) a compositional gradient.

Aspect 81. According to an eighty-first aspect of the disclosure, any one of the first through eleventh aspects is provided, wherein the transparent article serves as a protective cover for the display device.

Aspect 82. According to an eighty-second aspect of the disclosure, any one of the twelfth through twenty-fourth aspects is provided, wherein the transparent article serves as a protective cover for the display device.

Aspect 83. According to an eighty-third aspect of the disclosure, any one of the twenty-fifth through thirty-seventh aspects is provided, wherein the transparent article serves as a protective cover for the display device.

Aspect 84. According to an eighty-fourth aspect of the disclosure, any one of the thirty-eighth through fifty-first aspects is provided, wherein the transparent article serves as a protective cover for the display device.

Aspect 85. According to an eighty-fifth aspect of the disclosure, any one of the fifty-second through sixty-fourth aspects is provided, wherein the transparent article serves as a protective cover for the display device.

Aspect 86. According to an eighty-sixth aspect of the disclosure, any one of the sixty-fifth through eightieth aspects is provided, wherein the transparent article serves as a protective cover for the display device.

Aspect 87. According to an eighty-seventh of the disclosure, a transparent article is provided that includes: a glass-ceramic substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one of the high RI layers and the scratch-resistant layer. Further, the medium RI layer comprises a refractive index from 1.55 to 1.80, each of the high RI layers comprises a refractive index of greater than 1.80, and each of the low RI layers comprises a refractive index of less than 1.55. In addition, the glass-ceramic substrate comprises an elastic modulus of greater than 85 GPa and a fracture toughness of greater than 0.8 MPa·√m.

Aspect 88. According to an eighty-eighth aspect of the disclosure, the eighty-seventh aspect is provided, wherein the optical film structure exhibits a residual compressive stress of greater than or equal to 700 MPa and an elastic modulus of greater than or equal to 140 GPa.

Aspect 89. According to an eighty-ninth aspect of the disclosure, the eighty-seventh aspect is provided is provided, wherein the optical film structure exhibits a residual compressive stress of from 700 MPa to 1100 MPa and an elastic modulus of from 140 GPa to 200 GPa.

Aspect 90. According to a ninetieth aspect of the disclosure, any one of the eighty-seventh through eighty-ninth aspects is provided, wherein the optical film structure exhibits an elastic modulus of from 140 GPa to 180 GPa.

Aspect 91. According to a ninety-first aspect of the disclosure, any one of the eighty-seventh through ninetieth aspects is provided, wherein the glass-ceramic substrate has a residual surface compressive stress of from 200 MPa to 1200 MPa and a depth of compression (DOC) of from 5 μm to 150 μm.

Aspect 92. According to a ninety-second aspect of the disclosure, any one of the eighty-seventh through ninety-first aspects is provided, wherein the glass-ceramic substrate further exhibits a maximum central tension (CT) value from 80 MPa to 200 MPa, and further wherein the glass-ceramic substrate has a thickness of about 1.5 mm or less.

Aspect 93. According to a ninety-third aspect of the disclosure, any one of the eighty-seventh through ninety-second aspects is provided, wherein the glass-ceramic substrate has a residual surface compressive stress of from 200 MPa to 400 MPa.

Aspect 94. According to a ninety-fourth aspect of the disclosure, the eighty-eighth aspect is provided, wherein the article exhibits an average failure stress of 700 MPa or greater in a ring-on-ring test with the outer surface of the optical film structure placed in tension.

Aspect 95. According to a ninety-fifth aspect of the disclosure, the eighty-eighth aspect is provided, wherein the article exhibits an average failure stress of 500 MPa or greater in a four-point bend test with the outer surface of the optical film structure placed in tension.

Aspect 96. According to a ninety-sixth aspect of the disclosure, any one of the eighty-seventh through ninety-fifth aspects is provided, wherein the transparent article serves as a protective cover for the display device.

Aspect 97. According to a ninety-seventh aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. Further, the at least one medium RI layer comprises a refractive index from 1.55 to 1.80, each of the high RI layers comprises a refractive index of greater than 1.80, and each of the low RI layers comprises a refractive index of less than 1.55. The optical film structure has a physical thickness of from about 200 nm to 5000 nm. Further, the article exhibits a first-surface average photopic reflectance of less than 6%. In addition, the article exhibits one or more of: (i) a hardness of greater than 11 GPa at an indentation depth of about 20 nm or 40 nm; (ii) a hardness of greater than 15 GPa at an indentation depth of 100 nm; and (iii) a hardness of greater than 16 GPa at an indentation depth of 125 nm, as measured by a Berkovich Hardness Test at the outer surface of the optical film structure.

Aspect 98. According to a ninety-eighth aspect of the disclosure, the ninety-seventh aspect is provided, wherein the substrate is a glass-ceramic material that comprises an elastic modulus of greater than 85 GPa and a fracture toughness of greater than 0.8 MPa·√m.

Aspect 99. According to a ninety-ninth aspect of the disclosure, the ninety-seventh aspect or the ninety-eighth aspect is provided, wherein the optical film structure exhibits a residual compressive stress of from 700 MPa to 1100 MPa and an elastic modulus of from 140 GPa to 200 GPa.

Aspect 100. According to a one hundredth aspect of the disclosure, any one of the ninety-seventh through ninety-ninth aspects is provided, wherein the optical film structure exhibits an elastic modulus of from 140 GPa to 180 GPa.

Aspect 101. According to a one hundred first aspect of the disclosure, any one of the ninety-seventh through one hundredth aspects is provided, wherein the substrate has a residual surface compressive stress of from 200 MPa to 1200 MPa and a depth of compression (DOC) of from 5 μm to 150 μm.

Aspect 102. According to a one hundred second aspect of the disclosure, any one of the ninety-seventh through one hundred first aspects is provided, wherein the substrate further exhibits a maximum central tension (CT) value from 80 MPa to 200 MPa, and further wherein the substrate has a thickness of about 1.5 mm or less.

Aspect 103. According to a one hundred third aspect of the disclosure, any one of the ninety-seventh through one hundred second aspects is provided, wherein the substrate has a residual surface compressive stress of from 200 MPa to 400 MPa.

Aspect 104. According to a one hundred fourth aspect of the disclosure, any one of the ninety-ninth through one hundred third aspects is provided, wherein the inner structure comprises one of: (a) a plurality of alternating high refractive (RI) and low RI layers; (b) a refractive index gradient; and (c) a compositional gradient.

Aspect 105. According to a one hundred fifth aspect of the disclosure, any one of the ninety-ninth through one hundred fourth aspects is provided, wherein the optical film structure has a physical thickness of from about 800 nm to 4000 nm.

Aspect 106. According to a one hundred sixth aspect of the disclosure, any one of the ninety-ninth through one hundred fifth aspects is provided, wherein the transparent article serves as a protective cover for the display device.

Aspect 107. According to a one hundred seventh aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. Further, the at least one medium RI layer comprises a refractive index from 1.55 to 1.80, each of the high RI layers comprises a refractive index of greater than 1.80, and each of the low RI layers comprises a refractive index of less than 1.55. The optical film structure has a physical thickness of from about 200 nm to 800 nm. Further, the article exhibits a first-surface average photopic reflectance of less than 6%. In addition, the article exhibits one or more of: (i) a hardness of greater than 9 GPa at an indentation depth of 20 nm; (ii) a hardness of greater than 10 GPa at an indentation depth of 40 nm; (iii) a hardness of greater than 12 GPa at an indentation depth of 100 nm; and (iv) a hardness of greater than 12 GPa at an indentation depth of 125 nm, as measured by a Berkovich Hardness Test at the outer surface of the optical film structure

Aspect 108. According to a one hundred eighth aspect of the disclosure, the one hundred seventh aspect is provided, wherein the substrate is a glass-ceramic material that comprises an elastic modulus of greater than 85 GPa and a fracture toughness of greater than 0.8 MPa·√m.

Aspect 109. According to a one hundred ninth aspect of the disclosure, the one hundred seventh aspect or one hundred eighth is provided, wherein the optical film structure exhibits a residual compressive stress of from 700 MPa to 1100 MPa and an elastic modulus of from 140 GPa to 200 GPa.

Aspect 110. According to a one hundred tenth aspect of the disclosure, any one of the one hundred seventh through one hundred ninth aspects is provided, wherein the optical film structure exhibits an elastic modulus of from 140 GPa to 180 GPa.

Aspect 111. According to a one hundred eleventh aspect of the disclosure, any one of the one hundred seventh through one hundred tenth aspects is provided, wherein the substrate has a residual surface compressive stress of from 200 MPa to 1200 MPa and a depth of compression (DOC) of from 5 μm to 150 μm.

Aspect 112. According to a one hundred twelfth aspect of the disclosure, any one of the one hundred seventh through one hundred eleventh aspects is provided, wherein the substrate further exhibits a maximum central tension (CT) value from 80 MPa to 200 MPa, and further wherein the substrate has a thickness of about 1.5 mm or less.

Aspect 113. According to a one hundred thirteenth aspect of the disclosure, any one of the one hundred seventh through one hundred twelfth aspects is provided, wherein the substrate has a residual surface compressive stress of from 200 MPa to 400 MPa.

Aspect 114. According to a one hundred fourteenth aspect of the disclosure, any one of the one hundred seventh through one hundred thirteenth aspects is provided, wherein the inner structure comprises one of: (a) a plurality of alternating high refractive (RI) and low RI layers; (b) a refractive index gradient; and (c) a compositional gradient.

Aspect 115. According to a one hundred fifteenth aspect of the disclosure, any one of the one hundred seventh through one hundred fourteenth aspects is provided, wherein the optical film structure has a physical thickness of from about 200 nm to 600 nm.

Aspect 116. According to a one hundred sixteenth aspect of the disclosure, any one of the one hundred seventh through one hundred fifteenth aspects is provided, wherein the transparent article serves as a protective cover for the display device.

Aspect 117. According to a one hundred seventeenth aspect of the disclosure, a transparent article is provided that includes: a substrate comprising a first primary surface and a second primary surface, the primary surfaces opposing one another; and an optical film structure defining an outer surface, the optical film structure disposed on the first primary surface. The optical film structure comprises a scratch-resistant layer and a plurality of alternating high refractive index (RI) and low RI layers. Further, the optical film structure comprises an outer structure and an inner structure, the scratch-resistant layer disposed between the outer and inner structures. The outer structure comprises at least one medium RI layer in contact with one or both of: (a) the scratch-resistant layer and (b) one of the high RI layers. In addition, the at least one medium RI layer comprises a refractive index from 1.55 to 1.80, each of the high RI layers comprises a refractive index of greater than 1.80, and each of the low RI layers comprises a refractive index of less than 1.55. Further, the scratch-resistant layer has a physical thickness from about 100 nm to less than 2000 nm.

Aspect 118. According to a one hundred eighteenth aspect of the disclosure, the one hundred seventeenth aspect is provided, wherein the substrate is a glass-ceramic material that comprises an elastic modulus of greater than 85 GPa and a fracture toughness of greater than 0.8 MPa·√m.

Aspect 119. According to a one hundred nineteenth aspect of the disclosure, the one hundred seventeenth aspect or one hundred eighteenth aspect is provided, wherein the optical film structure exhibits a residual compressive stress of from 700 MPa to 1100 MPa and an elastic modulus of from 140 GPa to 200 GPa.

Aspect 120. According to a one hundred twentieth aspect of the disclosure, any one of the one hundred seventeenth through one hundred nineteenth aspects is provided, wherein the optical film structure exhibits an elastic modulus of from 140 GPa to 180 GPa.

Aspect 121. According to a one hundred twenty first aspect of the disclosure, any one of the one hundred seventeenth through one hundred twentieth aspects is provided, wherein the substrate has a residual surface compressive stress of from 200 MPa to 1200 MPa and a depth of compression (DOC) of from 5 μm to 150 μm.

Aspect 122. According to a one hundred twenty-second aspect of the disclosure, any one of the one hundred seventeenth through one hundred twenty-first aspects is provided, wherein the substrate further exhibits a maximum central tension (CT) value from 80 MPa to 200 MPa, and further wherein the substrate has a thickness of about 1.5 mm or less.

Aspect 123. According to a one hundred twenty-third aspect of the disclosure, any one of the one hundred seventeenth through one hundred twenty-second aspects is provided, wherein the substrate has a residual surface compressive stress of from 200 MPa to 400 MPa.

Aspect 124. According to a one hundred twenty-fourth aspect of the disclosure, any one of the one hundred seventeenth through one hundred twenty-third aspects is provided, wherein the transparent article serves as a protective cover for the display device.

Aspect 125. According to a one hundred twenty-fifth aspect of the disclosure, any one of the ninety-seventh through one hundred sixth aspects is provided, further comprising a textured surface region defined by the first primary surface of the substrate, wherein the textured surface region comprises a plurality of structural features and an average texture height (Rtext) from 50 nm to 800 nm.

Aspect 126. According to a one hundred twenty-sixth aspect of the disclosure, any one of the one hundred seventh through one hundred sixteenth aspects is provided, further comprising a textured surface region defined by the first primary surface of the substrate, wherein the textured surface region comprises a plurality of structural features and an average texture height (Rtext) from 50 nm to 800 nm.

Aspect 127. According to a one hundred twenty-seventh aspect of the disclosure, any one of the one hundred seventeenth through one hundred twenty-fourth aspects is provided, further comprising a textured surface region defined by the first primary surface of the substrate, wherein the textured surface region comprises a plurality of structural features and an average texture height (Rtext) from 50 nm to 800 nm.

Aspect 128. According to a one hundred twenty-eighth aspect of the disclosure, any one of the ninety-seventh through one hundred sixth aspects is provided, further comprising a diffractive surface region defined by the first primary surface of the substrate, wherein the diffractive surface region comprises a plurality of structural features with a plurality of different heights in a bimodal or multimodal distribution.

Aspect 129. According to a one hundred twenty-ninth aspect of the disclosure, any one of the one hundred seventh through one hundred sixteenth aspects is provided, further comprising a diffractive surface region defined by the first primary surface of the substrate, wherein the diffractive surface region comprises a plurality of structural features with a plurality of different heights in a bimodal or multimodal distribution.

Aspect 130. According to a one hundred thirtieth aspect of the disclosure, any one of the one hundred seventeenth through one hundred twenty-fourth aspects is provided, further comprising a diffractive surface region defined by the first primary surface of the substrate, wherein the diffractive surface region comprises a plurality of structural features with a plurality of different heights in a bimodal or multimodal distribution.

As outlined below, Table 37 provides a summary of the foregoing Aspects and embodiments of the disclosure, along with corresponding exemplary Figures and Examples. The Aspects and embodiments in Table 37 are for illustrative purposes, and are no way intended to limit the scope of this disclosure. Further, it should be understood that the exemplary features identified for each Aspect can be combined with any one of the features in the other Aspects.

TABLE 37
Summary of Aspects of the Disclosure

| Aspect | Transparent/Display Articles-Exemplary Features | FIGS. | Exs. |
|---|---|---|---|
| 1-11, 81 | High shallow hardness and various optical film structure thicknesses, and | 1A-1G | All |
| | minimized low RI volume and/or medium RI layer(s) in outer AR structure | | |
| | Thicker or thinner optical film structures with low reflectance and high | | |
| | shallow hardness | | |
| | Optimized optical film structures with thin scratch resistant layer, retained | | |
| | strength and hardness, and low warp | | |
| | High shallow hardness and texture or diffractive antiglare substrate surface | | |
| | Optical film structures and/or substrates with compositions and/or properties | | |
| | optimized for retained article strength | | |
| 12-24, 82 | High shallow hardness and various optical film structure thicknesses, and | 1A-1D | 1-3, |
| | medium RI layer(s) in outer AR structure | | 5, 8- |
| | Optical film structures and/or substrates with compositions and/or properties | | 11, |
| | optimized for retained article strength | | 13-16 |
| 25-37, 83 | High shallow hardness and various optical film structure thicknesses, and | 1A-1D | 1-16 |
| | minimized low RI volume in outer AR structure | | |
| | Optical film structures and/or substrates with compositions and/or properties | | |
| | optimized for retained article strength | | |
| 38-51, 84 | High shallow hardness and various optical film structure thicknesses, and | 1A-1D | 1-3, |
| | minimized low RI volume and medium RI layer(s) in outer AR structure | | 5, 8- |
| | Optical film structures and/or substrates with compositions and/or properties | | 11, |
| | optimized for retained article strength | | 13-16 |
| 52-64, 85 | High shallow hardness and various optical film structure thicknesses, | 1A-1D | 1-4, |
| | minimized low RI volume in outer AR structure, and low photopic reflectance | | 13 |
| | Optical film structures and/or substrates with compositions and/or properties | | |
| | optimized for retained article strength | | |
| 65-80, 86 | High shallow hardness and various optical film structure thicknesses, | 1A-1D | 1-16 |
| | minimized low RI volume in outer AR structure, and low photopic reflectance | | |
| | Optical film structures and/or substrates with compositions and/or properties | | |
| | optimized for retained article strength | | |
| 87-96 | High shallow hardness and various optical film structure thicknesses, and | 1A-1D | 1-3, |
| | medium RI layer(s) in outer AR structure | | 5, 8- |
| | Optical film structures and/or substrates with compositions and/or properties | | 11, |
| | optimized for retained article strength | | 13-16 |
| 97-106 | Thicker optical film structures with low reflectance and high shallow hardness | 1G | 23-27 |
| | Optical film structures and/or substrates with compositions and/or properties | | |
| | optimized for retained article strength | | |
| 107-116 | Thinner optical film structures with low reflectance and high shallow | 1E-1F | 17-22 |
| | hardness | | |
| | Optical film structures and/or substrates with compositions and/or properties | | |
| | optimized for retained article strength | | |
| 117-124 | Optimized optical film structures with thin scratch resistant layer, retained | 1A-1G | 28A- |
| | strength and hardness, and low warp | | 28E |
| 125-130 | High shallow hardness and texture or diffractive antiglare substrate surface | — | — |

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that has been set forth and defined within the following claims.

What is claimed is:

1. A transparent article, comprising:
a substrate comprising a first primary surface and a second primary surface, the primary surfaces opposing one another; and
an optical film structure defining an outer surface, the optical film structure disposed on the first primary surface,
wherein the optical film structure comprises an outer structure, an inner structure, an outermost capping layer, and a scratch-resistant layer disposed between the outer and inner structures,
wherein the outer structure comprises at least one medium refractive index (RI) layer in contact with one or more of: (a) the scratch-resistant layer, (b) a high RI layer in the outer structure, and (c) a low RI layer in the outer structure,
wherein the scratch-resistant layer has a physical thickness of greater than or equal to 1500 nm,
wherein each of the medium RI layers comprises a refractive index from 1.5 to 1.9, each of the high RI layers comprises a refractive index of greater than 1.90, and each of the low RI layers comprises a refractive index of less than 1.5, and
further wherein the scratch-resistant layer comprises SiOₓN_{y}, wherein the capping layer and each low RI layer comprises SiO₂, each medium RI layer comprises SiOₓN_{y}, and each high RI layer comprises SiOₓN_{y} or SiNₓ.

2. The transparent article of claim 1, wherein the inner structure comprises a plurality of alternating high RI and low RI layers or alternating medium RI and low RI layers.

3. The transparent article of claim 1, wherein the inner structure comprises a plurality of alternating high and low RI layers of SiOₓN_{y} and SiO₂, respectively, and further wherein the outer structure comprises medium RI layers of SiOₓN_{y} and high RI layers of SiNₓ.

4. The transparent article of claim 1, wherein the inner structure comprises a plurality of alternating medium and low RI layers of SiOₓN_{y} and SiO₂, respectively, and further wherein the outer structure comprises medium RI layers of SiOₓN_{y} and high RI layers of SiNₓ.

5. The transparent article of claim 1, wherein the scratch-resistant layer exhibits a hardness value of greater than about 10 GPa, as measured with a Berkovich Hardness Test.

6. The transparent article of claim 1, wherein the optical film structure has a physical thickness of greater than or equal to 2000 nm.

7. The transparent article of claim 1, wherein the wherein the scratch-resistant layer has a physical thickness of greater than or equal to 2000 nm.

8. The transparent article of claim 7, wherein the optical film structure has a physical thickness of greater than or equal to 3000 nm.

9. The transparent article of claim 1, wherein the wherein the scratch-resistant layer has a physical thickness of greater than or equal to 3000 nm.

10. The transparent article of claim 9, wherein the optical film structure has a physical thickness of greater than or equal to 4000 nm.

11. The transparent article of claim 1, wherein the wherein the scratch-resistant layer has a physical thickness of greater than or equal to 5000 nm.

12. The transparent article of claim 11, wherein the optical film structure has a physical thickness of greater than or equal to 6000 nm.

13. The transparent article of claim 1, wherein the optical film structure exhibits a maximum hardness of 12 GPa or greater, as measured from the outer surface with a Berkovich Hardness Test over an indentation depth from 100 nm to 500 nm.

14. The transparent article of claim 1, wherein the article exhibits a first-surface reflected color with a D65 illuminant from −5 to +4 in a* and −8 to +4 in b* over all incident angles from 0 degrees to 90 degrees.

15. The transparent article of claim 1, wherein the article exhibits a first-surface photopic reflectance of less than about 5%, as measured from 0 to 10 degrees.

16. The transparent article of claim 1, wherein the optical film structure exhibits a residual compressive stress of 700 MPa to 1100 MPa.

17. The transparent article of claim 1, wherein the optical film structure has a maximum hardness of no greater than 30 GPa, as measured by a Berkovich Indenter Hardness Test over an indentation depth from 100 nm to 500 nm, and further wherein the optical film structure has a physical thickness of no greater than 10 μm.

18. The transparent article of claim 1, wherein the maximum hardness of the optical film structure, as measured by a Berkovich Indenter Hardness Test over an indentation depth from 100 nm to 500 nm, is greater than the hardness of the scratch-resistant layer, as also measured by the Berkovich Indenter Hardness Test.

19. The transparent article of claim 1, wherein the hardness of the optical film structure is greater than 12 GPa, as measured from the outer surface with a Berkovich Hardness Test at an indentation depth of 100 nm.
